(19) United States
(12) Patent Application Publication
(10) Pub. No.: US 2018/0232828 A1
(43) Pub. Date: Aug. 16, 2018

(54) APPARATUS AND METHOD FOR PROVIDING AND/OR FOR PROCESSING INFORMATION FOR, REGARDING, AND/OR FOR FACILITATING, THE COMMERCIALIZATION, DEVELOPMENT, MARKETING, SALE, TRANSFER, LICENSING, AND/OR MONETIZATION, OF INTELLECTUAL PROPERTY

(71) Applicant: RAYMOND ANTHONY JOAO, YONKERS, NY (US)

(72) Inventor: RAYMOND ANTHONY JOAO, YONKERS, NY (US)

(21) Appl. No.: 15/953,702

(22) Filed: Apr. 16, 2018

Related U.S. Application Data
(63) Continuation-in-part of application No. 14/542,683, filed on Nov. 17, 2014.
(60) Provisional application No. 61/925,256, filed on Jan. 9, 2014.

(51) Int. Cl. G06Q 50/18; G06Q 40/06; G06Q 20/10; G06Q 20/06; G06Q 20/22; H04L 9/06

(52) U.S. Cl. CPC G06Q 50/184; G06Q 40/06; H04L 9/0637; G06Q 20/06; G06Q 20/223; G06Q 20/102

(57) ABSTRACT

An apparatus, including a user device, provider device, central processing computer, and distributed ledger. The central processing computer is specially programmed to process the information regarding an intellectual property, create a posting, a listing, or a registration, regarding the intellectual property, and generate a profile and first report regarding the intellectual property. The first report contains a video or audio recording. The central processing computer processes information for identifying a provider or an investor and generates a second report containing information regarding at least one provider or investor. The second report contains a video recording or audio recording. The central processing computer transmits the first report to the provider device and transmits the second report to the user device. The apparatus processes a transaction involving an owner of the intellectual property and the provider or investor as a Blockchain or Ethereum transaction via the distributed ledger.

### RELATED APPLICATIONS

This is a continuation-in-part application of U.S. patent application Ser. No. 14/542,683, filed Nov. 17, 2014, and entitled “APPARATUS AND METHOD FOR PROVIDING AND/OR FOR PROCESSING INFORMATION FOR, REGARDING, AND/OR FOR FACILITATING, THE COMMERCIALIZATION, DEVELOPMENT, MARKETING, SALE, TRANSFER, LICENSING, AND/OR MONETIZATION, OF INTELLECTUAL PROPERTY”, the subject matter and teachings of which are hereby incorporated by reference herein in their entirety. U.S. patent application Ser. No. 14/542,683 claims the benefit of the priority of U.S. Provisional Patent Application Ser. No. 61/925,256, filed Jan. 9, 2014, and entitled “APPARATUS AND METHOD FOR PROVIDING AND/OR FOR PROCESSING INFORMATION FOR, REGARDING, AND/OR FOR FACILITATING, THE COMMERCIALIZATION, DEVELOPMENT, MARKETING, SALE, TRANSFER, LICENSING, AND/OR MONETIZATION, OF INTELLECTUAL PROPERTY”, the subject matter and teachings of which are hereby incorporated by reference herein in their entirety.

### FIELD OF THE INVENTION

The present invention pertains to an apparatus and a method for providing and/or for processing information for, regarding, and/or for facilitating, the commercialization, development, marketing, sale, transfer, licensing, and/or monetization, of intellectual property and, in particular, to an apparatus and a method for providing and/or for processing information for, regarding, and/or for facilitating, the commercialization, development, marketing, sale, transfer, licensing, and/or monetization, of intellectual property, which can provide a centralized computer system which can be utilized by any user, individual, or business entity, in order to gain access to or to be provided with access to various service providers, goods providers, funding sources, official or governmental offices or agencies, agents, brokers, social networks, social networking members, media sources, and/or information sources, which can be utilized in commercializing, developing, marketing, selling, transferring, licensing, and/or monetizing, intellectual property of any type or kind.

### BACKGROUND OF THE INVENTION

Many individuals dream of inventing that new invention, dreaming up that new idea, or creating that new creation, which will enable them to achieve financial independence, achieve wealth, become famous, gain recognition, or solve a problem or problems which can help others or which can help society, people, or the environment. Individuals can spend a great deal of time and money, and/or can wait years, in order to protect that new invention, that new idea, or that new creation, only to find out that they lack the resources, the money or the capital, or the expertise to commercialize, develop, market, sell, transfer, license, or monetize, same. While some individuals are fortunate enough to have access to the needed resources, the needed money or capital, or the needed expertise, to commercialize, develop, market, sell, transfer, license, or monetize, their inventions, ideas, or creations, the vast majority of individuals lack access to these resources, money or capital, or expertise.

There is also a need to provide safeguards and/or security for and regarding transactions which can occur between individuals attempting to commercialize, develop, market, sell, transfer, license, or monetize, their inventions, ideas, or creations, and those persons or entities with whom they might attempt to do business. There is also a need to provide safeguards and/or security for individuals attempting to commercialize, develop, market, sell, transfer, license, or monetize, their inventions, ideas, or creations, as well as for the their respective subject inventions, ideas, and/or creations.

While official or governmental filing offices or invention, idea, or new creation, submission companies or entities can or may offer some guidance and/or assistance to some individuals for allowing them to obtain intellectual property to protect their invention, idea, or new creation, these official or governmental filing offices or invention, idea, or new creation, submission companies or entities fall far short when it comes to providing the vast majority of individuals with the guidance, money or capital, assistance, or expertise, or with any introduction to same or access to same, which is needed in order to enable or allow these individuals to commercialize, develop, market, sell, transfer, license, or monetize, their intellectual property.

### SUMMARY OF THE INVENTION

The present invention pertains to an apparatus and a method for providing and/or for processing information for, regarding, and/or for facilitating, the commercialization, development, marketing, sale, transfer, licensing, and/or monetization, of intellectual property, which overcomes the shortfalls of the prior art. The present invention pertains to an apparatus and a method for providing and/or for processing information for, regarding, and/or for facilitating, the commercialization, development, marketing, sale, transfer, licensing, and/or monetization, of intellectual property, which can provide a centralized computer system which can be utilized by any user, individual, or business entity, in order to gain access to, or to be provided with access to various service providers, goods providers, funding sources, official or governmental offices or agencies, agents, brokers, social networks, social networking members, media sources, and/or information sources or news sources, which can be utilized in commercializing, developing, marketing, selling, transferring, licensing, and/or monetizing, intellectual property of any type or kind.

The present invention provides an apparatus and a method which allows any user, individual, or entity, to post, list, or register, his, her, or its, intellectual property with the apparatus of the present invention for purposes of commercializing, developing, marketing, selling, transferring, licensing, and/or monetizing, same. The present invention also provides an apparatus and method which allows any user, individual, entity, provider, service provider, goods provider, funding entity or funding source, official or governmental office or agency, agent, broker, social network member, media source, and/or information provider or news provider, to search for and be provided with and/or otherwise obtain information regarding any intellectual property which is posted, listed, or registered, with the apparatus of the present invention.

The present invention can also be programmed to generate and/or to provide, upon a posting, a listing, or a registration, of an intellectual property or intellectual properties with the apparatus of the present invention, a notification message(s) or an alert message(s), containing information regarding the posted, the listed, or the registered, or any newly posted, newly listed, or newly registered, intellectual property or intellectual properties, to any user, individual, entity, provider, service provider, goods provider, funding entity or funding source, official or governmental office or agency, agent, broker, social network member, media source, or information provider or news provider, who or which may be interested in same.

The present invention can also be programmed to generate and/or to provide, upon a posting, a listing, or registration, of a user, individual, entity, provider, service provider, goods provider, funding entity or funding source, official or governmental office or agency, agent, broker, social network member, media source, or information provider or news provider, or a new user, individual, entity, provider, service provider, goods provider, funding entity or funding source, official or governmental office or agency, agent, broker, social network member, media source, or information provider or news provider, with the apparatus, a notification message(s) or an alert message(s), containing information regarding the newly posted, listed, or registered or available, user, individual, entity, provider, service provider, goods provider, funding entity or funding source, official or governmental office or agency, agent, broker, social network member, media source, or information provider or news provider, to any user, individual, or entity, who or which has posted, listed, or registered, intellectual property or intellectual properties with the apparatus of the present invention.

The present invention can also be utilized to process information regarding a commercialization of, a development of, a marketing of, a sale of, a transfer of, a licensing of, or a monetization of, any intellectual property, or any investment in such activity for or regarding any intellectual property. The present invention can also be utilized to sell shares or interests in intellectual property, or to sell shares or interests in any activity, effort, or entity, for or regarding the commercialization of, the development of, the marketing of, the sale of, the transfer of, the licensing of, or the monetization of, any intellectual property.

The present invention can also be utilized in order to allow any user, individual, or entity, to search for, hire, or otherwise engage any provider(s) or service provider(s) or professional service provider(s) for purposes of protecting, securing rights to, obtaining rights to or regarding, commercializing, developing, marketing, selling, transferring, licensing, or monetization of, his, her, or its, intellectual property. The present invention can also be utilized in order to allow a user, individual, entity, provider, service provider, goods provider, funding entity or funding source, official or governmental office or agency, agent, broker, social network member, media source, or information provider or news provider, to obtain information regarding, provide information for or regarding, or to offer to sell, advertise, or sell, a service or goods, or to be hired by or engaged by any user, individual, or entity who or which utilizes the apparatus and method of the present invention in order to commercialize, develop, market, sell, transfer, license, or monetize of, his, her, or its, intellectual property.

The present invention can also be utilized in order to allow a user, individual, or entity, to sell, transfer, or license, any domestic rights or foreign rights to his, her, or its, intellectual property. The present invention can also be utilized in order to offer, advertise, provide, or sell, services of any of the herein-described users, individuals, entities, provider, service providers, goods providers, funding entities or funding sources, official or governmental offices or agencies, agents, brokers, social networking members, media sources, or information providers or news providers. The present invention can also be utilized in order to offer, advertise, provide, or sell, subscriptions for the services of any of the herein-described users, individuals, entities, providers, service providers, goods providers, funding entities or funding sources, official or governmental offices or agencies, agents, brokers, social networking members, media sources, or information providers or news providers. The present invention can also be utilized to allow any users, individuals, entities, or any of the herein-described users, individuals, entities, providers, service providers, goods providers, funding entities or funding sources, official or governmental offices or agencies, agents, brokers, social networking members, media sources, or information providers or news providers, to buy, sell, trade in, or barter for, any herein-described intellectual property or any services or goods, or any subscriptions for any services or goods, provided by any of the herein-described users, individuals, entities, providers, service providers, goods providers, funding entities or funding sources, official or governmental offices or agencies, agents, brokers, social networking members, media sources, or information providers or news providers.

The present invention can also be utilized as a clearinghouse for the selling, purchasing, trading, or bartering, of shares or interests in or regarding intellectual property. The present invention can also be utilized as a clearinghouse for intellectual property and/or any rights in, to, or relating to, same, as a clearinghouse for any services or goods, or any subscriptions for any services or goods, which can be provided by any of the herein-described users, individuals, entities, providers, service providers, goods providers, funding entities or funding sources, official or governmental offices or agencies, agents, brokers, social networking members, media sources, or information providers or news providers, as a virtual employment agency, as a virtual subscription buying, selling, trading, or bartering, clearinghouse or platform, and/or as a virtual incubator for incubating start-up companies, for launching new business divisions or entities, or as a new product or service launch platform or forum. The present invention can also be utilized to provide or perform any number of functions or functionality.

The apparatus of the present invention can include a central processing computer or central processing computer system. The central processing computer can be, or can include, any computer or system of computers, or a network computer or a server computer or any number of network computers or server computers. The central processing computer can provide control over the apparatus of the present invention and can perform any of the various processing services and/or functions described herein. The central processing computer may be a single computer or system of computers and/or may be or may include a plurality of computers or computer systems which are utilized in conjunction with one another. The central processing computer can also provide or perform processing functionality for any of the other computers, computer systems, and/or communication devices, described herein as being used by or associated with any of the herein-described users, individuals, entities, business entities, providers, service providers, goods providers, funding sources or funding services or individuals associated therewith, official or governmental filing offices, agencies, or bureaus, agents, brokers, social networks, or media or information sources or services, who or utilize the apparatus and method of the present invention.

The apparatus of the present invention can also include a user communication device or computer (“user communication device”) which can be used by, or which is or can be associated with, any user of the apparatus and method of the present invention. Any number or amount of user communication devices can be utilized in connection with the apparatus of the present invention. Any number or amount of user communication devices can also be utilized by, or can be associated with, any user. The user communication device(s) can communicate with, and can operate in conjunction with, the central processing computer and/or any of the other communication devices, computers, and/or computer systems, described herein which can be associated with, or which can be used by, any of the users, individuals, and/or entities, who or which utilize the present invention.

The apparatus of the present invention can also include a provider computer or communication device (“provider communication device”) which can be associated with, or which can be utilized by, any provider, or any employee or agent of any provider, who or which utilizes the present invention. Any number or amount of provider communication device(s) can be utilized in connection with the apparatus of the present invention. Any number or amount of provider communication devices can also be utilized by, or can be associated with, any provider. The provider communication device(s) can communicate with, and can operate in conjunction with, the central processing computer and/or any of the other communication devices, computers, and/or computer systems, described herein which can be associated with, or which can be used by, any of the users, individuals, and/or entities, who or which utilize the present invention.

The apparatus of the present invention can also include a funding service or funding source computer or communication device (“funding service communication device”) which can be associated with, or which can be utilized by, any funding service, funding source, fund raising service or source, bank, credit union, investment bank, crowd funding company, crowd funding service, investor, angel investor, lender, or any other individual or entity who or which can assist in raising money, in lending money, in contributing money or services, goods, or products, or in investing money or services, goods, or products, in or for any efforts regarding or relating to any commercialization, development, marketing, sale, transfer, licensing, and/or monetization, of any intellectual property, or for facilitating any commercialization, development, marketing, sale, transfer, licensing, and/or monetization, of any intellectual property, or any employees or agents of same, who or which utilizes the present invention.

Any number or amount of funding service communication devices can be utilized in connection with the present invention. Any number or amount of funding service communication devices can also be utilized by, or can be associated with, any funding service or funding source. The funding service communication device(s) can communicate with, and can operate in conjunction with, the central processing computer and/or any of the other communication devices, computers, and/or computer systems, described herein which can be associated with, or which can be used by, any of the users, individuals, and/or entities, who or which utilize the present invention.

The apparatus of the present invention can also include an official or governmental filing office computer or communication device (“official filing office computer”) which can be associated with, or which can be utilized by, any national, regional, or governmental, patent office, trademark office, copyright office, or any other office, agency, department, or bureau, which governs or is responsible for the filing, examination, or issuance, or registration or maintenance, of or for any type, kind, or form, of intellectual property for any nation or country, or for any groups or regions of nations or countries, or any employee or agent of same, who or which utilizes the present invention.

Any number or amount of official filing office computers can be utilized in connection with the apparatus of the present invention. Any number or amount of official filing office computers can also be utilized by, or can be associated with, any official filing office. The official filing office computer(s) can communicate with, and can operate in conjunction with, the central processing computer and/or any of the other communication devices, computers, and/or computer systems, described herein which can be associated with, or which can be used by, any of the users, individuals, and/or entities, who or which utilize the present invention.

The apparatus can also include an agent or broker communication device or computer (“agent/broker communication device”) which can be utilized by any agent, broker, patent broker or patent brokerage entity, trademark broker or trademark brokerage entity, or copyright broker or copyright brokerage entity, or any intellectual property agent or intellectual property broker, or any agent or employee of same, who or which can provide any service for, or represent, any owner or holder or any right, title, or interest, in any intellectual property, or for any employee or agent of same, or who or which can provide any service for, or represent, any user of the present invention described herein or otherwise.

Any number or amount of agent/broker communication devices can be utilized in connection with the apparatus of the present invention. Any number or amount of agent/broker communication devices can also be utilized by, or can be associated with, any agent, broker, patent broker or patent brokerage entity, trademark broker or trademark brokerage entity, or copyright broker or copyright brokerage entity, or any intellectual property agent or intellectual property broker, or any agent or employee of same, who or which can provide any service for, or represent, any owner or holder or any right, title, or interest, in any intellectual property, or for any employee or agent of same, or who or which can provide any service for, or represent, any user of the apparatus of the present invention described herein or otherwise. The agent/broker communication device(s) can communicate with, and can operate in conjunction with, the central processing computer and/or any of the other communication devices, computers, and/or computer systems, described herein which can be associated with, or which can be used by, any of the users, individuals, and/or entities, who or which utilize the present invention.

The apparatus can also include a social networking computer or communication device (“social networking computer”) which can be utilized by or which can be associated with any social network, social networking company, social networking website, or any member, employee, or agent, of same, who or which utilizes the present invention.

Any number or amount of social networking computers can be utilized in connection with the apparatus of the present invention. Any number or amount of social networking computers can also be utilized by, or can be associated with, any social network, social networking company, social networking website, or any member, employee, or agent, of same. The social networking computer(s) can communicate with, and can operate in conjunction with, the central processing computer and/or any of the other communication devices, computers, and/or computer systems, described herein which can be associated with, or which can be used by, any of the users, individuals, and/or entities, who or which utilize the present invention.

The apparatus can also include a media computer or communication device (“media computer”) which can be utilized by or which can be associated with any media service or media source, information service or information source, or news service or news source, or any employee, or agent, of same, who or which utilizes the present invention. Any media computer can provide any media, information, news, any news relating to intellectual property, or any news regarding patents, trademarks, copyrights, or trade secrets, or news information, business news information, financial news information, or any current events information, or any intellectual property information, intellectual property-related information, or any information regarding current events, or any advertisements and/or any marketing information or materials, which can be disseminated via the present invention.

Any number or amount of media computers can be utilized in connection with the apparatus of the present invention. Any number or amount of media computers can also be utilized by, or can be associated with, any media service or media source, information service or information source, or news service or news source, or any employee, or agent, of same. The media computer(s) can communicate with, and can operate in conjunction with, the central processing computer and/or any of the other communication devices, computers, and/or computer systems, described herein which can be associated with, or which can be used by, any of the users, individuals, and/or entities, who or which utilize the present invention.

Any of the user communication device(s), the provider communication device(s), the funding service communication device(s), the official filing office computer(s), the agent/broker communication device(s), the social networking computer(s), and/or the media computer(s), can be any computer or communication device, including, but not limited to, a personal computer, a home computer, a server computer, a network computer, a hand-held computer, a palmtop computer, a laptop computer, a tablet, a tablet computer, a personal communication device, a cellular telephone, a wireless telephone, a Smartphone or smart phone, a mobile telephone, a television, a digital television, an interactive television, a smart television, a personal digital assistant, a telephone, a digital telephone, a smart interactive television, a beeper, a pager, and/or a watch.

Each of the central processing computer(s), the user communication device(s), the provider communication device(s), the funding service communication device(s), the official filing office computer(s), the agent/broker communication device(s), the social networking computer(s), and/or the media computer(s), can transmit information to, as well as receive information from, any of the computers or communications devices described herein. In this regard, each of the herein-described computers or communications devices can communicate with, process information from, and/or share data and/or information with, each other and/or any other computers or communications devices described herein and/or utilized in conjunction with the present invention. In this manner, data and/or information transfer between any of the herein-described computers or communications devices can be performed with any other computers or communications devices described herein in a bi-directional manner.

The central processing computer(s), the user communication device(s), the provider communication device(s), the funding service communication device(s), the official filing office computer(s), the agent/broker communication device(s), the social networking computer(s), and/or the media computer(s), can communicate with one another, and/or can be linked to one another, over a communication network, a telecommunication network, a telephone network, a line-connected network, and/or a wireless communication network. Each of the herein-described computers or communication devices can be linked with any other computer or computers or communication device or communication devices described herein directly or indirectly so as to facilitate a direct or indirect bi-directional communication with and between said respective computers or communication devices. Communications between each of the herein-described computers or communication devices can also involve an e-mail server or e-mail servers in those instances when e-mails are described as being used to transmit or to send any of the information, signals, messages, reports, notification messages, or any other communications, described herein, by or between any of the herein-described computers or communication devices, or when any of the information, signals, messages, reports, notification messages, or any other communications, described herein, are transmitted by and/or between any of the users or parties described herein and/or by or between any of the herein-described computers or communication devices or any other computers or communication devices, computer systems, communication network equipment, or server computers, etc., or any other devices used or needed in order to facilitate communications or the transmission of any of the herein-described information, signals, messages, reports, notification messages, or any other communications.

Each of the central processing computer(s), the user communication device(s), the provider communication device(s), the funding service communication device(s), the official filing office computer(s), the agent/broker communication device(s), the social networking computer(s), and/or the media computer(s), can communicate in a bi-directional manner with, and/or can send and/or receive signals, messages, reports, notification messages, alerts, or any other communications or electronic communication transmissions, to, from and/or between, any other, or any number of, other central processing computer(s), if utilized, user communication device(s), provider communication device(s), funding service communication device(s), official filing office computer(s), agent/broker communication device(s), social networking computer(s), and/or media computer(s).

Each of the central processing computer(s), the user communication device(s), the provider communication device(s), the funding service communication device(s), the official filing office computer(s), the agent/broker communication device(s), the social networking computer(s), and/or the media computer(s) can be linked to or with any other central processing computer(s), if utilized, user communication device(s), provider communication device(s), funding service communication device(s), official filing office computer(s), agent/broker communication device(s), social networking computer(s), and/or media computer(s), via a wired link or line or a wireless link.

Each of the user communication device(s), the provider communication device(s), the funding service communication device(s), the official filing office computer(s), the agent/broker communication device(s), the social networking computer(s), and/or the media computer(s), can be connected with or linked with the central processing computer.

Any and/or all of the signals, messages, reports, notification messages, or any other communications, described herein as being transmitted from one device, computer, or communication device, to another, can be, or can be included in, or be attached to, an e-mail message, an instant messaging message, an electronic transmission, or an electronic data transmission or electronic data interchange, or can be transmitted via any other data or information transmission, and can be transmitted via or using any appropriate or necessary computer(s) or device(s).

The present invention can be utilized on, and/or over, the Internet and/or the World Wide Web. The present invention can also utilize wireless Internet and/or World Wide Web services, equipment and/or devices. The central processing computer(s) can also have a web site or web sites associated therewith. Each of the other computers or communication devices described herein can also have a web site or web sites associated with same.

Although the Internet and/or the World Wide Web is a preferred communication system and/or medium utilized, the present invention, in any and/or all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

Each of the central processing computer(s), the user communication device(s), the provider communication device(s), the funding service communication device(s), the official filing office computer(s), the agent/broker communication device(s), the social networking computer(s), and/or the media computer(s), can transmit data and/or information using TCP/IP, as well as any other Internet and/or World Wide Web, and/or communication, protocols.

The present invention can also utilize electronic commerce technologies and security methods, techniques and technologies, in any and/or all of the instances of data and/or information processing, and/or data and/or information transmission, described herein.

Each of the central processing computer(s), the user communication device(s), the provider communication device(s), the funding service communication device(s), the official filing office computer(s), the agent/broker communication device(s), the social networking computer(s), and/or the media computer(s), can include a central processing unit or CPU, a random access memory device(s) (RAM), a read only memory device(s) (ROM), a user input device, a display device, a transmitter(s), a receiver(s), a database(s), an output device, or a video and/or audio recording device(s).

The apparatus and method of the present invention can be utilized in order to allow any user, individual, or entity, to post, list, or register, his, her, or its, intellectual property with the apparatus of the present invention for purposes of commercializing, developing, marketing, selling, transferring, licensing, and/or monetizing, same. The apparatus and method of the present invention can be utilized as a posting, listing, or registration, entity for intellectual property of any type or kind.

The apparatus and method of the present invention can also be utilized in order to allow any provider, service provider, goods provider, funding service, investor, agent, broker, media service, information service, or news information service, post, list, or register, himself, herself, or itself, and/or information regarding the respective services, goods, or products, which he, she, or it, provides, with the apparatus of the present invention for purposes of serving the commercializing, developing, marketing, selling, transferring, licensing, and/or monetizing, needs of any of users described herein who or which own, hold, or manage any intellectual property. The apparatus and method of the present invention can be utilized as a posting, listing, or registration, entity for services, goods, or products, of any type or kind.

The apparatus and method of the present invention can also be utilized in order to allow any user, provider, funding service or investor, agent or broker, social network, or media service, information service, or news information service, to be notified upon the posting, listing, or registration, of an intellectual property with the apparatus. In this regard, the apparatus of the present invention can be utilized to generate a notification message or an alert message, containing information regarding a newly posted, listed, or registered, intellectual property, and to transmit the notification message or the alert message to a respective communication device of a respective user, provider, funding service or investor, agent or broker, social network, or media service, information service, or news information service.

The apparatus and method of the present invention can be utilized in order to allow any owner of intellectual property or any user who posts, lists, or registers, same with the apparatus of the present invention to be notified upon the posting, listing, or registration, of any provider, funding service or investor, agent or broker, official or governmental filing office, social network, or media service, information service, or news information service, or any other user, who or which the owner of intellectual property or any user who posts, lists, or registers, same might be interested in engaging the services of, or might be interested in purchasing services, goods, or products, from, or might be interested in being represented by, or to whom the owner of intellectual property or any user who posts, lists, or registers, same might be interested in selling or licensing the intellectual property or a portion thereof, or who or which the owner of intellectual property or any user who posts, lists, or registers, same may have any reason or interest for being so notified. In this regard, the apparatus of the present invention can be utilized to generate a notification message or an alert message, containing information regarding a newly posted, listed, or registered, provider, funding service or investor, agent or broker, official or governmental filing office, social network, or media service, information service, or news information service, or other user, who can provide any service, good, or product, which might be of interest to the owner of intellectual property or any user who posts, lists, or registers, same or who might be of any interest to the owner of intellectual property or any user who posts, lists, or registers, same for any reason or purpose. The apparatus of the present invention can thereafter transmit the notification message or the alert message to the user communication device of or associated with the owner of intellectual property or any user who posts, lists, or registers, same.

The present invention, or the apparatus and/or the central processing computer, can receive information regarding an intellectual property. The information regarding the intellectual property can include at least an identifier for the intellectual property, which can signify that the intellectual property has been previously filed with an intellectual property examining entity or an official filing office, and information regarding a goal or an objective for commercializing or monetizing the intellectual property.

The present invention can process the information regarding the intellectual property, and the apparatus and/or the central processing computer can be specially programmed to process the information regarding the intellectual property, specially programmed to create a posting, a listing, or a registration, of, for, or associated with, the intellectual property, and specially programmed to generate a profile for the intellectual property. The present invention can also generate or create the posting, the listing, or the registration for the intellectual property, and can also and/or further generate the profile for the intellectual property as well as a report containing information regarding the intellectual property.

The present invention can also process information for identifying a provider of a service, services, goods, or products, or for identifying a funding service or an investor, based on the goal or the objective for commercializing or monetizing the intellectual property, using information regarding the goal or the objective for commercializing or monetizing the intellectual property which can be previously by the apparatus and/or the central processing computer. The present invention can also transmit the report to any one or more of the user communication device of a user, a provider communication device of a provider, and/or a funding service communication device of an investor or funding entity.

The present invention, or the apparatus and/or the central processing computer, can receive information regarding a provider of a service, services, goods, or products, or information regarding an investor or a funding entity. The information regarding the provider can include at least information regarding qualifications or credentials of the provider and desired projects or jobs sought by the provider, in order to assist an owner of intellectual property to commercialize or monetize the intellectual property. The information regarding the investor or the funding entity can include information regarding investment criteria, services provided, and/or information regarding projects or intellectual property opportunities in or for which the investor or funding entity is interested in investing.

The present invention can process the information regarding the provider or the investor or funding entity, and the apparatus and/or the central processing computer can be specially programmed to generate a posting or a listing of or for the provider or the investor or funding entity and can be specially programmed to generate a profile for the provider or the investor or funding entity. The present invention can also generate or create the posting, the listing, or the registration, of, for, or associated with, the provider or the investor or the funding entity, and can also generate a profile for the provider or the investor or the funding entity, as well as a report containing information regarding the provider or the investor or the funding entity.

The present invention can also process information for identifying the owner of intellectual property based on the qualifications or credentials of the provider, or based on the qualifications, credentials, or investment criteria, of the investor or funding entity, and for identifying desired projects or jobs sought by the provider, to assist an owner of intellectual property to commercialize or monetize the intellectual property, or for identifying investment opportunities for the investor or funding entity, for assisting the intellectual property owner in commercializing or monetizing the intellectual property. The present invention can also transmit the report to any one or more of the user communication device of a user, a provider communication device of a provider, and/or a funding service communication device of an investor or funding entity.

The apparatus and method of the present invention can also be utilized to provide a centralized entity or repository, or a clearinghouse, for storing and/or for providing information regarding intellectual property of any kind or type which is available, or which can be available for commercialization, development, marketing, sale, transfer, licensing, or monetization. In a preferred embodiment, any number of users of the apparatus and method of the present invention can post, list, or register, his, her, or its, intellectual property or intellectual properties with the apparatus of the present invention and/or the central processing computer in order to commercialize, develop, market, sell, transfer, license, or monetize, same. Any and/or all information regarding any of the posted, listed, or registered, intellectual properties, and/or any information regarding the user who posted, listed, or registered, same, can be stored by in the central processing computer and can be searchable by any of the herein-described providers, funding services or investors, official or governmental filing offices, agents or brokers, social networking companies or entities or any members of any social networks, or media services or media sources, information services or information sources, or news services or news sources, or any other users.

The apparatus and method of the present invention can also be utilized to provide a centralized entity or repository, or a clearinghouse, for storing and/or for providing information regarding any of the herein-described providers, funding services or investors, official or governmental filing offices, agents or brokers, social networking companies or entities or any members of any social networks, or media services or media sources, information services or information sources, or news services or news sources, or any other users, and any of the respective services, goods, or products, which are or can be provided by each of same.

Any of the information, messages, reports, profiles, intellectual property profiles, provider reports, funding service/investor reports, agent/broker reports, intellectual property reports, intellectual property report messages, provider profiles, intellectual property user reports, provider reports, intellectual property user report messages, notification messages, alert messages, intellectual property (“IP”) notification messages, IP alert messages, provider availability notification messages, provider availability alert messages, search requests, search reports, intellectual property offer messages, intellectual property bid messages, offer messages, or any other messages, reports, or communications, described herein which can be generated by the apparatus of the present invention or by the central processing computer, or which can be generated by, transmitted from, or received by, any user communication device, any provider communication device, any funding service communication device, any official filing office computer, any agent/broker communication device, any social networking computer, or any media computer, can contain or include an advertisement, advertising information, marketing information, or marketing materials.

The apparatus of the present invention can also process any transactions, or any transaction information associated with same, which can or may occur, or which can or may transpire, with, between, or involving, any of the herein-described users, providers, funding services or investors, official or governmental filing offices, agents or brokers, social networking companies or entities or any members of any social networks, or media services or media sources, information services or information sources, or news services or news sources, pursuant to their respective utilization of the apparatus of the present invention and/or otherwise.

The apparatus of the present invention can also administer, or process data and/or information for administering, financial accounts or any other accounts for or on behalf of any of the herein-described users, providers, funding services or investors, official or governmental filing offices, agents or brokers, social networking companies or entities or any members of any social networks, or media services or media sources, information services or information sources, or news services or news sources.

Any of the herein-described information, messages, reports, profiles, intellectual property profiles, provider reports, funding service/investor reports, agent/broker reports, intellectual property reports, intellectual property report messages, provider profiles, intellectual property user reports, provider reports, intellectual property user report messages, notification messages, alert messages, intellectual property (“IP”) notification messages, IP alert messages, provider availability notification messages, provider availability alert messages, search requests, search reports, intellectual property offer messages, intellectual property bid messages, offer messages, or any other messages, reports, or communications, which can be generated by the apparatus of the present invention or by the central processing computer, or which can be generated by, transmitted from, or received by, any user communication device, any provider communication device, any funding service communication device, any official filing office computer, any agent/broker communication device, any social networking computer, or any media computer 80, described herein can contain or can include data or information regarding, or a link(s) to or a hyperlink(s) to, any of the herein-described users, providers, funding services or investors, official or governmental filing offices, agents or brokers, social networking companies, or media services or media sources, information services or information sources, or news information services or news information sources, or any website associated with or corresponding to same, or any respective communication device(s) or computer(s) associated with or corresponding to same, or any social network, or any Internet chat room or discussion group, Internet forum, on-line chat room or discussion group, on-line forum, class or instructional session or broadcast, seminar, or webinar, or any advertisement(s) or advertising materials, or any marketing information or marketing materials, or any work schedule(s) or scheduling information, of, for, regarding, relating to, or associated with or corresponding to, same.

The apparatus of the present invention and/or the central processing computer can also process any data or information for allowing any of the herein-described users, providers, funding services or investors, official or governmental filing offices, agents or brokers, social networking companies, or media services or media sources, information services or information sources, or news information services or news information sources, or any agents or employees of same, to engage in chat room sessions or discussions and/or video chat room sessions or discussions with one another, and/or in groups.

The apparatus of the present invention and/or the central processing computer can also process any data or information for allowing any of the herein-described users, providers, funding services or investors, official or governmental filing offices, agents or brokers, social networking companies, or media services or media sources, information services or information sources, or news information services or news information sources, or any agents or employees of same, to engage in bartering or in trading activities regarding or involving any services, goods, products, or other offerings which can be provide via the apparatus and method of the present invention.

The apparatus of the present invention and/or the central processing computer can also process data or information for advertising, marketing, or selling, franchises of any type or kind. The apparatus and method of the present invention can also be utilized in any number of ways in order to process information for, regarding, and/or for facilitating, the commercialization, development, marketing, sale, transfer, licensing, and/or monetization, of intellectual property which can be most beneficial to the various users, providers, funding services or investors, official or governmental filing offices, agents or brokers, social networking companies, or media services or media sources, information services or information sources, or news information services or new information sources, describe herein or otherwise who or which utilize the present invention.

The present invention can process data or information for advertising, marketing, or selling, media rights of any type or kind. The present invention and/or the central processing computer can also process data or information for advertising, marketing, or selling, publicity rights of any type or kind.

Any and all transactions which are or can be processed by the present invention or by any of the herein-described central processing computer(s), user communication devices, provider communication devices, funding service communication devices, official filing office computers, agent/broker communication devices, social networking computers, and/or the media computers, can be processed by using a distributed ledger and/or distributed ledger technology or technologies, and/or by using Blockchain technology and/or technologies, Bitcoin technology and/or technologies, Ethereum technology and/or technologies, cryptocurrency technology and/or technologies, and/or smart contract technology and/or technologies, and/or peer-to-peer technology or technologies, and/or any technology or technologies related thereto or which can be utilized in conjunction therewith.

Any combination of a centralized system, such as by using the central processing computer, to perform certain functions, and a decentralized system, such as a distributed ledger system, which can use Blockchain technology and/or technologies, Bitcoin technology and/or technologies, Ethereum technology and/or technologies, cryptocurrency technology and/or technologies, and/or smart contract technology and/or technologies, and/or peer-to-peer technology and/or technologies, to perform other functions, can also be utilized in the operation and use of the present invention and/or any of the herein-described described central processing computer(s), user communication devices, provider communication devices, funding service communication devices, official filing office computers, agent/broker communication devices, social networking computers, and/or the media computers.

A distributed ledger system, which can use Blockchain technology and/or technologies, Bitcoin technology and/or technologies, Ethereum technology and/or technologies, cryptocurrency technology and/or technologies, and/or smart contract technology and/or technologies, and/or peer-to-peer technology and/or technologies, can be utilized instead of using a central processing computer or instead of using any other of the herein-described user communication devices, provider communication devices, funding service communication devices, official filing office computers, agent/broker communication devices, social networking computers, and/or the media computers.

### BRIEF DESCRIPTION OF THE DRAWINGS

In the Drawings:

FIG. 1 illustrates a preferred embodiment of the apparatus of the present invention, in block diagram form;

FIG. 2 illustrates the central processing computer of FIG. 1, in block diagram form;

FIG. 3 illustrates the user communication device of FIG. 1, in block diagram form;

FIG. 4 illustrates the provider communication device of FIG. 1, in block diagram form;

FIG. 5 illustrates the funding source communication device of FIG. 1, in block diagram form;

FIG. 6 illustrates the official filing office computer of FIG. 1, in block diagram form;

FIG. 7 illustrates the agent/broker communication device of FIG. 1, in block diagram form;

FIG. 8 illustrates the social networking computer of FIG. 1, in block diagram form;

FIG. 9 illustrates media computer of FIG. 1, in block diagram form;

FIG. 10 illustrates a preferred embodiment method of utilizing the apparatus of the present invention, in flow diagram form;

FIG. 11 illustrates another preferred embodiment method of utilizing the apparatus of the present invention, in flow diagram form;

FIG. 12 illustrates yet another preferred embodiment method of utilizing the apparatus of the present invention, in flow diagram form;

FIG. 13 illustrates still another preferred embodiment method of utilizing the apparatus of the present invention, in flow diagram form;

FIG. 14 illustrates another preferred embodiment method of using the apparatus of the present invention, in flow diagram form; and

FIG. 15 illustrates another preferred embodiment method for utilizing the apparatus of the present invention, in flow diagram form.

### DESCRIPTION OF THE PREFERRED EMBODIMENTS

The present invention pertains to an apparatus and a method for providing and/or for processing information for, regarding, and/or for facilitating, the commercialization, development, marketing, sale, transfer, licensing, and/or monetization, of intellectual property and, in particular, to an apparatus and a method for providing and/or for processing information for, regarding, and/or for facilitating, the commercialization, development, marketing, sale, transfer, licensing, and/or monetization, of intellectual property, which can provide a centralized computer system which can be utilized by any user, individual, or business entity, in order to gain access to, or to be provided with access to, various providers, service providers, goods providers, funding sources, official or governmental offices or agencies, agents, brokers, social networks, social networking members, media sources, and/or information sources or news sources, which can be utilized in commercializing, developing, marketing, selling, transferring, licensing, and/or monetizing, intellectual property of any type or kind.

The present invention provides an apparatus and a method which allows any user, individual, or entity, to post, list, or register, his, her, or its, intellectual property with the apparatus of the present invention for purposes of commercializing, developing, marketing, selling, transferring, licensing, and/or monetizing, same. The present invention also provides an apparatus and method which allows any user, individual, entity, provider, service provider, goods provider, funding entity or funding source, official or governmental office or agency, agent, broker, social network member, media source, and/or information provider or news provider, to search for and be provided with and/or otherwise obtain information regarding any intellectual property which is posted, listed, or registered, with the apparatus of the present invention.

The apparatus of the present invention can also be programmed to generate and/or to provide, upon a posting, a listing, or a registration, of an intellectual property or intellectual properties with the apparatus of the present invention, a notification message(s) or an alert message(s), containing information regarding the posted, the listed, or the registered, or any newly posted, newly listed, or newly registered, intellectual property or intellectual properties, to any user, individual, entity, provider, service provider, goods provider, funding entity or funding source, official or governmental office or agency, agent, broker, social network member, media source, or information provider or news provider, who or which may be interested in same.

The apparatus of the present invention can also be programmed to generate and/or to provide, upon a posting, a listing, or registration, of a user, individual, entity, provider, service provider, goods provider, funding entity or funding source, official or governmental office or agency, agent, broker, social network member, media source, or information provider or news provider, or a new user, individual, entity, provider, service provider, goods provider, funding entity or funding source, official or governmental office or agency, agent, broker, social network member, media source, or information provider or news provider, with the apparatus, a notification message(s) or an alert message(s), containing information regarding the newly posted, listed, or registered or available, user, individual, entity, provider, service provider, goods provider, funding entity or funding source, official or governmental office or agency, agent, broker, social network member, media source, or information provider or news provider, to any user, individual, or entity, who or which has posted, listed, or registered, intellectual property or intellectual properties with the apparatus of the present invention.

The apparatus and method of the present invention can also be utilized to process information regarding a commercialization of, a development of, a marketing of, a sale of, a transfer of, a licensing of, or a monetization of, any intellectual property, or any investment in such activity for or regarding any intellectual property. The apparatus and method of the present invention can also be utilized to sell shares or interests in intellectual property, or to sell shares or interests in any activity, effort, or entity, for or regarding the commercialization of, the development of, the marketing of, the sale of, the transfer of, the licensing of, or the monetization of, any intellectual property.

The apparatus and method of the present invention can also be utilized in order to allow any user, individual, or entity, to search for, hire, or other engage any provider(s), service provider(s), or professional service provider(s), for purposes of protecting, securing rights to, obtaining rights to or regarding, commercializing, developing, marketing, selling, transferring, licensing, or monetization of, his, her, or its, intellectual property. The apparatus and method of the present invention can also be utilized in order to allow a user, individual, entity, provider, service provider, goods provider, funding entity or funding source, official or governmental office or agency, agent, broker, social network member, media source, or information provider or news provider, to obtain information regarding, provide information for or regarding, or to offer to sell, advertise, or sell, a service or goods, or to be hired by or engaged by any user, individual, or entity who or which utilizes the apparatus and method of the present invention in order to commercialize, develop, market, sell, transfer, license, or monetize of, his, her, or its, intellectual property.

The apparatus and method of the present invention can also be utilized in order to allow a user, individual, or entity, to sell, transfer, or license, any domestic rights or foreign rights to his, her, or its, intellectual property. The apparatus and method of the present invention can also be utilized in order to offer, advertise, provide, or sell, services of any of the herein-described users, individuals, entities, providers, service providers, goods providers, funding entities or funding sources, official or governmental offices or agencies, agents, brokers, social networking members, media sources, or information providers or news providers. The apparatus and method of the present invention can also be utilized in order to offer, advertise, provide, or sell, subscriptions for the services of any of the herein-described users, individuals, entities, provider, service providers, goods providers, funding entities or funding sources, official or governmental offices or agencies, agents, brokers, social networking members, media sources, or information providers or news providers. The apparatus and method of the present invention can also be utilized to allow any users, individuals, entities, or any of the herein-described users, individuals, entities, providers, service providers, goods providers, funding entities or funding sources, official or governmental offices or agencies, agents, brokers, social networking members, media sources, or information providers or news providers, to buy, sell, trade in, or barter for, any herein-described intellectual property or any services or goods, or any subscriptions for any services or goods, provided by any of the herein-described users, individuals, entities, providers, service providers, goods providers, funding entities or funding sources, official or governmental offices or agencies, agents, brokers, social networking members, media sources, or information providers or news providers.

The apparatus and method of the present invention can also be utilized as a clearinghouse for the selling, purchasing, trading, or bartering, of shares or interests in or regarding intellectual property.

The apparatus and method of the present invention can also be utilized as a clearinghouse for intellectual property and/or any rights in, to, or relating to, same, as a clearinghouse for any services or goods, or any subscriptions for any services or goods, which can be provided by any of the herein-described users, individuals, entities, providers, service providers, goods providers, funding entities or funding sources, official or governmental offices or agencies, agents, brokers, social networking members, media sources, or information providers or news providers, as a virtual employment agency, as a virtual subscription buying, selling, trading, or bartering, clearinghouse or platform, and/or as a virtual incubator for incubating start-up companies, for launching new business divisions or entities, or as a new product or service launch platform or forum. The apparatus and method of the present invention can also be utilized to provide or perform any number of functions or functionality.

As used herein, the term “intellectual property” refers to, or means, any patent, utility patent, design patent, plant patent, or any foreign or international equivalent of same or any foreign or international counterpart to same, any patent application, provisional patent application, non-provisional patent application, utility patent application, design patent application, plant patent application, and/or any derivative rights associated with or relating to same, or any foreign or international equivalent of same or any foreign or international counterpart to same, or any Patent Cooperation Treaty (PCT) patent application, European Patent Application, or any national, foreign, or regional, patent application, or any foreign or international equivalent of same or any foreign or international counterpart to same, or any invention, idea, documented invention, documented idea, utility model, utility model application, petty patent, petty patent application, innovation patent, innovation patent application, laid open patent application, published patent application, or each and/or every any kind of protection available in and for each nation which is a signatory to the Patent Cooperation Treaty (PCT) or any other international intellectual patent treaty, or each and/or every any kind of protection available in and for each regional patent protection or intellectual property protection under the Patent Cooperation Treaty (PCT) or any other international intellectual patent treaty, or regional or any patent or patent equivalent protection vehicle, or any foreign or international equivalent of same or any foreign or international counterpart to same, and/or any derivative rights associated with or relating to same, or trademark, service mark, mark (hereinafter “trademark”), or any trademark application, service mark application, or mark application, or any federally or otherwise registered, or any common law trademark, service mark, mark, or any foreign or international equivalent of same or any foreign or international counterpart to same, and/or any derivative rights associated with or relating to same, or any copyright, copyright application, registered copyright, common law copyright, copyrighted work, work of authorship, book, literary work of any type or kind, story, short story, article, journal, novel, poem, design, logo, play, screen play, movie script, television show script, internet production or presentation script, movie, television show, Internet show or presentation, movie script, or music, a song, recital, or opera, or music, musical, or song, lyrics, or a design, new product design, apparel, clothing, or any other creation or work of authorship, or any foreign or international equivalent of same or any foreign or international counterpart to same, and/or any derivative rights associated with or relating to same, or any trade secret or trade secret information. As used herein, the term “intellectual property” also refers to, or also means, any license, exclusive license, non-exclusive license, covenant not to sue, or a release, to, for, regarding, or relating to, any herein-described or other intellectual property. The term “intellectual property” also means, or also refers to any derivative rights associated with any intellectual property. Derivative rights can be or can include any rights typically considered to be such for any intellectual property. In addition, the term “intellectual property” also means or refers to any rights which can be granted to any intellectual property. As and for an example, the right to make a book or a story into a television show, a television series, or a movie, is to be considered to be an example of a derivative right of or associated with the book or story for purposes of this patent application in addition to any other derivative rights normally and/or typically associated with the book or the story. Any rights associated with or relating to any item of intellectual property is also to be considered as intellectual property for purposes of this application. In addition, the term “intellectual property” also refers to, or means, or includes, franchises of any type or kind, media rights of any type or kind, and/or rights of publicity of any type or kind.

The term “user”, or the plural of same, means or refers to, any individual, person, business organization, company, corporation, partnership, limited liability company, or other entity, who or which utilizes, or who or which can utilize, the apparatus and/or method of the present invention in any manner, any inventor, creator, intellectual property creator, intellectual property owner, intellectual property holder or holding entity, any agent, any broker, any attorney, any business consultant or professional, a market consultant or professional, a product development consultant or professional, or any provider, service provider, or any goods provider, or any funding source, any funding source employee, agent, or individual, or any investor or investment entity, or any facilitator, any middle man, any third party, any official filing office or agency, any official filing office or agency agent or employee, any social network member, any social networking entity, any media source or media source agent, employee, or individual, or any information source, or any information provider or news provider agent, employee, or individual, any patent broker or patent brokerage entity, any trademark broker or trademark brokerage entity, or any copyright broker or copyright brokerage entity, or any intellectual property broker or intellectual property brokerage entity, or any other person or entity who or which uses, or who or which can utilize the apparatus and method of the present invention.

The term “user”, or the plural of same, also means or refers to, any individual, person, business organization, company, corporation, partnership, limited liability company, or other entity, who or which utilizes, or who or which has associated therewith, a user communication device 20. The term “user”, or the plural of same, also means or refers to any inventor, creator, author, artist, intellectual property creator, intellectual property owner, intellectual property holder or holding entity, or any employee or agent of same, or any agent, any broker, any attorney, any business consultant or professional, any marketing consultant or professional, any product development consultant or professional, or any provider, any service provider, any goods provider, or any funding service or funding source, any funding service or funding source employee, agent, or individual, or any investor or investment entity, any deal facilitator, middleman, or third party, any agent, broker, patent broker or patent brokerage entity, trademark broker or trademark brokerage entity, or copyright broker or copyright brokerage entity, intellectual property broker or intellectual property brokerage entity, or any agent or employee of same, or any official or government filing office, agency, department, or bureau, or any employee or agent of same, any social network or any employee or agent of same, or any social networking member or any employee or agent of same, or any media service or source, information service or source, or any news service or source, or any employee or agent of same. The term “user”, or the plural of same, also means, or refers to, an employer, a hiring entity, an employee, a contractor, an independent contractor, a temporary worker, or a freelance worker or a freelancer. In this regard, a user, as that term is defined herein, or any user, can be an employer, a hiring entity, an employee, a contractor, an independent contractor, a temporary worker, or a freelance worker or a freelancer.

As used herein, the term “provider”, “service provider”, or “professional service provider”, or the plural of same, refers to, or means, any provider of any service or professional service, such as, but not limited to, an attorney, a business consultant, a computer programmer, a network engineer, an information technology professional, a software developer, a database developer, a software programmer, a designer, an engineer, a software architect, an application developer, a software application developer or programmer, an architect, an artist, a graphic designer, a web developer, a web site developer, a web hosting service, an accountant, a business plan writer, an electronic commerce consultant, a writer, an editor, a manufacturer, a product developer or product development individual, company, or entity, a mold maker, a product research individual, company, or entity, a marketer or a marketing individual, company, or entity, a patent attorney, a trademark attorney, a copyright attorney, a business attorney, a corporate attorney, a writer, an investor, an investment entity, or any provider or any other type or kind of provider of any service or of any professional service which can or which may be utilized in any effort or activity to in order to commercialize, develop, market, sell, transfer, license, monetize, or advertise, any intellectual property.

As used herein, the term “provider”, or the plurality of same, also refers to, or also means, any contractor, independent contractor, temporary worker, freelance worker or freelancer, or any employee or individual or entity who or which can be hired to perform any service, job, or task. As used herein, the term “provider”, or the plurality of same, also refers to, or also means, any providers or goods or products (also referred to herein as “goods providers”). As used herein, the term “provider”, or the plurality of same, also refers to, or also means, any funding service or investor, official or governmental filing office, agent or broker, social network or social networking company or entity, or any media service or media source, information service or information source, or news information service or news information source, as it is to be understood that each or any funding service or investor, official or governmental filing office, agent or broker, social network or social networking company or entity, or any media service or media source, information service or information source, or news information service or news information source is, or can be, a provider of a service, a food, or a product.

Applicant hereby incorporates by reference herein the subject matter and teachings of U.S. Provisional Patent Application Ser. No. 61/925,256, filed Jan. 9, 2014, and entitled “APPARATUS AND METHOD FOR PROVIDING AND/OR FOR PROCESSING INFORMATION FOR, REGARDING, AND/OR FOR FACILITATING, THE COMMERCIALIZATION, DEVELOPMENT, MARKETING, SALE, TRANSFER, LICENSING, AND/OR MONETIZATION, OF INTELLECTUAL PROPERTY”, the subject matter and teachings of which are hereby incorporated by reference herein in their entirety.

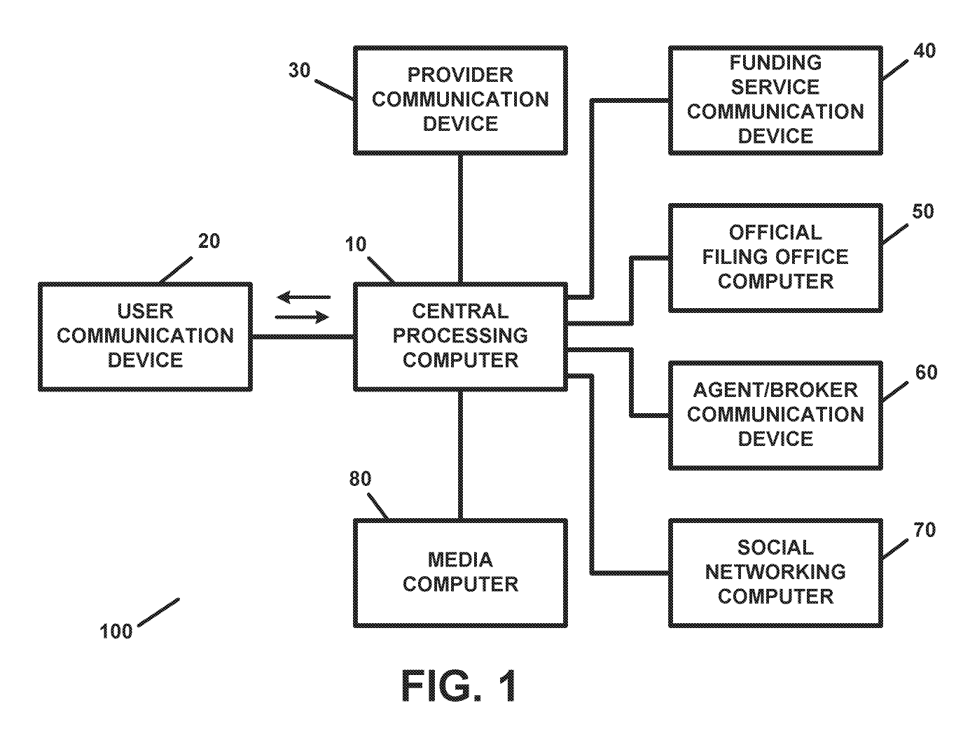

FIG. 1 illustrates the apparatus of the present invention, in block diagram form. The apparatus of the present invention is denoted generally by the reference numeral 100. In the preferred embodiment, the apparatus 100 of the present invention includes a central processing computer or central processing computer system 10 (hereinafter referred to as the “central processing computer 10”). In the preferred embodiment, the central processing computer 10 can be, or can include, any computer or system of computers, or a network computer or a server computer or any number of network computers or server computers.

In the preferred embodiment, the central processing computer 10 can provide control over the apparatus 100 and can perform any of the various processing services and/or functions described herein. The central processing computer 10 may be a single computer or system of computers and/or may be or may include a plurality of computers or computer systems which are utilized in conjunction with one another. The central processing computer 10, in the preferred embodiment, can provide or perform processing functionality for any of the other computers, computer systems, and/or communication devices, described herein as being used by or associated with any of the herein-described users, individuals, entities, business entities, providers, service providers, goods providers, funding sources or funding services or individuals associated therewith, official or governmental filing offices, agencies, or bureaus, agents, brokers, social networks, or media or information sources or services, who or utilize the apparatus 100 and method of the present invention.

The apparatus 100 also includes a user communication device or computer 20 (hereinafter referred to as “user communication device 20”) which is or can be used by, or which is or can be associated with, any user of the apparatus 100 and method of the present invention. As used herein, the term “user”, or the plural of same, means or refers to any individual, person, business or business entity, organization, or entity, who or which utilizes, or who or which has associated therewith, a user communication device 20. The term “user”, or the plural of same, also means or refers to any inventor, creator, author, artist, intellectual property creator, intellectual property owner, intellectual property holder or holding entity, or any employee or agent of same, or any agent, any broker, any attorney, any business consultant or professional, any marketing consultant or professional, any product development consultant or professional, or any provider, any service provider, any goods provider, or any funding service or funding source, any funding service or funding source employee, agent, or individual, or any investor or investment entity, any deal facilitator, middleman, or third party, any agent, broker, patent broker or patent brokerage entity, trademark broker or trademark brokerage entity, or copyright broker or copyright brokerage entity, or any intellectual property agent or intellectual property broker, or any agent or employee of same, or any official or government filing office, agency, department, or bureau, or any employee or agent of same, any social network or any employee or agent of same, or any social networking member or any employee or agent of same, or any media service or source, information service or source, or any news service or source, or any employee or agent of same. The term “user”, or the plurality of same, also means or refers to any individual, employer, or hiring entity, who or which can employ, engage, or hire, any individual or entity, on a permanent basis, on a temporary basis, on a task-by-task basis, on a seasonal basis, on a contract basis or pursuant to a contract, or on a freelance basis, to perform any job, task, or service, or any individual, entity, contractor, independent contractor, temporary worker, or freelance worker or freelancer, who or which can be hired, employed, or engaged, to perform a task, job, of service.

Any number or amount of user communication devices 20 can be utilized in connection with the apparatus 100 of the present invention. Any number or amount of user communication devices 20 can also be utilized by, or can be associated with, any user. The user communication device(s) 20 can communicate with, and can operate in conjunction with, the central processing computer 10 and/or any of the other communication devices, computers, and/or computer systems, described herein which can be associated with, or which can be used by, any of the users, individuals, and/or entities, who or which utilize the apparatus 100 of the present invention.

The apparatus 100 can also include a provider computer or communication device 30 (hereinafter “provider communication device 30”) which can be associated with, or which can be utilized by, any provider, or any employee or agent of any provider, who or which utilizes the apparatus 100 and method of the present invention.

Any number or amount of provider communication device 30 can be utilized in connection with the apparatus 100 of the present invention. Any number or amount of provider communication devices 30 can also be utilized by, or can be associated with, any provider. The provider communication device(s) 30 can communicate with, and can operate in conjunction with, the central processing computer 10 and/or any of the other communication devices, computers, and/or computer systems, described herein which can be associated with, or which can be used by, any of the users, individuals, and/or entities, who or which utilize the apparatus 100 of the present invention.

The apparatus 100 can also include a funding service or funding source computer or communication device 40 (hereinafter “funding service communication device 40”) which can be associated with, or which can be utilized by, any funding service, funding source, fund raising service or source, bank, credit union, investment bank, crowd funding company, crowd funding service, investor, angel investor, lender, or any other individual or entity who or which can assist in raising money, in lending money, in contributing money or services, goods, or products, or in investing money or services, goods, or products, in or for any efforts regarding or relating to any commercialization, development, marketing, sale, transfer, licensing, and/or monetization, of any intellectual property, or for facilitating any commercialization, development, marketing, sale, transfer, licensing, and/or monetization, of any intellectual property, or any employees or agents of same (hereinafter referred to as “funding service” or “funding source”), who or which utilizes the apparatus 100 and method of the present invention.

Any number or amount of funding service communication devices 40 can be utilized in connection with the apparatus 100 of the present invention. Any number or amount of funding service communication devices 40 can also be utilized by, or can be associated with, any funding service or funding source. The funding service communication device(s) 40 can communicate with, and can operate in conjunction with, the central processing computer 10 and/or any of the other communication devices, computers, and/or computer systems, described herein which can be associated with, or which can be used by, any of the users, individuals, and/or entities, who or which utilize the apparatus 100 of the present invention.

The apparatus 100 can also include an official or governmental filing office computer or communication device 50 (hereinafter “official filing office computer 50”) which can be associated with, or which can be utilized by, any national, regional, or governmental, patent office, trademark office, copyright office, or any other office, agency, department, or bureau, which governs or is responsible for the filing, examination, or issuance, or registration or maintenance, of or for any type, kind, or form, of intellectual property for any nation or country, or for any groups or regions of nations or countries (hereinafter “official filing office), or any employee or agent of same, who or which utilizes the apparatus 100 and method of the present invention.

Any number or amount of official filing office computers 50 can be utilized in connection with the apparatus 100 of the present invention. Any number or amount of official filing office computers 50 can also be utilized by, or can be associated with, any official filing office. The official filing office computer(s) 50 can communicate with, and can operate in conjunction with, the central processing computer 10 and/or any of the other communication devices, computers, and/or computer systems, described herein which can be associated with, or which can be used by, any of the users, individuals, and/or entities, who or which utilize the apparatus 100 of the present invention.

The apparatus 100 can also include an agent or broker communication device or computer 60 (hereinafter “agent/broker communication device 60”) which can be utilized by any agent, broker, patent broker or patent brokerage entity, trademark broker or trademark brokerage entity, or copyright broker or copyright brokerage entity, or any intellectual property agent or intellectual property broker, or any agent or employee of same, who or which can provide any service for, or represent, any owner or holder or any right, title, or interest, in any intellectual property, or for any employee or agent of same, or who or which can provide any service for, or represent, any user of the apparatus 100 of the present invention described herein or otherwise.

Any number or amount of agent/broker communication devices 60 can be utilized in connection with the apparatus 100 of the present invention. Any number or amount of agent/broker communication devices 60 can also be utilized by, or can be associated with, any agent, broker, patent broker or patent brokerage entity, trademark broker or trademark brokerage entity, or copyright broker or copyright brokerage entity, or any intellectual property agent or intellectual property broker, or any agent or employee of same, who or which can provide any service for, or represent, any owner or holder or any right, title, or interest, in any intellectual property, or for any employee or agent of same, or who or which can provide any service for, or represent, any user of the apparatus 100 of the present invention described herein or otherwise. The agent/broker communication device(s) 60 can communicate with, and can operate in conjunction with, the central processing computer 10 and/or any of the other communication devices, computers, and/or computer systems, described herein which can be associated with, or which can be used by, any of the users, individuals, and/or entities, who or which utilize the apparatus 100 of the present invention.

The apparatus 100 can also include a social networking computer or communication device 70 (hereinafter “social networking computer 70”) which can be utilized by or which can be associated with any social network, social networking company, social networking website, or any member, employee, or agent, of same, who or which utilizes the apparatus 100 and method of the present invention.

Any number or amount of social networking computers 70 can be utilized in connection with the apparatus 100 of the present invention. Any number or amount of social networking computers 70 can also be utilized by, or can be associated with, any social network, social networking company, social networking website, or any member, employee, or agent, of same. The social networking computer(s) 70 can communicate with, and can operate in conjunction with, the central processing computer 10 and/or any of the other communication devices, computers, and/or computer systems, described herein which can be associated with, or which can be used by, any of the users, individuals, and/or entities, who or which utilize the apparatus 100 of the present invention.

The apparatus 100 can also include a media computer or communication device 80 (hereinafter “media computer 80”) which can be utilized by or which can be associated with any media service or media source, information service or information source, or news service or news source, or any employee, or agent, of same, who or which utilizes the apparatus 100 and method of the present invention. In a preferred embodiment, any media computer 80 can provide any media, information, news, any news relating to intellectual property, or any news regarding patents, trademarks, copyrights, or trade secrets, or news information, business news information, financial news information, or any current events information, or any intellectual property information, intellectual property-related information, or any information regarding current events, or any advertisements and/or any marketing information or materials, which can be disseminated via the apparatus 100 of the present invention.

Any number or amount of media computers 80 can be utilized in connection with the apparatus 100 of the present invention. Any number or amount of media computers 80 can also be utilized by, or can be associated with, any media service or media source, information service or information source, or news service or news source, or any employee, or agent, of same. The media computer(s) 80 can communicate with, and can operate in conjunction with, the central processing computer 10 and/or any of the other communication devices, computers, and/or computer systems, described herein which can be associated with, or which can be used by, any of the users, individuals, and/or entities, who or which utilize the apparatus 100 of the present invention.

In the preferred embodiment, any of the user communication device(s) 20, the provider communication device(s) 30, the funding service communication device(s) 40, the official filing office computer(s) 50, the agent/broker communication device(s) 60, the social networking computer(s) 70, and/or the media computer(s) 80, can be any computer or communication device, including, but not limited to, a personal computer, a home computer, a server computer, a network computer, a hand-held computer, a palmtop computer, a laptop computer, a tablet, a tablet computer, a personal communication device, a cellular telephone, a wireless telephone, a Smartphone or smart phone, a mobile telephone, a digital television, an interactive television, a digital television, a personal digital assistant, a telephone, a digital telephone, a television, an interactive television, a beeper, a pager, and/or a watch.

Each of the central processing computer(s) 10, the user communication device(s) 20, the provider communication device(s) 30, the funding service communication device(s) 40, the official filing office computer(s) 50, the agent/broker communication device(s) 60, the social networking computer(s) 70, and/or the media computer(s) 80, can transmit information to, as well as receive information from, any of the computers or communications devices 10, 20, 30, 40, 50, 60, 70, and 80 described herein. In this regard, each of the computers or communications devices 10, 20, 30, 40, 50, 60, 70, and 80, can communicate with, process information from, and/or share data and/or information with, each other and/or any other computers or communications devices 10, 20, 30, 40, 50, 60, 70, and 80, described herein and/or utilized in conjunction with the present invention. In this manner, data and/or information transfer between any of the computers or communications devices 10, 20, 30, 40, 50, 60, 70, and 80, can be performed or effectuated with any other computers or communications devices 10, 20, 30, 40, 50, 60, 70, and 80 in a bi-directional manner.

In a preferred embodiment, the central processing computer(s) 10, the user communication device(s) 20, the provider communication device(s) 30, the funding service communication device(s) 40, the official filing office computer(s) 50, the agent/broker communication device(s) 60, the social networking computer(s) 70, and/or the media computer(s) 80, can communicate with one another, and/or can be linked to one another, over a communication network, a telecommunication network, a telephone network, a line-connected network, and/or a wireless communication network. Each of the computers or communication devices 10, 20, 30, 40, 50, 60, 70, and 80, can be linked with any other computer or computers or communication device or communication devices directly or indirectly so as to facilitate a direct or indirect bi-directional communication with and between said respective computers or communication devices. Communications between each of the computers or communication devices 10, 20, 30, 40, 50, 60, 70, and 80 can also involve an e-mail server or e-mail servers in those instances when e-mails are described as being used to transmit or to send any of the information, signals, messages, reports, notification messages, or any other communications, described herein, by or between any of the computers or communication devices 10, 20, 30, 40, 50, 60, 70, or 80, or when any of the information, signals, messages, reports, notification messages, or any other communications, described herein, are transmitted by and/or between any of the users or parties described herein and/or by or between any of the computers or communication devices 10, 20, 30, 40, 50, 60, 70, or 80, or any other computers or communication devices, computer systems, communication network equipment, or server computers, etc., or any other devices used or needed in order to facilitate communications or the transmission of any of the herein-described information, signals, messages, reports, notification messages, or any other communications.

In a preferred embodiment, each of the central processing computer(s) 10, the user communication device(s) 20, the provider communication device(s) 30, the funding service communication device(s) 40, the official filing office computer(s) 50, the agent/broker communication device(s) 60, the social networking computer(s) 70, and/or the media computer(s) 80, can communication in a bi-directional manner with, and/or can send and/or receive signals, messages, reports, notification messages, alerts, or any other communications or electronic communication transmissions, to, from and/or between, any other, or any number of, other central processing computer(s) 10, if utilized, user communication device(s) 20, provider communication device(s) 30, funding service communication device(s) 40, official filing office computer(s) 50, agent/broker communication device(s) 60, social networking computer(s) 70, and/or media computer(s) 80.

In a preferred, each of the central processing computer(s) 10, the user communication device(s) 20, the provider communication device(s) 30, the funding service communication device(s) 40, the official filing office computer(s) 50, the agent/broker communication device(s) 60, the social networking computer(s) 70, and/or the media computer(s) 80, can be linked to or with any other central processing computer(s) 10, if utilized, user communication device(s) 20, provider communication device(s) 30, funding service communication device(s) 40, official filing office computer(s) 50, agent/broker communication device(s) 60, social networking computer(s) 70, and/or media computer(s) 80, via a wired link or line or a wireless link.

In a preferred embodiment, each of the user communication device(s) 20, the provider communication device(s) 30, the funding service communication device(s) 40, the official filing office computer(s) 50, the agent/broker communication device(s) 60, the social networking computer(s) 70, and/or the media computer(s) 80, can be connected with or linked with the central processing computer 10 as shown in FIG. 1.

In a preferred embodiment, any and/or all of the signals, messages, reports, notification messages, or any other communications, described herein as being transmitted from one device, computer, or communication device, to another, can be, or can be included in, or be attached to, an e-mail message, an instant messaging message, an electronic transmission, or an electronic data transmission or electronic data interchange, or can be transmitted via any other data or information transmission, and can be transmitted via or using any appropriate or necessary computer(s) or device(s).

In the preferred embodiment, the present invention is utilized on, and/or over, the Internet and/or the World Wide Web. The present invention, in the preferred embodiment, can also utilize wireless Internet and/or World Wide Web services, equipment and/or devices. The central processing computer(s) 10, in the preferred embodiment, has a web site or web sites associated therewith. Each of the other computers or communication devices described herein can also have a web site or web sites associated with same.

Although the Internet and/or the World Wide Web is a preferred communication system and/or medium utilized, the present invention, in any and/or all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

In the preferred embodiment, each of the central processing computer(s) 10, the user communication device(s) 20, the provider communication device(s) 30, the funding service communication device(s) 40, the official filing office computer(s) 50, the agent/broker communication device(s) 60, the social networking computer(s) 70, and/or the media computer(s) 80, can transmit data and/or information using TCP/IP, as well as any other Internet and/or World Wide Web, and/or communication, protocols.

The apparatus 100 of the present invention can also utilize electronic commerce technologies and security methods, techniques and technologies, in any and/or all of the instances of data and/or information processing, and/or data and/or information transmission, described herein.

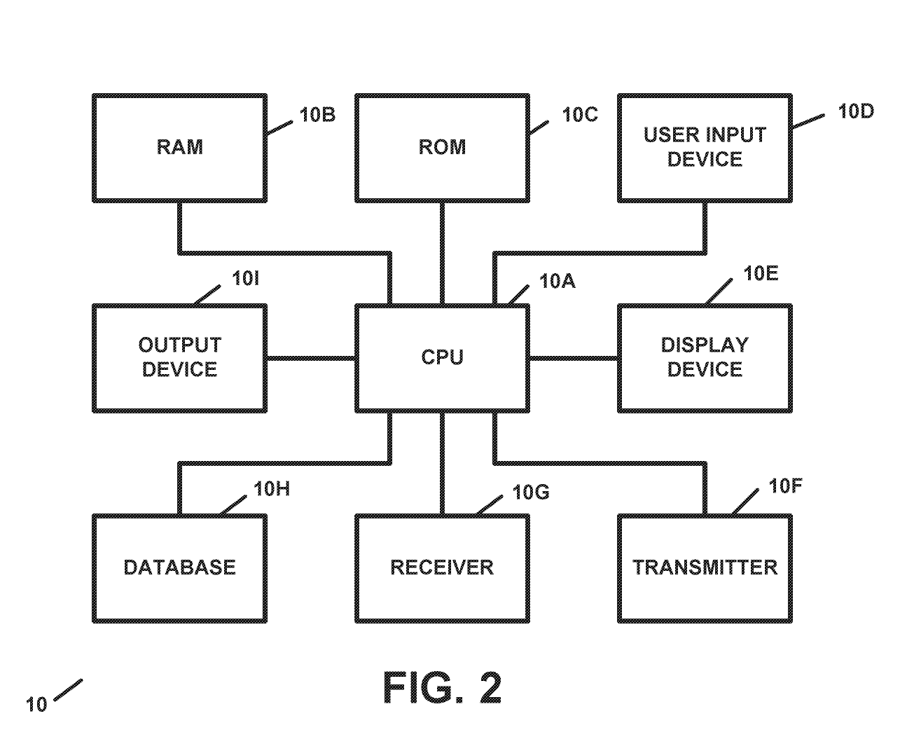

FIG. 2 illustrates the central processing computer 10 of FIG. 1, in block diagram form. The central processing computer 10, in the preferred embodiment, is a network computer or computer system, or any other communication device which can provide the functionality of, and which can be utilized as a central processing computer such as an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, a user input device 10D, for entering data and/or commands into the central processing computer 10, which includes any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise which can be utilized for inputting and/or entering data, information, or commands, into the central processing computer 10, which input device(s) are also connected to the CPU 10A. The central processing computer 10 also includes a display device 10E for displaying data and/or information to a user or operator.

The central processing computer 10 also includes a transmitter(s) 10F, for transmitting signals and/or data and/or information to any one or more of any other central processing computer(s) 10, the user communication device(s) 20, the provider communication device(s) 30, the funding service communication device(s) 40, the official filing office computer(s) 50, the agent/broker communication device(s) 60, the social networking computer(s) 70, and/or the media computer(s) 80, or any other computers or communication devices or individual computer(s), which may be utilized in conjunction with the present invention. The central processing computer 10 also includes a receiver 10G, for receiving signals and/or data and/or information from any one or more of any other central processing computer(s) 10, the user communication device(s) 20, the provider communication device(s) 30, the funding service communication device(s) 40, the official filing office computer(s) 50, the agent/broker communication device(s) 60, the social networking computer(s) 70, and/or the media computer(s) 80, or any other computers or communication devices or individual computer(s), which may be utilized in conjunction with the present invention.

The central processing computer 10 also includes a database(s) 10H which contains and/or includes any data and/or information needed or desired for enabling the central processing computer 10 and/or the apparatus 100 to perform all of the functions and/or functionality described herein as being performed, or as being capable of being performed, by the apparatus 100 and methods of the present invention.

In a preferred embodiment, the database 10H can contain and/or can include, for each user, information regarding the user's name, address, telephone number, cellular telephone number, wireless telephone number, e-mail address, text messaging number, SMS messaging number, company name or business name, company telephone number or business telephone number, company e-mail address or business e-mail address, the user's agent's name, the user's agent's telephone number, the user's agent's cellular telephone number, the user's agent's wireless telephone number, the user's agent's e-mail address, the user's text messaging number, the user's SMS messaging number, and/or any other contact information for the user and/or for the user's agent.

In a preferred embodiment, the database 10H can also contain and/or can include, for each user, information regarding any of the user's intellectual property. For example, in a preferred embodiment, the database 10H can contain and/or can include, for each user, information regarding any of the user's intellectual property, the user's patent(s), the user's patent application(s), the user's domestic patent(s), the user's domestic patent application(s), the user's provisional patent application(s) either domestic or foreign, the user's foreign patent(s) or the user's regional patents, the user's foreign patent application(s) or the user's regional patent applications, the user's PCT patent applications, or any other types or kinds of patent or patent-related protections or international patent or patent-related protections of the user, or information regarding any of the user's trademark(s), the user's trademark application(s), the user's domestic trademark (s), the user's domestic trademark application(s), the user's foreign trademark(s) or the user's regional trademark(s), the user's foreign trademark application(s) or the user's regional trademark applications, the user's international trademark applications, or any other types or kinds of trademark, service mark, or mark, protections, either domestic or foreign, of the user, or information regarding any of the user's copyrights(s), the user's copyrighted works, the user's copyright application(s), the user's domestic copyrights (s) or copyrighted works, the user's domestic copyright application(s), the user's foreign copyright(s) or the user's regional copyright(s), the user's foreign copyright application(s) or the user's regional copyright applications, the user's international copyright applications, or any other types or kinds of copyright protections, either domestic or foreign, of the user. The database 10H can also contain and/or can include, for each user, information regarding any other types or kinds of intellectual property or intellectual property-related protections or any international intellectual property or intellectual property-related protections.

For each type of intellectual property of, owned by, or controlled by, the user, the database 10H can also contain and/or include data and/or information regarding each item of intellectual property, each patent, each patent application, each provisional patent application, each foreign patent application, each foreign patent, each PCT application, each regional patent, or each regional patent application, or each trademark, each trademark application, each foreign trademark, each foreign trademark application, or each convention trademark application, or each copyright, each copyright application, each foreign copyright, each foreign copyright application, or each convention copyright.

For each patent or patent application of any kind or type, domestic or foreign, the database 10H can include a patent number or a patent application derail number, a name of the patent or a name of the patent application, a description of the invention described in or covered by the patent or the patent application, a copy of the patent or the patent application or a link or a hyperlink to a copy of the patent or the patent application, the filing date of the patent or the patent application, the priority date of the patent or the patent application, the country or countries in which protection have been sought for the inventions described or covered by the patent or the patent application, the status of the patent or the patent application, the inventor(s) of the patent or the patent application, the assignee, if any, of the patent or the patent application, the status of payment of any fees or maintenance fees for any patent, and/or the date and/or time of the posting, listing, or registration, of the patent or the patent application with the apparatus 100.

The database 10H can also contain and/or include, for each user, any data and/or information regarding what the user desires or plans to do with the patent or the patent application or any invention covered by same or described by same, including, but not limited to, any information regarding whether or not the user wants to commercialize the invention covered by or described in the patent or the patent application, information regarding whether or not the user wants to develop, produce, market, and/or sell, any goods, products, or services, covered by the invention covered by or described in the patent or the patent application, information regarding whether or not the user wants to start a company or a business entity to develop, produce, market, and/or sell, any goods, products, or services, covered by the invention covered by or described in the patent or the patent application, information regarding whether or not the user wants to find a partner(s) or investor(s) to develop, produce, market, and/or sell, any goods, products, or services, covered by the invention covered by or described in the patent or the patent application, information regarding whether or not the user wants to find a provider of any services, goods, or products, in order to assist the user or to aid the user in developing, producing, marketing, and/or selling, any goods, products, or services, covered by the invention covered by or described in the patent or the patent application, information regarding whether or not the user wants to find a provider of any services, goods, or products, in order to assist the user or to aid the user in obtaining protection for, in obtaining additional protection for, or in further developing and/or protecting additional patents or other intellectual property relating to or regarding, the patent or the patent application, information regarding whether or not the user wants to find an attorney or other professional to represent the user in obtaining protection for, in obtaining additional protection for, or to further developing and/or protecting additional patents or other intellectual property relating to or regarding, the patent or the patent application, information regarding whether or not the user wants to sell, assign, transfer, license, license in a field or use, exclusively license, exclusively license in a field of use, non-exclusively license, non-exclusively license in a field of use, market, or monetize, the invention(s) covered by or described in the patent or the patent application, information regarding whether or not the user wants to sell, assign, transfer, license, license in a field or use, exclusively license, exclusively license in a field of use, non-exclusively license, non-exclusively license in a field of use, market, or monetize, any foreign country counterparts to the patent or the patent application or any foreign patents or patent applications relating to same, information regarding any user asking prices or any offering prices for selling, assigning, transferring, licensing, exclusively licensing, non-exclusively licensing, or otherwise monetizing, the patent or the patent application, or information regarding whether or not the user is seeking any partners, strategic partners, joint ventures, or joint venture partners, or others, in the user's efforts or activities in commercializing, developing, marketing, selling, transferring, licensing, and/or monetizing, the patent or the patent application or any inventions covered by same or described in same, or any information regarding the user's expectations, needs, or desires regarding same, information regarding any hiring needs of the user, or information regarding the user's needs, plans, strategies, or desires, for the patent or the patent application, information regarding any work schedule or scheduling needs of the user, and/or any other information regarding the user, the patent, or the patent application, the user's needs, plans, strategies, or desires, for or regarding the patent or the patent application, or any other information which would be needed or desired for or regarding the user, the patent, or the patent application, relating to the user's use of the apparatus 100 of the present invention for, relating to, or regarding, the patent or the patent application.

For each trademark or trademark application of any kind or type, domestic or foreign, the database 10H can include a trademark number or a trademark application serial number, the name or a description of the trademark, a description of the goods, products, or services, with which the trademark is utilized, a copy of the trademark or the trademark application or a link or a hyperlink to a copy of the trademark or the trademark application, the filing date of the trademark or the trademark application, the priority date of the trademark or the trademark application, the country or countries in which protection have been sought for the trademark, the status of the trademark or the trademark application, the applicant(s) for the trademark or the trademark application, the assignee, if any, of the trademark or the trademark application, the status of payment of any fees or renewal fees for the trademark, and/or the date and/or time of the posting, listing, or registration, of the trademark or the trademark application with the apparatus 100.

The database 10H can also contain and/or include, for each user, any data and/or information regarding what the user desires or plans to do with the trademark or the trademark application, including, but not limited to, any information regarding whether or not the user wants to commercialize any goods, products, or services, under the trademark or the trademark application, information regarding whether or not the user wants to develop, produce, market, and/or sell, any goods, products, or services, under the trademark or the trademark application, information regarding whether or not the user wants to start a company or a business entity using the trademark and/or to develop, produce, market, and/or sell, any goods, products, or services, under the trademark or the trademark application, information regarding whether or not the user wants to find a partner(s) or investor(s) to develop, produce, market, and/or sell, any goods, products, or services, under the trademark or the trademark application, information regarding whether or not the user wants to find a provider of any services, goods, or products, in order to assist the user or to aid the user in developing, producing, marketing, and/or selling, any goods, products, or services, under the trademark or the trademark application, information regarding whether or not the user wants to find a provider of any services, goods, or products, in order to assist the user or to aid the user in obtaining protection for, in obtaining additional protection for, or in further developing and/or protecting additional trademarks or other intellectual property relating to or regarding, the trademark or the trademark application, or information regarding whether or not the user wants to find an attorney or other professional to represent the user in obtaining protection for, in obtaining additional protection for, or in further developing and/or protecting additional trademarks or other intellectual property relating to or regarding the trademark or the trademark application, or information regarding whether or not the user wants to sell, assign, transfer, license, license in a field or use, exclusively license, exclusively license in a field of use, non-exclusively license, non-exclusively license in a field of use, market, or monetize, the trademark or the trademark application or any goods, products, or services, under the trademark or the trademark application, or information regarding whether or not the user wants to sell, assign, transfer, license, license in a field or use, exclusively license, exclusively license in a field of use, non-exclusively license, non-exclusively license in a field of use, market, or monetize, any foreign country counterparts to the trademark or the trademark application or any foreign trademarks or trademark applications relating to same, or information regarding any user asking prices or any offering prices for selling, assigning, transferring, licensing, exclusively licensing, non-exclusively licensing, or otherwise monetizing, the trademark or the trademark application, information regarding whether or not the user is seeking any partners, strategic partners, joint ventures, or joint venture partners, or others, in the user's efforts or activities in commercializing, developing, marketing, selling, transferring, licensing, and/or monetizing, the trademark or the trademark application or any goods, products, or services, under the trademark or the trademark application, or any information regarding the user's expectations, needs, or desires regarding same, or information regarding any hiring needs of the user, information regarding the user's needs, plans, strategies, or desires, for the trademark or the trademark application, information regarding any work schedule or scheduling needs of the user, and/or any other information regarding the user, the trademark, or the trademark application, the user's needs, plans, strategies, or desires, for or regarding the trademark or the trademark application, or any other information which would be needed or desired for or regarding the user, the trademark, or the trademark application, relating to the user's use of the apparatus 100 of the present invention for, relating to, or regarding, the trademark or the trademark application.

For each copyright, copyrighted work, or copyright application, of any kind or type, domestic or foreign, the database 10H can include a copyright number of a copyright application serial number, the name or a description of the copyrighted work, the copyright, of the copyright application, a description of the copyrighted work, the copyright, of the copyright application, a copy of the copyrighted work, the copyright, or the copyright application, or a link or a hyperlink to a copy of the copyrighted work, the copyright, or the copyright application, the date of creation of the copyrighted work or the date of filing of the copyright or the copyright application, any first publication date or other priority date of the copyrighted work, the country or countries in which protection has been sought for the copyrighted work, the copyright, or the copyright application, the status of the copyright or the copyright application, the author, creator, or applicant for the copyright or the copyright application, the assignee, if any, of the copyrighted work, the copyright, or the copyright application, the status of payment of any fees or renewal fees for the copyright, and/or the date and/or time of the posting, listing, or registration, of the copyrighted work, the copyright, or the copyright application with the apparatus 100.

The database 10H can also contain and/or include, for each user, any data and/or information regarding what the user desires or plans to do with the copyrighted work, the copyright, or the copyright application, including, but not limited to, any information regarding whether or not the user wants to commercialize the copyrighted work, the copyright, or the copyright application, information regarding whether or not the user wants to develop, produce, market, and/or sell, the copyrighted work, the copyright, or the copyright application, and/or any goods, products, or services, under the copyright or the copyright application, information regarding whether or not the user wants to start a company or a business entity to commercialize or exploit the copyrighted work and/or to develop, produce, market, and/or sell, the copyrighted work and/or any goods, products, or services, relating to same, information regarding whether or not the user wants to find a partner(s) or investor(s) to develop, produce, market, and/or sell, any copyrighted work and/or any goods, products, or services, relating to same, information regarding whether or not the user wants to find a provider of any services, goods, or products, in order to assist the user or to aid the user in developing, producing, marketing, and/or selling, the copyrighted work and/or any goods, products, or services, relating to same, information regarding whether or not the user wants to find a provider of any services, goods, or products, in order to assist the user or to aid the user in obtaining protection for, in obtaining additional protection for, or in further developing and/or protecting additional copyrighted works and/or any goods, products, or services, relating to same, or information regarding whether or not the user wants to find an attorney or other professional to represent the user in obtaining protection for, in obtaining additional protection for, or in further developing and/or protecting additional, copyrighted works, the copyrighted work or other intellectual property relating to or regarding the copyrighted work, the copyright, or the copyright application, or information regarding whether or not the user wants to sell, assign, transfer, license, license in a field or use, exclusively license, exclusively license in a field of use, non-exclusively license, non-exclusively license in a field of use, market, or monetize, the copyrighted work, the copyright, or the copyright application, or any goods, products, or services, under the copyright or the copyright application, or information regarding whether or not the user wants to sell, assign, transfer, license, license in a field or use, exclusively license, exclusively license in a field of use, non-exclusively license, non-exclusively license in a field of use, market, or monetize, any foreign country counterparts to the copyrighted work, the copyright, or the copyright application, or any foreign copyrighted works, copyrights, or copyright applications, or information regarding any user asking prices or any offering prices for selling, assigning, transferring, licensing, exclusively licensing, non-exclusively licensing, or otherwise monetizing, the copyrighted work, the copyright, or the copyright application, or information regarding whether or not the user is seeking any partners, strategic partners, joint ventures, or joint venture partners, or others, in the user's efforts or activities in commercializing, developing, marketing, selling, transferring, licensing, and/or monetizing, the copyrighted work, the copyright, or the copyright application or any goods, products, or services, relating to the copyrighted work, the copyright, or the copyright application or any information regarding the user's expectations, needs, or desires regarding same, or information regarding any hiring needs of the user, information regarding the user's needs, plans, strategies, or desires, for the copyrighted work, the copyright, or the copyright application, information regarding any work schedule or scheduling needs of the user, and/or any other information regarding the user, copyrighted work, the copyright, or the copyright application, the user's needs, plans, strategies, or desires, for or regarding the copyrighted work, the copyright, or the copyright application or any other information which would be needed or desired for or regarding the user, copyrighted work, the copyright, or the copyright application, relating to the user's use of the apparatus 100 of the present invention for, relating to, or regarding, copyrighted work, the copyright, or the copyright application.

The database 10H can also contain and/or include any link(s) or hyperlink(s) to any respective intellectual property of the user, a link(s) or a hyperlink(s) to the user communication device(s) 20 of or associated with the user, and/or any other data and/or information needed or desired for utilizing the apparatus 100 and method of the present invention in any of the embodiments described herein. The database 10H can also, for each user or for each item of intellectual property associated with that user, contain and/or include, and/or contain and/or include a link(s) or a hyperlink(s) to, any data and/or information maintained by, provided by, offered by, or sold by, the user and/or which can be accessed or obtained from the user or any computer, server, or web site, of same.

In a preferred embodiment, the database 10H can contain and/or can include, for each provider, service provider, goods provider (hereinafter “provider”) who or which utilizes the apparatus 100 and method of the present invention, information regarding the provider's name, address, telephone number, cellular telephone number, wireless telephone number, e-mail address, text messaging number, SMS messaging number, company name or business name, company telephone number or business telephone number, company e-mail address or business e-mail address, the provider's agent's name, the provider's agent's telephone number, the provider's agent's cellular telephone number, the provider's agent's wireless telephone number, the provider's agent's e-mail address, the provider's text messaging number, the provider's SMS messaging number, and/or any other contact information for the provider and/or for the provider's agent.

The database 10H can also contain and/or include, for each provider, a description of the types or kinds of the services and/or the goods or products, provided, offered, or performed by the provider, information regarding the prices, fees, or charges, for the provider's various services, goods, or products, information regarding educational or training information, professional or other licenses or certifications, work samples, references, past work performed, past project or work experiences, desired projects or jobs, types or kinds of projects, compensation structures, marketing information and/or materials of or regarding the provider, and/or information regarding employees, partners, business partners, working partners, or agents, of the provider.

The database 10H can also contain and/or include, for each provider, information regarding the provider's, or the provider's employees' or agents′, work schedule(s), work calendar(s), or other scheduling information, which can be utilized to allow any user of the apparatus 100 to engage or reserve the provider's, or the provider's employees' or agents' services. The database 10H can also contain and/or include information for allowing any user of the apparatus 100 to order or purchase goods, products, or services, from the provider.

The database 10H can also contain and/or include, for each provider, information regarding any available subscriptions offered by the provider for any services, goods, or products, performed by or offered by the provider, so that any user can purchase a subscription from the provider for any services, or goods or products, performed by or offered by the provider.

The database 10H can also contain and/or include, for each provider, any link(s) or hyperlink(s) to the provider, a link(s) or a hyperlink(s) to the provider communication device(s) 30 of or associated with the provider, and/or any other data and/or information needed or desired for utilizing the apparatus 100 and method of the present invention in any of the embodiments described herein. The database 10H can also, for each provider, contain and/or include, and/or contain and/or include, a link(s) or a hyperlink(s) to, any data and/or information maintained by, provided by, offered by, or sold by, the provider and/or which can be accessed or obtained from the provider or any computer, server, or website, of same.

In a preferred embodiment, the database 10H can contain and/or can include, for each funding service or funding source (hereinafter “funding service”) who or which utilizes the apparatus 100 and method of the present invention, information regarding the funding service's name, address, telephone number, cellular telephone number, wireless telephone number, e-mail address, text messaging number, SMS messaging number, names of principals, employees or agents and contact information for same, company name or business name, company telephone number or business telephone number, company e-mail address or business e-mail address, the funding service's agent's name, the funding service's agent's telephone number, the funding service's agent's cellular telephone number, the funding service's agent's wireless telephone number, the funding service's agent's e-mail address, the funding service's text messaging number, the funding service's SMS messaging number, and/or any other contact information for the funding service and/or for the funding service's, principals, employees, or agents.

The database 10H can also contain and/or include, for each funding service, a description of the types or kinds of funding services, and/or any goods or products, provided, offered, or performed, by the funding service, information regarding the commissions, success fees, prices, fees, or charges, for the funding service's various services, goods, or products, information regarding educational or training information, professional or other licenses or certifications, work samples, references, past work performed, past deals worked on or completed, past investments made, past project or work experiences, desired investments, projects or jobs, types or kinds of projects, compensation structures, marketing information and/or materials of or regarding the funding service, and/or information regarding principals, employees, partners, business partners, working partners, or agents, of the funding service.

The database 10H can also contain and/or include, for each funding service, information regarding the funding service's, or the funding service's employees' or agents′, work schedule(s), work calendar(s), or other scheduling information, which can be utilized to allow any user of the apparatus 100 to engage or reserve the funding service's, or the funding service's employees' or agents' services. The database 10H can also contain and/or include information for allowing any user of the apparatus 100 to order or purchase goods, products, or services, from the funding service or engage the services of the funding service or the services or any principals, employees, or agents, of the funding service.

The database 10H can also contain and/or include, for each funding service, information regarding any available subscriptions offered by the funding service for any services, goods, or products, performed by or offered by the funding service, so that any user can purchase a subscription from the funding service for any services, or goods or products, performed by or offered by the funding service.

The database 10H can also, for each funding service, contain and/or include any link(s) or hyperlink(s) to the funding service, a link(s) or a hyperlink(s) to the funding service communication device(s) 40 of or associated with the funding service, and/or any other data and/or information needed or desired for utilizing the apparatus 100 and method of the present invention in any of the embodiments described herein.

The database 10H can also, for each funding service, contain and/or include, and/or contain and/or include a link(s) or a hyperlink(s) to, any data and/or information maintained by, provided by, offered by, or sold by, the funding service and/or which can be accessed or obtained from the funding service or any computer, server, or website, of same.

In a preferred embodiment, the database 10H can contain and/or can include, for each official or governmental filing office which utilizes the apparatus 100 of the present invention, information regarding the name of the official or governmental filing office and its address, its telephone number(s), and/or a listing of its directors, employees, or agents, including, but not limited to their names, telephone numbers, e-mail addresses, text messaging numbers, SMS messaging numbers, department, work group, or art unit, identifying information, and/or any other contact information for the official or governmental filing office. The database 10H can also contain and/or include, for each official or governmental filing office, a link(s) or hyperlink(s) to the official or governmental filing office, to any of its departments, work groups, or art units, or to any of its directors, employees, or agents.

The database 10H can also contain and/or include, for each official or governmental filing office, any information regarding, and/or any link(s) or hyperlink(s) to, any and/or all of the respective patents, patent applications, trademarks, trademark applications, copyrights, copyright applications, or any other intellectual property, the respective official or governmental filing office has issued and/or is currently examining or reviewing, information regarding the status of any issued patents, patent applications, trademarks, trademark applications, copyrights, copyright applications, or any other intellectual property, the status of the payment or the non-payment of any filing fees, examination fees, issue fees, maintenance fees, or renewal, or any other fees, and/or the status of fees owed any issued patents, patent applications, trademarks, trademark applications, copyrights, copyright applications, or any other intellectual property.

The database 10H can also contain and/or include, for each official or governmental filing office, information regarding, electronic copies of, access to physical copies of, and/or a link(s) or a hyperlink(s) to, any recorded documents, assignments, licenses, covenants not to sue, releases, transfers, liens, or any other documents recorded for or regarding any of the patents, patent applications, trademarks, trademark applications, copyrights, copyright applications, or any other intellectual property. For each patent, patent application, trademark, trademark application, copyright, copyright application, or other intellectual property, the database 10H can contain or include information regarding the name, address, telephone number, company name, e-mail address, or any other contact information, of and for the inventor(s), the author(s), the creator(s), or the applicant(s), owner(s), assignee(s), assignor(s), attorney(s), examiner(s), lien holder(s), or any other individuals or entities associated with each patent, patent application, trademark, trademark application, copyright, copyright application, or other intellectual property.

The database 10H can also contain and/or include, for each official or governmental filing office, data and/or information regarding licensed or authorized practitioners or other individuals who can represent others before, and in proceedings in, the official or governmental filing office, and any contact information to each practitioner or other individual. The database 10H can also contain and/or include, for each official or governmental filing office, any data and/or information for providing information regarding patents, patent applications, trademarks, trademark applications, copyrights, copyright applications, or any other intellectual property, for which the official or governmental filing office is authorized or responsible for administering, examining, or maintaining, information regarding instructions or other information regarding the filing, the examination, the prosecution, the issuance, and the maintenance, of any patents, patent applications, trademarks, trademark applications, copyrights, copyright applications, or any other intellectual property, or information for appealing decisions or actions of the official or governmental filing office. In a preferred embodiment, any data and/or information provided by the official or governmental filing office can be provided in text form, video form, audio form, or any combination of same.

The database 10H can also contain and/or include, for each official or governmental filing office, any link(s) or hyperlink(s) to the official or governmental filing office, a link(s) or a hyperlink(s) to the official or governmental filing office computer(s) 50 of or associated with the official or governmental filing office, and/or any other data and/or information needed or desired for utilizing the apparatus 100 and method of the present invention in any of the embodiments described herein. The database 10H can also, for each official or governmental filing office, contain and/or include, and/or contain and/or include a link(s) or a hyperlink(s) to, any data and/or information maintained by, provided by, offered by, or sold by, the official or governmental filing office and/or which can be accessed or obtained from the official or governmental filing office or any computer, server, or website, of same.

The database 10H can also contain and/or include, for each official or governmental filing office, a link(s) or a hyperlink(s) to, any data and/or information maintained by, provided by, offered by, or sold by, the official or government filing office and/or which can be accessed or obtained from the official or government filing office or any computer, server, or website, of same.

In a preferred embodiment, the database 10H can contain and/or can include, for each agent or broker who or which utilizes the apparatus 100 and method of the present invention, information regarding the agent's or the broker's name, address, telephone number, cellular telephone number, wireless telephone number, e-mail address, text messaging number, SMS messaging number, names of principals, employees or agents and contact information for same, company name or business name, company telephone number or business telephone number, company e-mail address or business e-mail address, the agent's or the broker's agent's name, the agent's or the broker's agent's telephone number, the agent's or the broker's agent's cellular telephone number, the agent's or the broker's agent's wireless telephone number, the agent's or the broker's agent's e-mail address, the agent's or the broker's text messaging number, the agent's or the broker's SMS messaging number, and/or any other contact information for the agent or the broker and/or for the agent's or the broker's, principals, employees, or agents.

The database 10H can also contain and/or include, for each agent or broker, a description of the types or kinds of services, and/or any goods or products, provided, offered, or performed by the agent or the broker, information regarding the commissions, success fees, prices, fees, or charges, for the agent's or the broker's various services, goods, or products, information regarding educational or training information, professional or other licenses or certifications, work samples, references, past work performed, past deals worked on or completed, past project or work experiences, desired investments, projects or jobs, types or kinds of projects, compensation structures, marketing information and/or materials of or regarding the agent or the broker, and/or information regarding principals, employees, partners, business partners, working partners, or agents, of the agent or the broker.

The database 10H can also contain and/or include, for each agent or broker, information regarding the agent or the broker, or the agent's or the broker's employees' or agents′, work schedule(s), work calendar(s), or other scheduling information, which can be utilized to allow any user of the apparatus 100 to engage or reserve the agent's or the broker's services, or the agent's or the broker's employees' or agent's services. The database 10H can also contain and/or include, for each agent or broker, information for allowing any user of the apparatus 100 to order or purchase goods, products, or services, from the agent or the broker or engage the services of the agent or the broker or engage the services of any principals, employees, or agents, of the agent or the broker.

The database 10H can also contain and/or include, for each agent or the broker, information regarding any available subscriptions offered by the agent or the broker for any services, goods, or products, performed by or offered by the agent or the broker, so that any user can purchase a subscription from the agent or the broker for any services, or goods or products, performed by or offered by the agent or the broker.

The database 10H can also contain and/or include, for each agent or broker, any link(s) or hyperlink(s) to the agent or broker, a link(s) or a hyperlink(s) to the agent/broker communication device(s) 60 of or associated with the agent or the broker, and/or any other data and/or information needed or desired for utilizing the apparatus 100 and method of the present invention in any of the embodiments described herein. The database 10H can also contain and/or include, for each agent or broker, a link(s) or a hyperlink(s) to, any data and/or information maintained by, provided by, offered by, or sold by, the agent or the broker and/or which can be accessed or obtained from the agent or the broker or any computer, server, or web site, of same.

In a preferred embodiment, the database 10H can contain and/or can include, for each social network which utilizes the apparatus 100, information regarding the name, domain name, uniform resource locator (url), or web address of the social network, information regarding any members of the social network and for each member, the member's name, address, telephone number, cellular telephone number, wireless telephone number, e-mail address, text messaging number, SMS messaging number, company name or business name, company telephone number or business telephone number, company e-mail address or business e-mail address, and/or any other contact information for the social networking member.

The database 10H can also contain and/or include, for each social network, any link(s) or hyperlink(s) to the social network, a link(s) or a hyperlink(s) to the social network computer(s) 70 of or associated with the social network, and/or any other data and/or information needed or desired for utilizing the apparatus 100 and method of the present invention in any of the embodiments described herein. The database 10H can also, for each social network, contain and/or include, and/or contain and/or include a link(s) or a hyperlink(s) to, any data and/or information maintained by, provided by, offered by, or sold by, the social network and/or which can be accessed or obtained from the social network or any computer, server, or web site, of same.

The database 10H can also contain and/or include, for each social network and/or each of the social networking members, a description of the social network sub-group(s) in which the member belongs and any information regarding each subgroup(s) and any characteristics or interests of the members of each subgroup.

The database 10H can also contain and/or include, for each social network and/or each of the social networking members, any link(s) or hyperlink(s) to the social networking computer 70 associated with that social network, and/or can contain and/or include any link(s) or hyperlink(s) to any group(s) or subgroup(s) in that social network. The database 10H can also, for each social network and/or each of the social networking members, contain and/or include, and/or contain or include a link(s) or a hyperlink(s) to, any data and/or information maintained by, provided by, offered by, or sold by, the social network or the social networking company or entity associated with same and/or which can be accessed or obtained from the social network or the social networking company or entity associated with same, or any computer, server, or website, of same.

In a preferred embodiment, the database 10H can contain and/or can include, for each media service or media source (hereinafter “media service”) who or which utilizes the apparatus 100 and method of the present invention, the media service's name, address, telephone number, e-mail address, company name or business name, company telephone number or business telephone number, company e-mail address or business e-mail address, employee directory, and/or any other contact information for the media service or its employees or agents.

The database 10H can also contain and/or include, for each media service, a description of the types or kinds of media, information, or news information, or any other services, products or goods, performed, provided, or offered, by the media service, the type or kind of media, information, or news information, provided by the media service, information regarding whether or not the media service provides, and/or the types or kinds of, general news or information, global news or information, national news or information, regional news or information, local news or information, business news of information, investment news of information, financial news of information, legal news or information, news or information regarding patents, trademarks, copyrights, trade secrets, or other intellectual property, any news or information regarding any commercialization, development, marketing, sale, transfer, licensing, and/or monetization, of or regarding patents, trademarks, copyrights, trade secrets, or other intellectual property, or any other media, information, or news information which may be of interest to any of the users, providers, funding services, official or governmental filing offices, agents, brokers, social networks or social networking members, or any other media services, who or which utilize the apparatus 100 and method of the present invention.

The database 10H can also contain and/or include, for each media service, the prices or fees for the various media services, or products or goods, offered by or provided by the media service.

The database 10H can also contain and/or include, for each media service, information regarding any available subscriptions offered by the media service for any services, goods, or products, performed by or offered by the media service, so that any user can purchase a subscription from the media service for any services, or goods or products, performed by or offered by the media service. In a preferred embodiment, any data and/or information provided by, and/or any media, information, or news information, provided by, the media service can be provided in text form, video form, audio form, or any combination of same.

The database 10H can also contain and/or include, for each media service, any link(s) or hyperlink(s) to the media service, a link(s) or a hyperlink(s) to the media service computer(s) 80 of or associated with the media service, and/or any other data and/or information needed or desired for utilizing the apparatus 100 and method of the present invention in any of the embodiments described herein. The database 10H can also, for each media service, contain and/or include, and/or contain and/or include a link(s) or a hyperlink(s) to, any data and/or information maintained by, provided by, offered by, or sold by, the media service and/or which can be accessed or obtained from the media service or any computer, server, or web site, of same.

The database 10H can also contain and/or include, and/or contain and/or include a link(s) or a hyperlink(s) to, any data and/or information, and/or any media, information, or news information, provided by, offered by, sold by, or maintained by, the media service and/or which can be accessed or obtained from the media service or any computer, server, or website, of same.

In the preferred embodiment, the database 10H can also contain and/or include any data and/or information regarding any relationship or relationships, or any working relationship or any working relationships, present or past, which exist or which may have existed between any of the herein-described users, providers, funding services, official or governmental filing offices, agents, brokers, social networks or social networking companies, or media services with or between any other users, providers, funding services, official or governmental filing offices, agents, brokers, social networks or social networking companies, or media services who or which utilize the apparatus 100 and method of the present invention, and/or can contain and/or include any data and/or information regarding dates of same, the nature or scope of same, any project or work which was the subject of same, and/or any outcome or result of same.

In a preferred embodiment, the database 10H can also contain and/or include any and/or all data and/or information, and/or any link(s) or hyperlink(s) to same, described herein as being stored in the respective databases of the herein-described user communication devices 20, the provider communication devices 30, the funding service communication devices 40, the official filing office computers 50, the agent/broker communication devices 60, social networking computers 70, and/or media computers 80.

In a preferred embodiment, the database 10H can also contain and/or include any link(s) or hyperlink(s) any and/or all of the herein-described user communication devices 20, the provider communication devices 30, the funding service communication devices 40, the official filing office computers 50, the agent/broker communication devices 60, social networking computers 70, and/or media computers 80, of or associated with any or the respective users, providers, funding services, official filing offices, agents, brokers, social networks, or media services, who or which utilize the apparatus 100 and method of the present invention.

In a preferred embodiment, the database 10H can also contain and/or include any data, information, software, algorithms, or processing routines needed or desired for generating any of the herein-described messages, reports, profiles, intellectual property profiles, provider reports, funding service/investor reports, agent/broker reports, intellectual property reports, intellectual property report messages, provider profiles, intellectual property user reports, provider reports, intellectual property user report messages, notification messages, alert messages, intellectual property (“IP”) notification messages, IP alert messages, provider availability notification messages, provider availability alert messages, search requests, search reports, intellectual property offer messages, intellectual property bid messages, offer messages, or any other messages, reports, or communications, described herein which can be generated by the apparatus 100 of the present invention or by the central processing computer 10, or which can be generated by, transmitted from, or received by, any user communication device 20, any provider communication device 30, any funding service communication device 40, any official filing office computer 50, any agent/broker communication device 60, any social networking computer 70, or any media computer 80.

In a preferred embodiment, the database 10H can also contain and/or include any data and/or information regarding any advertisements, advertising information, marketing information, or marketing materials of for or regarding any of the herein-described users, providers, funding services, official filing offices, agents, brokers, social networks, or media services, information services, or news services, who or which utilize the apparatus 100 and method of the present invention.

In a preferred embodiment, the database 10H can also contain and/or include any data, information, software, programs, algorithms, or any other information for allowing the apparatus 100 to process financial transactions between any of the herein-described and herein-defined users, providers, funding services, official filing offices, agents, brokers, social networks, or media services, information services, or news services, who or which utilize the apparatus 100 and method of the present invention. In a preferred embodiment, the database 10H can also contain and/or include any data, information, software, programs, algorithms, or any other information for allowing the apparatus 100 to administer and/or maintain financial accounts for any of the herein-described and herein-defined users, providers, funding services, official filing offices, agents, brokers, social networks, or media services, information services, or news services, who or which utilize the apparatus 100 and method of the present invention.

In a preferred embodiment, the database 10H can also contain and/or include any data, information, software, programs, algorithms, or any other information for allowing the apparatus 100 to perform all of the functions and functionality described herein as being performed by the apparatus 100 and method of the present invention.

The central processing computer 10 also includes an output device 101 for outputting any data, information, reports, or messages, described herein as being generated and/or transmitted by the apparatus 100 of the present invention. In the preferred embodiment, the output device 101 can be a printer, a display, a transmitter, a modem, and/or any other device which can be used to output data or information.

The central processing computer 10 can also include a video and/or audio recording device(s) (not shown) which can include a camera and/or a video recording device for recording pictures or video and/or video clips and/or a microphone or an audio recording device for recording audio or audio clips which can be stored in the central processing computer 10, and/or which can be transmitted to and/or stored in any other central processing computer(s) 10, the user communication device(s) 20, the provider communication device(s) 30, the funding service communication device(s) 40, the official filing office computer(s) 50, the agent/broker communication device(s) 60, the social networking computer(s) 70, and/or the media computer(s) 80, described herein, and/or which can be utilized to allow a user or operator or the central processing computer 10 to engage in video conferencing with any other users, individuals, entities, providers, funding services or funding sources, official filing offices, agents, brokers, social networks, social network operators, social network members, media services or media sources, information services or sources, or news services or news sources, and/or which can be utilized to allow a user or operator of the central processing computer 10 to record and/or transmit video messages, video e-mails, and/or which can allow a user or operator of the central processing computer 10 to utilize or engage in or with any other video messaging applications.

Any of the data and/or information stored in the database 10H can be updated by any of the herein-described users, individuals, entities, providers, funding services or funding sources, official filing offices, agents, brokers, social networks, social network operators, social network members, media services or media sources, information services or sources, or news services or news sources, or by any other person, individual, or entity who or which utilizes the apparatus 100 and method of the present invention, and any such updated data and/or information can be made available to any other users, individuals, entities, providers, funding services or funding sources, official filing offices, agents, brokers, social networks, social network operators, social network members, media services or media sources, information services or sources, or news services or news sources.

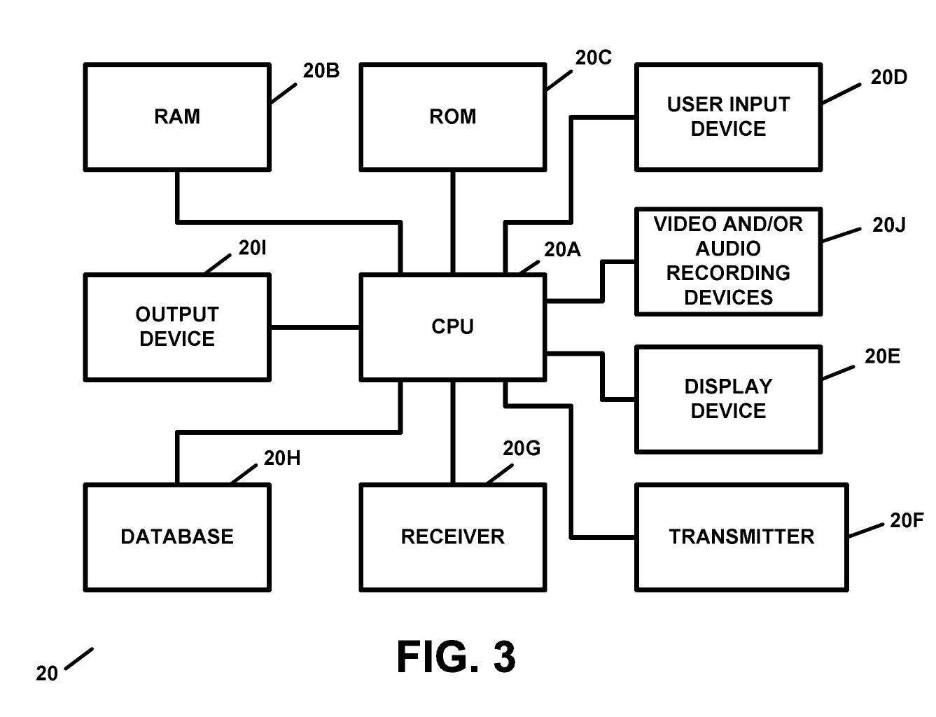

FIG. 3 illustrates the user communication device 20 of FIG. 1, in block diagram form. The user communication device 20, in the preferred embodiment, can be any computer, personal computer, network computer, or computer system, or any other computer or communication device, which can be utilized as a user communication device 20. In the preferred embodiment, the user communication device 20 includes a central processing unit or CPU 20A, which in the preferred embodiment, is a microprocessor. The CPU 20A may also be a microcomputer, a minicomputer, a macro-computer, and/or a mainframe computer, depending upon the application.

The user communication device 20 also includes a random access memory device(s) 20B (RAM) and a read only memory device(s) 20C (ROM), each of which is connected to the CPU 20A, a user input device 20D, for entering data, information, and/or commands, into the user communication device 20, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data, information, or commands into the user communication device 20, and which input device(s) are also connected to the CPU 20A.

The user communication device 20 also includes a display device 20E for displaying data and/or information to a user or operator. The user communication device 20 also includes a transmitter(s) 20F, for transmitting signals and/or data and/or information to any one or more of the central processing computer(s) 10, any other user communication device(s) 20, the provider communication device(s) 30, the funding service communication device(s) 40, the official filing office computer(s) 50, the agent/broker communication device(s) 60, the social networking computer(s) 70, and/or the media computer(s) 80, which may be utilized in conjunction with the apparatus 100 and method of the present invention. The user communication device 20 also includes a receiver 20G, for receiving signals and/or data and/or information from any one or more of the central processing computer(s) 10, any other user communication device(s) 20, the provider communication device(s) 30, the funding service communication device(s) 40, the official filing office computer(s) 50, the agent/broker communication device(s) 60, the social networking computer(s) 70, and/or the media computer(s) 80, which may be utilized in conjunction with the apparatus 100 and method of the present invention.

The user communication device 20 also includes a database(s) 20H for storing any data and/or information needed or desired for utilizing the apparatus 100 and method of the present invention and/or for performing any and/or all of the functions and functionality described herein as being performed by the apparatus 100, the central processing computer 10, and/or the user communication device 20.

In a preferred embodiment, the database 20H can contain and/or can include, for the user who or which utilizes the user communication device 20, information regarding the user's name, address, telephone number, cellular telephone number, wireless telephone number, e-mail address, text messaging number, SMS messaging number, company name or business name, company telephone number or business telephone number, company e-mail address or business e-mail address, the user's agent's name, the user's agent's telephone number, the user's agent's cellular telephone number, the user's agent's wireless telephone number, the user's agent's e-mail address, the user's text messaging number, the user's SMS messaging number, and/or any other contact information for the user and/or for the user's agent.

In a preferred embodiment, the database 20H can also contain and/or can include, for the user, information regarding any of the user's intellectual property. In a preferred embodiment, the database 20H can contain and/or can include, for the user, information regarding any of the user's intellectual property, the user's patent(s), the user's patent application(s), the user's domestic patent(s), the user's domestic patent application(s), the user's provisional patent application(s) either domestic or foreign, the user's foreign patent(s) or the user's regional patents, the user's foreign patent application(s) or the user's regional patent applications, the user's PCT patent applications, or any other types or kinds of patent or patent-related protections or international patent or patent-related protections of the user, or information regarding any of the user's trademark(s), the user's trademark application(s), the user's domestic trademark (s), the user's domestic trademark application(s), the user's foreign trademark(s) or the user's regional trademark(s), the user's foreign trademark application(s) or the user's regional trademark applications, the user's international trademark applications, or any other types or kinds of trademark, service mark, or mark, protections, either domestic or foreign, of the user, or information regarding any of the user's copyrights(s), the user's copyrighted works, the user's copyright application(s), the user's domestic copyrights (s) or copyrighted works, the user's domestic copyright application(s), the user's foreign copyright(s) or the user's regional copyright(s), the user's foreign copyright application(s) or the user's regional copyright applications, the user's international copyright applications, or any other types or kinds of copyright protections, either domestic or foreign, of the user.

The database 20H can also contain and/or can include, for the user, information regarding any other types or kinds of intellectual property or intellectual property-related protections or any international intellectual property or intellectual property-related protections. For each type of intellectual property of, owned by, or controlled by, the user, the database 20H can also contain and/or include data and/or information regarding each item of intellectual property, each patent, each patent application, each provisional patent application, each foreign patent application, each foreign patent, each PCT application, each regional patent, or each regional patent application, or each trademark, each trademark application, each foreign trademark, each foreign trademark application, or each convention trademark application, or each copyright, each copyright application, each foreign copyright, each foreign copyright application, or each convention copyright.

For each patent or patent application of any kind or type, domestic or foreign, the database 20H can include a patent number or a patent application derail number, a name of the patent or a name of the patent application, a description of the invention described in or covered by the patent or the patent application, a copy of the patent or the patent application or a link or a hyperlink to a copy of the patent or the patent application, the filing date of the patent or the patent application, the priority date of the patent or the patent application, the country or countries in which protection have been sought for the inventions described or covered by the patent or the patent application, the status of the patent or the patent application, the inventor(s) of the patent or the patent application, the assignee, if any, of the patent or the patent application, the status of payment of any fees or maintenance fees for any patent, and/or the date and/or time of the posting, listing, or registration, of the patent or the patent application with the apparatus 100.

The database 20H can also contain and/or include, for each user, any data and/or information regarding what the user desires or plans to do with the patent or the patent application or any invention covered by same or described by same, including, but not limited to, any information regarding whether or not the user wants to commercialize the invention covered by or described in the patent or the patent application, information regarding whether or not the user wants to develop, produce, market, and/or sell, any goods, products, or services, covered by the invention covered by or described in the patent or the patent application, information regarding whether or not the user wants to start a company or a business entity to develop, produce, market, and/or sell, any goods, products, or services, covered by the invention covered by or described in the patent or the patent application, information regarding whether or not the user wants to find a partner(s) or investor(s) to develop, produce, market, and/or sell, any goods, products, or services, covered by the invention covered by or described in the patent or the patent application, information regarding whether or not the user wants to find a provider of any services, goods, or products, in order to assist the user or to aid the user in developing, producing, marketing, and/or selling, any goods, products, or services, covered by the invention covered by or described in the patent or the patent application, information regarding whether or not the user wants to find a provider of any services, goods, or products, in order to assist the user or to aid the user in obtaining protection for, in obtaining additional protection for, or in further developing and/or protecting additional patents or other intellectual property relating to or regarding, the patent or the patent application, information regarding whether or not the user wants to find an attorney or other professional to represent the user in obtaining protection for, in obtaining additional protection for, or to further developing and/or protecting additional patents or other intellectual property relating to or regarding, the patent or the patent application, information regarding whether or not the user wants to sell, assign, transfer, license, license in a field or use, exclusively license, exclusively license in a field of use, non-exclusively license, non-exclusively license in a field of use, market, or monetize, the invention(s) covered by or described in the patent or the patent application, information regarding whether or not the user wants to sell, assign, transfer, license, license in a field or use, exclusively license, exclusively license in a field of use, non-exclusively license, non-exclusively license in a field of use, market, or monetize, any foreign country counterparts to the patent or the patent application or any foreign patents or patent applications relating to same, information regarding any user asking prices or any offering prices for selling, assigning, transferring, licensing, exclusively licensing, non-exclusively licensing, or otherwise monetizing, the patent or the patent application, or information regarding whether or not the user is seeking any partners, strategic partners, joint ventures, or joint venture partners, or others, in the user's efforts or activities in commercializing, developing, marketing, selling, transferring, licensing, and/or monetizing, the patent or the patent application or any inventions covered by same or described in same, or any information regarding the user's expectations, needs, or desires regarding same, information regarding any hiring needs of the user, or information regarding the user's needs, plans, strategies, or desires, for the patent or the patent application, information regarding any work schedule or scheduling needs of the user, and/or any other information regarding the user, the patent, or the patent application, the user's needs, plans, strategies, or desires, for or regarding the patent or the patent application, or any other information which would be needed or desired for or regarding the user, the patent, or the patent application, relating to the user's use of the apparatus 100 of the present invention for, relating to, or regarding, the patent or the patent application.

For each trademark or trademark application of any kind or type, domestic or foreign, the database 20H can include a trademark number or a trademark application serial number, the name or a description of the trademark, a description of the goods, products, or services, with which the trademark is utilized, a copy of the trademark or the trademark application or a link or a hyperlink to a copy of the trademark or the trademark application, the filing date of the trademark or the trademark application, the priority date of the trademark or the trademark application, the country or countries in which protection have been sought for the trademark, the status of the trademark or the trademark application, the applicant(s) for the trademark or the trademark application, the assignee, if any, of the trademark or the trademark application, the status of payment of any fees or renewal fees for the trademark, and/or the date and/or time of the posting, listing, or registration, of the trademark or the trademark application with the apparatus 100.

The database 20H can also contain and/or include, for each user, any data and/or information regarding what the user desires or plans to do with the trademark or the trademark application, including, but not limited to, any information regarding whether or not the user wants to commercialize any goods, products, or services, under the trademark or the trademark application, information regarding whether or not the user wants to develop, produce, market, and/or sell, any goods, products, or services, under the trademark or the trademark application, information regarding whether or not the user wants to start a company or a business entity using the trademark and/or to develop, produce, market, and/or sell, any goods, products, or services, under the trademark or the trademark application, information regarding whether or not the user wants to find a partner(s) or investor(s) to develop, produce, market, and/or sell, any goods, products, or services, under the trademark or the trademark application, information regarding whether or not the user wants to find a provider of any services, goods, or products, in order to assist the user or to aid the user in developing, producing, marketing, and/or selling, any goods, products, or services, under the trademark or the trademark application, information regarding whether or not the user wants to find a provider of any services, goods, or products, in order to assist the user or to aid the user in obtaining protection for, in obtaining additional protection for, or in further developing and/or protecting additional trademarks or other intellectual property relating to or regarding, the trademark or the trademark application, or information regarding whether or not the user wants to find an attorney or other professional to represent the user in obtaining protection for, in obtaining additional protection for, or in further developing and/or protecting additional trademarks or other intellectual property relating to or regarding the trademark or the trademark application, or information regarding whether or not the user wants to sell, assign, transfer, license, license in a field or use, exclusively license, exclusively license in a field of use, non-exclusively license, non-exclusively license in a field of use, market, or monetize, the trademark or the trademark application or any goods, products, or services, under the trademark or the trademark application, or information regarding whether or not the user wants to sell, assign, transfer, license, license in a field or use, exclusively license, exclusively license in a field of use, non-exclusively license, non-exclusively license in a field of use, market, or monetize, any foreign country counterparts to the trademark or the trademark application or any foreign trademarks or trademark applications relating to same, or information regarding any user asking prices or any offering prices for selling, assigning, transferring, licensing, exclusively licensing, non-exclusively licensing, or otherwise monetizing, the trademark or the trademark application, information regarding whether or not the user is seeking any partners, strategic partners, joint ventures, or joint venture partners, or others, in the user's efforts or activities in commercializing, developing, marketing, selling, transferring, licensing, and/or monetizing, the trademark or the trademark application or any goods, products, or services, under the trademark or the trademark application, or any information regarding the user's expectations, needs, or desires regarding same, or information regarding any hiring needs of the user, information regarding the user's needs, plans, strategies, or desires, for the trademark or the trademark application, information regarding any work schedule or scheduling needs of the user, and/or any other information regarding the user, the trademark, or the trademark application, the user's needs, plans, strategies, or desires, for or regarding the trademark or the trademark application, or any other information which would be needed or desired for or regarding the user, the trademark, or the trademark application, relating to the user's use of the apparatus 100 of the present invention for, relating to, or regarding, the trademark or the trademark application.

For each copyright, copyrighted work, or copyright application, of any kind or type, domestic or foreign, the database 20H can include a copyright number of a copyright application serial number, the name or a description of the copyrighted work, the copyright, of the copyright application, a description of the copyrighted work, the copyright, of the copyright application, a copy of the copyrighted work, the copyright, or the copyright application, or a link or a hyperlink to a copy of the copyrighted work, the copyright, or the copyright application, the date of creation of the copyrighted work or the date of filing of the copyright or the copyright application, any first publication date or other priority date of the copyrighted work, the country or countries in which protection has been sought for the copyrighted work, the copyright, or the copyright application, the status of the copyright or the copyright application, the author, creator, or applicant for the copyright or the copyright application, the assignee, if any, of the copyrighted work, the copyright, or the copyright application, the status of payment of any fees or renewal fees for the copyright, and/or the date and/or time of the posting, listing, or registration, of the copyrighted work, the copyright, or the copyright application with the apparatus 100.

The database 20H can also contain and/or include any data and/or information regarding what the user desires or plans to do with the copyrighted work, the copyright, or the copyright application, including, but not limited to, any information regarding whether or not the user wants to commercialize the copyrighted work, the copyright, or the copyright application, information regarding whether or not the user wants to develop, produce, market, and/or sell, the copyrighted work, the copyright, or the copyright application, and/or any goods, products, or services, under the copyright or the copyright application, information regarding whether or not the user wants to start a company or a business entity to commercialize or exploit the copyrighted work and/or to develop, produce, market, and/or sell, the copyrighted work and/or any goods, products, or services, relating to same, information regarding whether or not the user wants to find a partner(s) or investor(s) to develop, produce, market, and/or sell, any copyrighted work and/or any goods, products, or services, relating to same, information regarding whether or not the user wants to find a provider of any services, goods, or products, in order to assist the user or to aid the user in developing, producing, marketing, and/or selling, the copyrighted work and/or any goods, products, or services, relating to same, information regarding whether or not the user wants to find a provider of any services, goods, or products, in order to assist the user or to aid the user in obtaining protection for, in obtaining additional protection for, or in further developing and/or protecting additional copyrighted works and/or any goods, products, or services, relating to same, or information regarding whether or not the user wants to find an attorney or other professional to represent the user in obtaining protection for, in obtaining additional protection for, or in further developing and/or protecting additional, copyrighted works, the copyrighted work or other intellectual property relating to or regarding the copyrighted work, the copyright, or the copyright application, or information regarding whether or not the user wants to sell, assign, transfer, license, license in a field or use, exclusively license, exclusively license in a field of use, non-exclusively license, non-exclusively license in a field of use, market, or monetize, the copyrighted work, the copyright, or the copyright application, or any goods, products, or services, under the copyright or the copyright application, or information regarding whether or not the user wants to sell, assign, transfer, license, license in a field or use, exclusively license, exclusively license in a field of use, non-exclusively license, non-exclusively license in a field of use, market, or monetize, any foreign country counterparts to the copyrighted work, the copyright, or the copyright application, or any foreign copyrighted works, copyrights, or copyright applications, or information regarding any user asking prices or any offering prices for selling, assigning, transferring, licensing, exclusively licensing, non-exclusively licensing, or otherwise monetizing, the copyrighted work, the copyright, or the copyright application, or information regarding whether or not the user is seeking any partners, strategic partners, joint ventures, or joint venture partners, or others, in the user's efforts or activities in commercializing, developing, marketing, selling, transferring, licensing, and/or monetizing, the copyrighted work, the copyright, or the copyright application or any goods, products, or services, relating to the copyrighted work, the copyright, or the copyright application or any information regarding the user's expectations, needs, or desires regarding same, or information regarding any hiring needs of the user, information regarding the user's needs, plans, strategies, or desires, for the copyrighted work, the copyright, or the copyright application, information regarding any work schedule or scheduling needs of the user, and/or any other information regarding the user, copyrighted work, the copyright, or the copyright application, the user's needs, plans, strategies, or desires, for or regarding the copyrighted work, the copyright, or the copyright application or any other information which would be needed or desired for or regarding the user, copyrighted work, the copyright, or the copyright application, relating to the user's use of the apparatus 100 of the present invention for, relating to, or regarding, copyrighted work, the copyright, or the copyright application.

The database 20H can also contain and/or include any link(s) or hyperlink(s) to any respective intellectual property of the user, a link(s) or a hyperlink(s) to the user communication device(s) 20 of or associated with the user, and/or any other data and/or information needed or desired for utilizing the apparatus 100 and method of the present invention in any of the embodiments described herein. The database 20H can also, for each item of intellectual property associated with the user, contain and/or include, and/or contain and/or include a link(s) or a hyperlink(s) to, any data and/or information maintained by, provided by, offered by, or sold by, the user and/or which can be accessed or obtained from the user or any computer, server, or website, of same.

The database 20H can also contain and/or include, and/or contain and/or include a link(s) or a hyperlink(s) to, any data and/or information described herein as being stored in any of the databases 10H, 20H, 30H, 40H, 50H, 60H, 70H, and/or 80H, described herein.

The database 20H can also contain and/or be linked to any of the data and/or information described herein as being stored in the database 10H.

The user communication device 20 also includes an output device 201 for outputting any data, information, report, or message, described herein. In the preferred embodiment, the output device 201 can be a printer, a display, a transmitter, a modem, and/or any other device which can be used to output data or information.

The user communication device 20 also includes a video and/or audio recording device(s) 20J which can include a camera and/or a video recording device for recording pictures or video and/or video clips and/or a microphone or an audio recording device for recording audio or audio clips which can be stored in the user communication device 20, and/or which can be transmitted to and/or stored in any other user communication device(s) 20, the central processing computer(s) 10, the provider communication device(s) 30, the funding service communication device(s) 40, the official filing office computer(s) 50, the agent/broker communication device(s) 60, the social networking computer(s) 70, and/or the media computer(s) 80, described herein, and/or which can be utilized to allow a user of the user communication device 20 to engage in video conferencing with any other users, individuals, entities, providers, funding services or funding sources, official filing offices, agents, brokers, social networks, social network operators, social network members, media services or media sources, information services or sources, or news services or news sources, and/or which can be utilized to allow a user of the user communication device 20 to record and/or transmit video messages, video e-mails, and/or which can allow a user of the user communication device 20 to utilize or engage in or with any other video messaging applications.

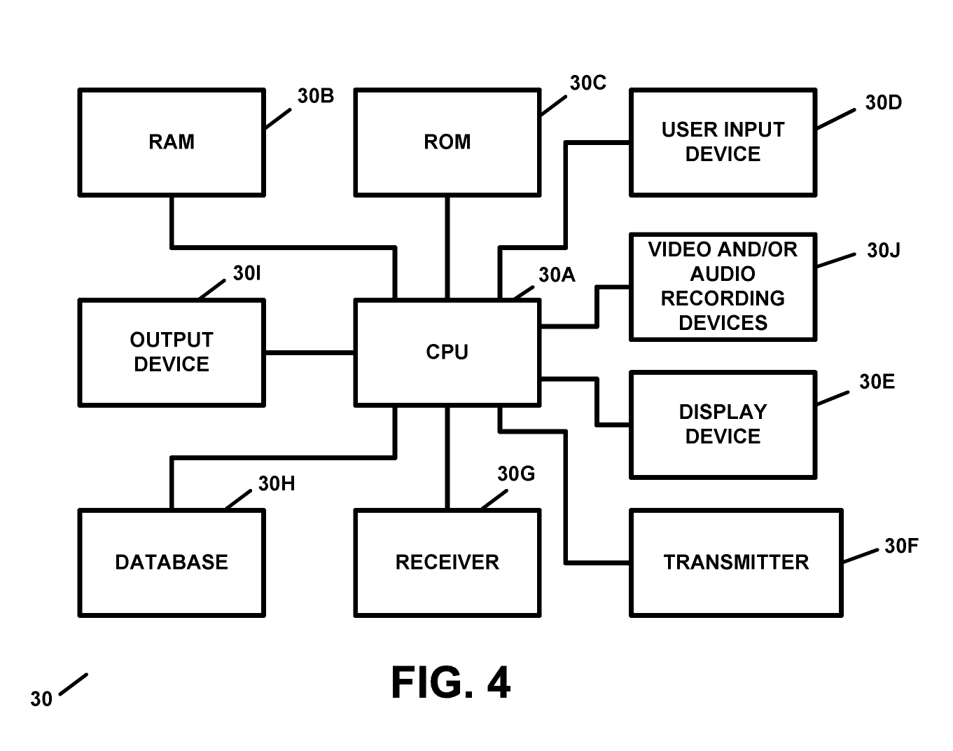

FIG. 4 illustrates the provider communication device 30 of FIG. 1, in block diagram form. The provider communication device 20, in the preferred embodiment, can be any computer, personal computer, network computer, or computer system, or any other computer or communication device, which can be utilized as a provider communication device 30. In the preferred embodiment, the provider communication device 30 includes a central processing unit or CPU 30A, which in the preferred embodiment, is a microprocessor. The CPU 30A may also be a microcomputer, a minicomputer, a macro-computer, and/or a mainframe computer, depending upon the application.

The provider communication device 30 also includes a random access memory device(s) 30B (RAM) and a read only memory device(s) 30C (ROM), each of which is connected to the CPU 30A, a user input device 30D, for entering data, information, and/or commands, into the provider communication device 30, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data, information, or commands into the provider communication device 30, and which input device(s) are also connected to the CPU 30A.

The provider communication device 30 also includes a display device 30E for displaying data and/or information to a user or operator. The provider communication device 30 also includes a transmitter(s) 30F, for transmitting signals and/or data and/or information to any one or more of the central processing computer(s) 10, the user communication device(s) 20, any other provider communication device(s) 30, the funding service communication device(s) 40, the official filing office computer(s) 50, the agent/broker communication device(s) 60, the social networking computer(s) 70, and/or the media computer(s) 80, which may be utilized in conjunction with the apparatus 100 and method of the present invention. The provider communication device 30 also includes a receiver 30G, for receiving signals and/or data and/or information from any one or more of the central processing computer(s) 10, the user communication device(s) 20, any other provider communication device(s) 30, the funding service communication device(s) 40, the official filing office computer(s) 50, the agent/broker communication device(s) 60, the social networking computer(s) 70, and/or the media computer(s) 80, which may be utilized in conjunction with the apparatus 100 and method of the present invention.

The provider communication device 30 also includes a database(s) 30H for storing any data and/or information needed or desired for utilizing the apparatus 100 and method of the present invention and/or for performing any and/or all of the functions and functionality described herein as being performed by the apparatus 100, the central processing computer 10, and/or the provider communication device 30.

In a preferred embodiment, the database 30H can contain and/or can include, for the provider who or which utilizes the provider communication device 30, information regarding the provider's name, address, telephone number, cellular telephone number, wireless telephone number, e-mail address, text messaging number, SMS messaging number, company name or business name, company telephone number or business telephone number, company e-mail address or business e-mail address, the provider's agent's name, the provider's agent's telephone number, the provider's agent's cellular telephone number, the provider's agent's wireless telephone number, the provider's agent's e-mail address, the provider's text messaging number, the provider's SMS messaging number, and/or any other contact information for the provider and/or for the provider's agent.

The database 30H can also contain and/or include, for the provider, a description of the types or kinds of the services and/or the goods or products, provided, offered, or performed by the provider, information regarding the prices, fees, or charges, for the provider's various services, goods, or products, information regarding educational or training information, professional or other licenses or certifications, resume(s), qualifications, honors or awards, work samples, references, past work performed, past project or work experiences, desired projects or jobs, types or kinds of projects, compensation structures, marketing information and/or materials of or regarding the provider, and/or information regarding employees, partners, business partners, working partners, or agents, of the provider.

The database 30H can also contain and/or include, for the provider, information regarding the provider's, or the provider's employees' or agents′, work schedule(s), work calendar(s), or other scheduling information, which can be utilized to allow any user of the apparatus 100 to engage or reserve the provider's, or the provider's employees' or agents' services. The database 30H can also contain and/or include information for allowing any user of the apparatus 100 to order or purchase goods, products, or services, from the provider.

The database 30H can also contain and/or include information regarding any available subscriptions offered by the provider for any services, goods, or products, performed by or offered by the provider, so that any user can purchase a subscription from the provider for any services, or goods or products, performed by or offered by the provider.

The database 30H can also contain and/or include, for the provider, any link(s) or hyperlink(s) to the provider, a link(s) or a hyperlink(s) to the provider communication device(s) 30 of or associated with the provider, and/or any other data and/or information needed or desired for utilizing the apparatus 100 and method of the present invention in any of the embodiments described herein. The database 30H can also contain and/or include, and/or contain and/or include, a link(s) or a hyperlink(s) to, any data and/or information maintained by, provided by, offered by, or sold by, the provider and/or which can be accessed or obtained from the provider or any computer, server, or web site, of same.

The database 30H can also contain and/or include, and/or contain and/or include a link(s) or a hyperlink(s) to, any data and/or information described herein as being stored in any of the databases 10H, 20H, 30H, 40H, 50H, 60H, 70H, and/or 80H, described herein.

The database 30H can also contain and/or be linked to any of the data and/or information described herein as being stored in the database 10H.

The provider communication device 30 also includes an output device 301 for outputting any data, information, report, or message, described herein. In the preferred embodiment, the output device 301 can be a printer, a display, a transmitter, a modem, and/or any other device which can be used to output data or information.

The provider communication device 30 also includes a video and/or audio recording device(s) 30J which can include a camera and/or a video recording device for recording pictures or video and/or video clips and/or a microphone or an audio recording device for recording audio or audio clips which can be stored in the provider communication device 30, and/or which can be transmitted to and/or stored in any other provider communication device(s) 30, the central processing computer(s) 10, the user communication device(s) 20, the funding service communication device(s) 40, the official filing office computer(s) 50, the agent/broker communication device(s) 60, the social networking computer(s) 70, and/or the media computer(s) 80, described herein, and/or which can be utilized to allow a user or operator of the provider communication device 30 to engage in video conferencing with any other users, individuals, entities, providers, funding services or funding sources, official filing offices, agents, brokers, social networks, social network operators, social network members, media services or media sources, information services or sources, or news services or news sources, and/or which can be utilized to allow a user or operator of the provider communication device 30 to record and/or transmit video messages, video e-mails, and/or which can allow a user or operator of the provider communication device 30 to utilize or engage in or with any other video messaging applications.

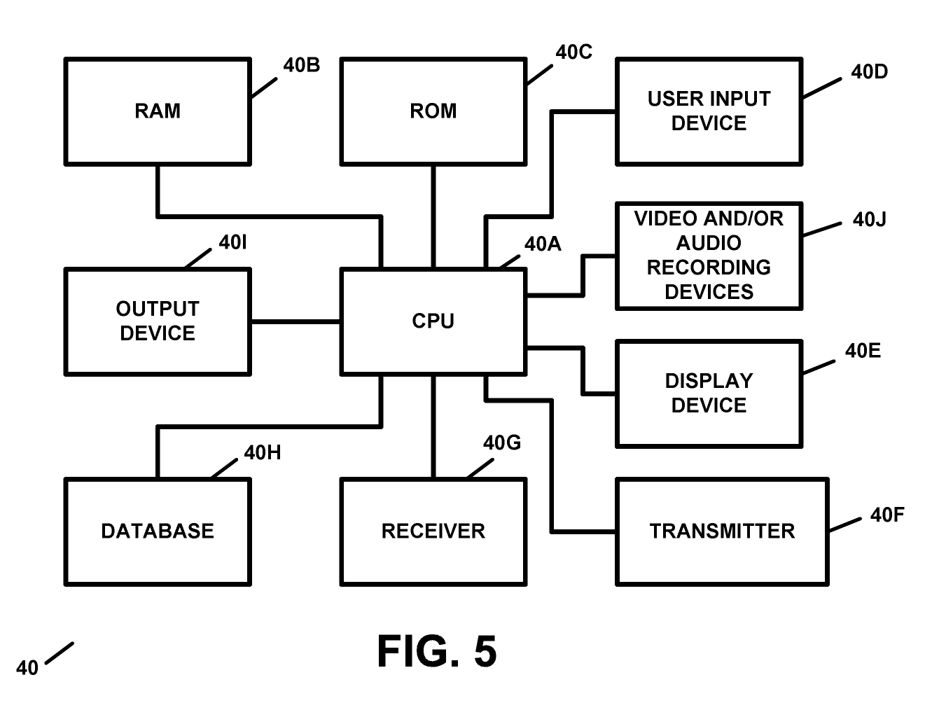

FIG. 5 illustrates the funding service communication device 40 of FIG. 1, in block diagram form. The funding service communication device 40, in the preferred embodiment, can be any computer, personal computer, network computer, or computer system, or any other computer or communication device, which can be utilized as a funding service communication device 40. In the preferred embodiment, the funding service communication device 40 includes a central processing unit or CPU 40A, which in the preferred embodiment, is a microprocessor. The CPU 40A may also be a microcomputer, a minicomputer, a macro-computer, and/or a mainframe computer, depending upon the application.

The funding service communication device 40 also includes a random access memory device(s) 40B (RAM) and a read only memory device(s) 40C (ROM), each of which is connected to the CPU 40A, a user input device 40D, for entering data, information, and/or commands, into the funding service communication device 40, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data, information, or commands into the funding service communication device 40, and which input device(s) are also connected to the CPU 40A.

The funding service communication device 40 also includes a display device 40E for displaying data and/or information to a user or operator. The funding service communication device 40 also includes a transmitter(s) 40F, for transmitting signals and/or data and/or information to any one or more of the central processing computer(s) 10, the user communication device(s) 20, the provider communication device(s) 30, any other funding service communication device(s) 40, the official filing office computer(s) 50, the agent/broker communication device(s) 60, the social networking computer(s) 70, and/or the media computer(s) 80, which may be utilized in conjunction with the apparatus 100 and method of the present invention. The funding service communication device 40 also includes a receiver 40G, for receiving signals and/or data and/or information from any one or more of the central processing computer(s) 10, the user communication device(s) 20, the provider communication device(s) 30, any other funding service communication device(s) 40, the official filing office computer(s) 50, the agent/broker communication device(s) 60, the social networking computer(s) 70, and/or the media computer(s) 80, which may be utilized in conjunction with the apparatus 100 and method of the present invention.

The funding service communication device 40 also includes a database(s) 40H for storing any data and/or information needed or desired for utilizing the apparatus 100 and method of the present invention and/or for performing any and/or all of the functions and functionality described herein as being performed by the apparatus 100, the central processing computer 10, and/or the funding service communication device 40.

In a preferred embodiment, the database 40H can contain and/or can include, for the funding service who or which utilizes the funding service communication device 40, information regarding the funding service's name, address, telephone number, cellular telephone number, wireless telephone number, e-mail address, text messaging number, SMS messaging number, names of principals, employees or agents and contact information for same, company name or business name, company telephone number or business telephone number, company e-mail address or business e-mail address, the funding service's agent's name, the funding service's agent's telephone number, the funding service's agent's cellular telephone number, the funding service's agent's wireless telephone number, the funding service's agent's e-mail address, the funding service's text messaging number, the funding service's SMS messaging number, and/or any other contact information for the funding service and/or for the funding service's, principals, employees, or agents.

The database 40H can also contain and/or include, for the funding service, a description of the types or kinds of funding services, and/or any goods or products, provided, offered, or performed, by the funding service, information regarding the commissions, success fees, prices, fees, or charges, for the funding service's various services, goods, or products, information regarding educational or training information, professional or other licenses or certifications, resume(s), qualifications, honors or awards, work samples, references, past work performed, past deals worked on or completed, past investments made, past project or work experiences, desired investments, projects or jobs, types or kinds of projects, compensation structures, marketing information and/or materials of or regarding the funding service, and/or information regarding principals, employees, partners, business partners, working partners, or agents, of the funding service.

The database 40H can also contain and/or include, for the funding service, information regarding the funding service's, or the funding service's employees' or agents′, work schedule(s), work calendar(s), or other scheduling information, which can be utilized to allow any user of the apparatus 100 to engage or reserve the funding service's, or the funding service's employees' or agents' services. The database 40H can also contain and/or include information for allowing any user of the apparatus 100 to order or purchase goods, products, or services, from the funding service or engage the services of the funding service or the services or any principals, employees, or agents, of the funding service.

The database 40H can also contain and/or include information regarding any available subscriptions offered by the funding service for any services, goods, or products, performed by or offered by the funding service, so that any user can purchase a subscription from the funding service for any services, or goods or products, performed by or offered by the funding service.

The database 40H can also contain and/or include any link(s) or hyperlink(s) to the funding service, a link(s) or a hyperlink(s) to the funding service communication device(s) 40 of or associated with the funding service, and/or any other data and/or information needed or desired for utilizing the apparatus 100 and method of the present invention in any of the embodiments described herein.

The database 40H can also contain and/or include, and/or contain and/or include a link(s) or a hyperlink(s) to, any data and/or information maintained by, provided by, offered by, or sold by, the funding service and/or which can be accessed or obtained from the funding service or any computer, server, or website, of same.

The database 40H can also contain and/or include, and/or contain and/or include a link(s) or a hyperlink(s) to, any data and/or information described herein as being stored in any of the databases 10H, 20H, 30H, 40H, 50H, 60H, 70H, and/or 80H, described herein.

The database 40H can also contain and/or be linked to any of the data and/or information described herein as being stored in the database 10H.

The funding service communication device 40 also includes an output device 401 for outputting any data, information, report, or message, described herein. In the preferred embodiment, the output device 401 can be a printer, a display, a transmitter, a modem, and/or any other device which can be used to output data or information.

The funding service communication device 40 also includes a video and/or audio recording device(s) 40J which can include a camera and/or a video recording device for recording pictures or video and/or video clips and/or a microphone or an audio recording device for recording audio or audio clips which can be stored in the funding service communication device 40, and/or which can be transmitted to and/or stored in any other funding service communication device(s) 40, the central processing computer(s) 10, the user communication device(s) 20, the provider communication device(s) 30, the official filing office computer(s) 50, the agent/broker communication device(s) 60, the social networking computer(s) 70, and/or the media computer(s) 80, described herein, and/or which can be utilized to allow a user or operator of the funding service communication device 40 to engage in video conferencing with any other users, individuals, entities, providers, funding services or funding sources, official filing offices, agents, brokers, social networks, social network operators, social network members, media services or media sources, information services or sources, or news services or news sources, and/or which can be utilized to allow a user or operator of the funding service communication device 40 to record and/or transmit video messages, video e-mails, and/or which can allow a user or operator of the funding service communication device 40 to utilize or engage in or with any other video messaging applications.

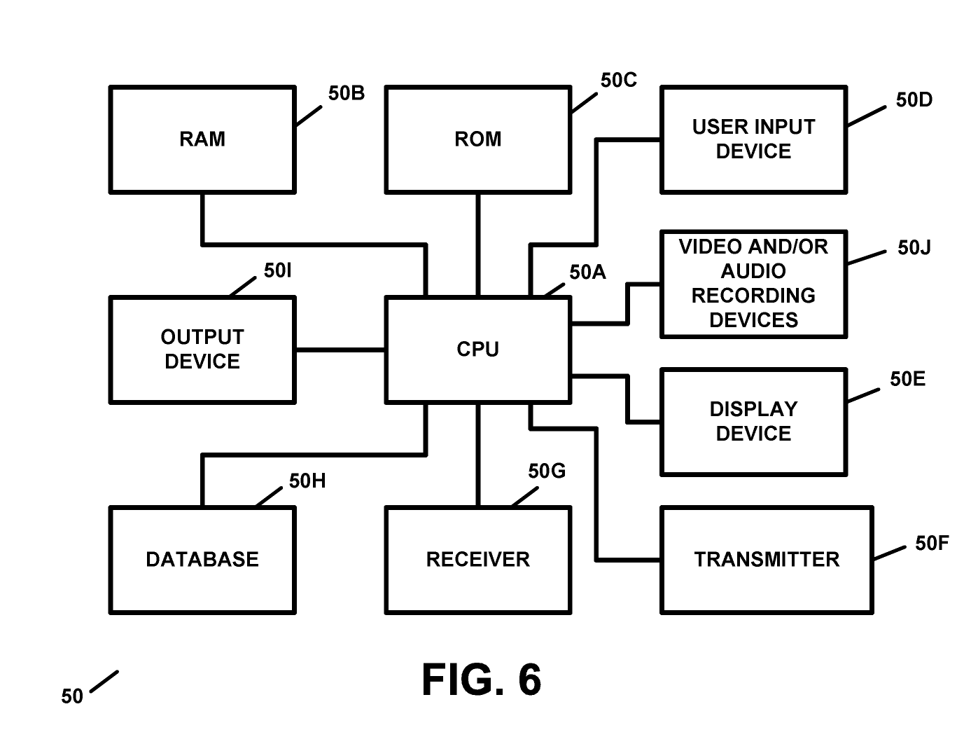

FIG. 6 illustrates the official filing office computer 50 of FIG. 1, in block diagram form. The official filing office computer 50, in the preferred embodiment, can be any computer, personal computer, network computer, or computer system, or any other computer or communication device, which can be utilized as an official filing office computer 50. In the preferred embodiment, the official filing office computer 50 includes a central processing unit or CPU 50A, which in the preferred embodiment, is a microprocessor. The CPU 50A may also be a microcomputer, a minicomputer, a macro-computer, and/or a mainframe computer, depending upon the application.

The official filing office computer 50 also includes a random access memory device(s) 50B (RAM) and a read only memory device(s) 50C (ROM), each of which is connected to the CPU 50A, a user input device 50D, for entering data, information, and/or commands, into the official filing office computer 50, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data, information, or commands into the official filing office computer 50, and which input device(s) are also connected to the CPU 50A.

The official filing office computer 50 also includes a display device 50E for displaying data and/or information to a user or operator. The official filing office computer 50 also includes a transmitter(s) 50F, for transmitting signals and/or data and/or information to any one or more of the central processing computer(s) 10, the user communication device(s) 20, the provider communication device(s) 30, the funding service communication device(s) 40, any other official filing office computer(s) 50, the agent/broker communication device(s) 60, the social networking computer(s) 70, and/or the media computer(s) 80, which may be utilized in conjunction with the apparatus 100 and method of the present invention. The official filing office computer 50 also includes a receiver 50G, for receiving signals and/or data and/or information from any one or more of the central processing computer(s) 10, the user communication device(s) 20, the provider communication device(s) 30, the funding service communication device(s) 40, any other official filing office computer(s) 50, the agent/broker communication device(s) 60, the social networking computer(s) 70, and/or the media computer(s) 80, which may be utilized in conjunction with the apparatus 100 and method of the present invention.

The official filing office computer 50 also includes a database(s) 50H for storing any data and/or information needed or desired for utilizing the apparatus 100 and method of the present invention and/or for performing any and/or all of the functions and functionality described herein as being performed by the apparatus 100, the central processing computer 10, and/or the official filing office computer 50.

In a preferred embodiment, the database 50H can contain and/or can include, for the official or governmental filing office which utilizes the official filing office computer 50, information regarding the name of the official or governmental filing office and its address, its telephone number(s), and/or a listing of its directors, employees, or agents, including, but not limited to their names, telephone numbers, e-mail addresses, text messaging numbers, SMS messaging numbers, department, work group, or art unit, identifying information, and/or any other contact information for the official or governmental filing office. The database 50H can also contain and/or include, for the official or governmental filing office, a link(s) or hyperlink(s) to the official or governmental filing office, to any of its departments, work groups, or art units, or to any of its directors, employees, or agents.

The database 50H can also contain and/or include, for the official or governmental filing office, any information regarding, and/or any link(s) or hyperlink(s) to, any and/or all of the respective patents, patent applications, trademarks, trademark applications, copyrights, copyright applications, or any other intellectual property, the official or governmental filing office has issued and/or is currently examining or reviewing, information regarding the status of any issued patents, patent applications, trademarks, trademark applications, copyrights, copyright applications, or any other intellectual property, the status of the payment or the non-payment of any filing fees, examination fees, issue fees, maintenance fees, or renewal, or any other fees, and/or the status of fees owed any issued patents, patent applications, trademarks, trademark applications, copyrights, copyright applications, or any other intellectual property.

The database 50H can also contain and/or include, for the official or governmental filing office, information regarding, electronic copies of, access to physical copies of, and/or a link(s) or a hyperlink(s) to, any recorded documents, assignments, licenses, covenants not to sue, releases, transfers, liens, or any other documents recorded for or regarding any of the patents, patent applications, trademarks, trademark applications, copyrights, copyright applications, or any other intellectual property. For each patent, patent application, trademark, trademark application, copyright, copyright application, or other intellectual property, the database 50H can contain or include information regarding the name, address, telephone number, company name, e-mail address, or any other contact information, of and for the inventor(s), the author(s), the creator(s), or the applicant(s), owner(s), assignee(s), assignor(s), attorney(s), examiner(s), lien holder(s), or any other individuals or entities associated with each patent, patent application, trademark, trademark application, copyright, copyright application, or other intellectual property.

The database 50H can also contain and/or include, for the official or governmental filing office, data and/or information regarding licensed or authorized practitioners or other individuals who can represent others before, and in proceedings in, the official or governmental filing office, and any contact information to each practitioner or other individual. The database 50H can also contain and/or include, for the official or governmental filing office, any data and/or information for providing information regarding patents, patent applications, trademarks, trademark applications, copyrights, copyright applications, or any other intellectual property, for which the official or governmental filing office is authorized or responsible for administering, examining, or maintaining, information regarding instructions or other information regarding the filing, the examination, the prosecution, the issuance, and the maintenance, of any patents, patent applications, trademarks, trademark applications, copyrights, copyright applications, or any other intellectual property, or information for appealing decisions or actions of the official or governmental filing office. In a preferred embodiment, any data and/or information provided by the official or governmental filing office can be provided in text form, video form, audio form, or any combination of same.

The database 50H can also contain and/or include, for the official or governmental filing office, any link(s) or hyperlink(s) to the official or governmental filing office, a link(s) or a hyperlink(s) to the official or governmental filing office computer(s) 50 of or associated with the official or governmental filing office, and/or any other data and/or information needed or desired for utilizing the apparatus 100 and method of the present invention in any of the embodiments described herein. The database 50H can also contain and/or include, and/or contain and/or include a link(s) or a hyperlink(s) to, any data and/or information maintained by, provided by, offered by, or sold by, the official or governmental filing office and/or which can be accessed or obtained from the official or governmental filing office or any computer, server, or website, of same.

The database 50H can also contain and/or include a link(s) or a hyperlink(s) to, any data and/or information maintained by, provided by, offered by, or sold by, the official or government filing office and/or which can be accessed or obtained from the official or government filing office or any computer, server, or website, of same.

The database 50H can also contain and/or include, and/or contain and/or include a link(s) or a hyperlink(s) to, any data and/or information described herein as being stored in any of the databases 10H, 20H, 30H, 40H, 50H, 60H, 70H, and/or 80H, described herein.

The database 50H can also contain and/or be linked to any of the data and/or information described herein as being stored in the database 10H.

The official filing office computer 50 also includes an output device 501 for outputting any data, information, report, or message, described herein. In the preferred embodiment, the output device 501 can be a printer, a display, a transmitter, a modem, and/or any other device which can be used to output data or information.

The official filing office computer 50 also includes a video and/or audio recording device(s) 50J which can include a camera and/or a video recording device for recording pictures or video and/or video clips and/or a microphone or an audio recording device for recording audio or audio clips which can be stored in the official filing office computer 50, and/or which can be transmitted to and/or stored in any other official filing office computer(s) 50, the central processing computer(s) 10, the user communication device(s) 20, the provider communication device(s) 30, the funding service communication device(s) 40, the agent/broker communication device(s) 60, the social networking computer(s) 70, and/or the media computer(s) 80, described herein, and/or which can be utilized to allow a user or operator of the official filing office computer 50 to engage in video conferencing with any other users, individuals, entities, providers, funding services or funding sources, official filing offices, agents, brokers, social networks, social network operators, social network members, media services or media sources, information services or sources, or news services or news sources, and/or which can be utilized to allow a user or operator of the official filing office computer 50 to record and/or transmit video messages, video e-mails, and/or which can allow a user or operator of the official filing office computer 50 to utilize or engage in or with any other video messaging applications.

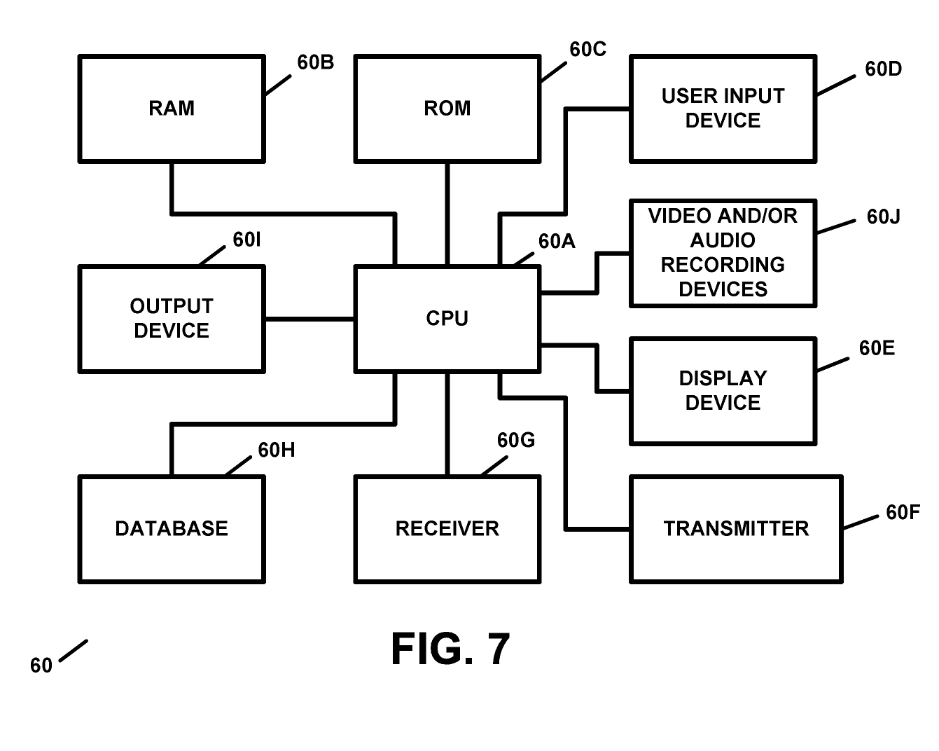

FIG. 7 illustrates the agent/broker communication device 60 of FIG. 1, in block diagram form. The agent/broker communication device 60, in the preferred embodiment, can be any computer, personal computer, network computer, or computer system, or any other computer or communication device, which can be utilized as an agent/broker communication device 60. In the preferred embodiment, the agent/broker communication device 60 includes a central processing unit or CPU 60A, which in the preferred embodiment, is a microprocessor. The CPU 60A may also be a microcomputer, a minicomputer, a macro-computer, and/or a mainframe computer, depending upon the application.

The agent/broker communication device 60 also includes a random access memory device(s) 60B (RAM) and a read only memory device(s) 60C (ROM), each of which is connected to the CPU 60A, a user input device 60D, for entering data, information, and/or commands, into the agent/broker communication device 60, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data, information, or commands into the agent/broker communication device 60, and which input device(s) are also connected to the CPU 60A.

The agent/broker communication device 60 also includes a display device 60E for displaying data and/or information to a user or operator. The agent/broker communication device 60 also includes a transmitter(s) 60F, for transmitting signals and/or data and/or information to any one or more of the central processing computer(s) 10, the user communication device(s) 20, the provider communication device(s) 30, the funding service communication device(s) 40, the official filing office computer(s) 50, any other agent/broker communication device(s) 60, the social networking computer(s) 70, and/or the media computer(s) 80, which may be utilized in conjunction with the apparatus 100 and method of the present invention. The agent/broker communication device 60 also includes a receiver 60G, for receiving signals and/or data and/or information from any one or more of the central processing computer(s) 10, the user communication device(s) 20, the provider communication device(s) 30, the funding service communication device(s) 40, the official filing office computer(s) 50, any other agent/broker communication device(s) 60, the social networking computer(s) 70, and/or the media computer(s) 80, which may be utilized in conjunction with the apparatus 100 and method of the present invention.

The agent/broker communication device 60 also includes a database(s) 60H for storing any data and/or information needed or desired for utilizing the apparatus 100 and method of the present invention and/or for performing any and/or all of the functions and functionality described herein as being performed by the apparatus 100, the central processing computer 10, and/or the agent/broker communication device 60.

In a preferred embodiment, the database 60H can contain and/or can include, for the agent or the broker who or which utilizes the agent/broker communication device 60, information regarding the agent's or the broker's name, address, telephone number, cellular telephone number, wireless telephone number, e-mail address, text messaging number, SMS messaging number, names of principals, employees or agents and contact information for same, company name or business name, company telephone number or business telephone number, company e-mail address or business e-mail address, the agent's or the broker's agent's name, the agent's or the broker's agent's telephone number, the agent's or the broker's agent's cellular telephone number, the agent's or the broker's agent's wireless telephone number, the agent's or the broker's agent's e-mail address, the agent's or the broker's text messaging number, the agent's or the broker's SMS messaging number, and/or any other contact information for the agent or the broker and/or for the agent's or the broker's, principals, employees, or agents.

The database 60H can also contain and/or include, for the agent or the broker, a description of the types or kinds of services, and/or any goods or products, provided, offered, or performed by the agent or the broker, information regarding the commissions, success fees, prices, fees, or charges, for the agent's or the broker's various services, goods, or products, information regarding educational or training information, professional or other licenses or certifications, resume(s), qualifications, honors or awards, work samples, references, past work performed, past deals worked on or completed, past project or work experiences, desired investments, projects or jobs, types or kinds of projects, compensation structures, marketing information and/or materials of or regarding the agent or the broker, and/or information regarding principals, employees, partners, business partners, working partners, or agents, of the agent or the broker.

The database 60H can also contain and/or include information regarding the agent or the broker, or the agent's or the broker's employees' or agents′, work schedule(s), work calendar(s), or other scheduling information, which can be utilized to allow any user of the apparatus 100 to engage or reserve the agent's or the broker's services, or the agent's or the broker's employees' or agent's services. The database 10H can also contain and/or include information for allowing any user of the apparatus 100 to order or purchase goods, products, or services, from the agent or the broker or engage the services of the agent or the broker or engage the services of any principals, employees, or agents, of the agent or the broker.

The database 10H can also contain and/or include information regarding any available subscriptions offered by the agent or the broker for any services, goods, or products, performed by or offered by the agent or the broker, so that any user can purchase a subscription from the agent or the broker for any services, or goods or products, performed by or offered by the agent or the broker.

The database 10H can also contain and/or include any link(s) or hyperlink(s) to the agent or the broker, a link(s) or a hyperlink(s) to the agent/broker communication device(s) 60 of or associated with the agent or the broker, and/or any other data and/or information needed or desired for utilizing the apparatus 100 and method of the present invention in any of the embodiments described herein. The database 10H can also contain and/or include a link(s) or a hyperlink(s) to, any data and/or information maintained by, provided by, offered by, or sold by, the agent or the broker and/or which can be accessed or obtained from the agent or the broker or any computer, server, or website, of same.

The database 60H can also contain and/or include, and/or contain and/or include a link(s) or a hyperlink(s) to, any data and/or information described herein as being stored in any of the databases 10H, 20H, 30H, 40H, 50H, 60H, 70H, and/or 80H, described herein.

The agent/broker communication device 60 also includes an output device 601 for outputting any data, information, report, or message, described herein. In the preferred embodiment, the output device 601 can be a printer, a display, a transmitter, a modem, and/or any other device which can be used to output data or information.

The agent/broker communication device 60 also includes a video and/or audio recording device(s) 60J which can include a camera and/or a video recording device for recording pictures or video and/or video clips and/or a microphone or an audio recording device for recording audio or audio clips which can be stored in the agent/broker communication device 60, and/or which can be transmitted to and/or stored in any other agent/broker communication device(s) 60, the central processing computer(s) 10, the user communication device(s) 20, the provider communication device(s) 30, the funding service communication device(s) 40, the official filing office computer(s) 50, the social networking computer(s) 70, and/or the media computer(s) 80, described herein, and/or which can be utilized to allow a user or operator of the agent/broker communication device 60 to engage in video conferencing with any other users, individuals, entities, providers, funding services or funding sources, official filing offices, agents, brokers, social networks, social network operators, social network members, media services or media sources, information services or sources, or news services or news sources, and/or which can be utilized to allow a user or operator of the agent/broker communication device 60 to record and/or transmit video messages, video e-mails, and/or which can allow a user or operator of the agent/broker communication device 60 to utilize or engage in or with any other video messaging applications.

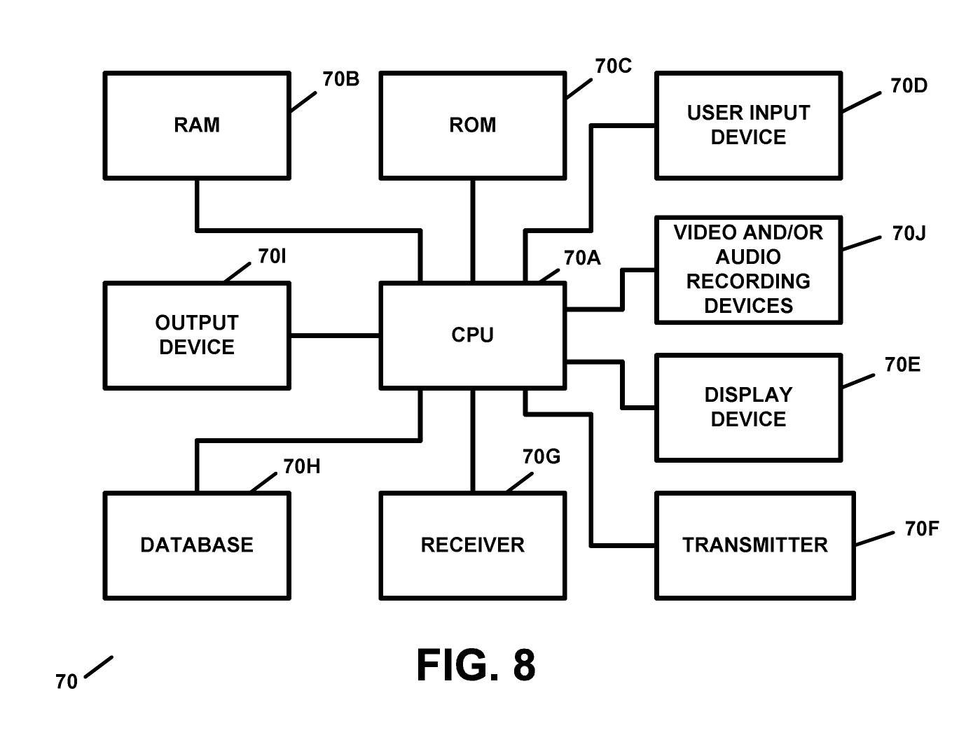

FIG. 8 illustrates the social networking computer 70 of FIG. 1, in block diagram form. The social networking computer 70, in the preferred embodiment, can be any computer, personal computer, network computer, or computer system, or any other computer or communication device, which can be utilized as a social networking computer 70. In the preferred embodiment, the social networking computer 70 includes a central processing unit or CPU 70A, which in the preferred embodiment, is a microprocessor. The CPU 70A may also be a microcomputer, a minicomputer, a macro-computer, and/or a mainframe computer, depending upon the application.

The social networking computer 70 also includes a random access memory device(s) 70B (RAM) and a read only memory device(s) 70C (ROM), each of which is connected to the CPU 70A, a user input device 70D, for entering data, information, and/or commands, into the social networking computer 70, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data, information, or commands into the social networking computer 70, and which input device(s) are also connected to the CPU 70A.

The social networking computer 70 also includes a display device 70E for displaying data and/or information to a user or operator. The social networking computer 70 also includes a transmitter(s) 70F, for transmitting signals and/or data and/or information to any one or more of the central processing computer(s) 10, the user communication device(s) 20, the provider communication device(s) 30, the funding service communication device(s) 40, the official filing office computer(s) 50, the agent/broker communication device(s) 60, any other social networking computer(s) 70, and/or the media computer(s) 80, which may be utilized in conjunction with the apparatus 100 and method of the present invention. The social networking computer 70 also includes a receiver 70G, for receiving signals and/or data and/or information from any one or more of the central processing computer(s) 10, the user communication device(s) 20, the provider communication device(s) 30, the funding service communication device(s) 40, the official filing office computer(s) 50, the agent/broker communication device(s) 60, any other social networking computer(s) 70, and/or the media computer(s) 80, which may be utilized in conjunction with the apparatus 100 and method of the present invention.

The social networking computer 70 also includes a database(s) 70H for storing any data and/or information needed or desired for utilizing the apparatus 100 and method of the present invention and/or for performing any and/or all of the functions and functionality described herein as being performed by the apparatus 100, the central processing computer 10, and/or the social networking computer 70.

In a preferred embodiment, the database 70H can contain and/or can include, for the social network which utilizes the social network computer 70, information regarding the name, domain name, uniform resource locator (url), or web address, of the social network, information regarding any members of the social network and for each member, the member's name, address, telephone number, cellular telephone number, wireless telephone number, e-mail address, text messaging number, SMS messaging number, company name or business name, company telephone number or business telephone number, company e-mail address or business e-mail address, and/or any other contact information for the social networking member.

The database 70H can also contain and/or include, for the social network, any link(s) or hyperlink(s) to the social network, a link(s) or a hyperlink(s) to the social network computer(s) 70 of or associated with the social network, and/or any other data and/or information needed or desired for utilizing the apparatus 100 and method of the present invention in any of the embodiments described herein. The database 70H can also, for the social network, contain and/or include, and/or contain and/or include a link(s) or a hyperlink(s) to, any data and/or information maintained by, provided by, offered by, or sold by, the social network and/or which can be accessed or obtained from the social network or any computer, server, or web site, of same.

The database 70H can also contain and/or include, for the social network and/or each of the social networking members, a description of the social network sub-group(s) in which the member belongs and any information regarding each subgroup(s) and any characteristics or interests of the members of each subgroup.

The database 70H can also contain and/or include, for the social network and/or each of the social networking members, any link(s) or hyperlink(s) to the social networking computer 70 associated with the social network, and/or can contain and/or include any link(s) or hyperlink(s) to any group(s) or subgroup(s) in that social network. The database 70H can also, for the social network and/or for each of the social networking members, contain and/or include, and/or contain or include a link(s) or a hyperlink(s) to, any data and/or information maintained by, provided by, offered by, or sold by, the social network or the social networking company or entity associated with same and/or which can be accessed or obtained from the social network or the social networking company or entity associated with same, or any computer, server, or web site, of same.

The database 70H can also contain and/or include, and/or contain and/or include a link(s) or a hyperlink(s) to, any data and/or information described herein as being stored in any of the databases 10H, 20H, 30H, 40H, 50H, 60H, 70H, and/or 80H, described herein.

The social networking computer 70 also includes an output device 701 for outputting any data, information, report, or message, described herein. In the preferred embodiment, the output device 701 can be a printer, a display, a transmitter, a modem, and/or any other device which can be used to output data or information.

The social networking computer 70 also includes a video and/or audio recording device(s) 70J which can include a camera and/or a video recording device for recording pictures or video and/or video clips and/or a microphone or an audio recording device for recording audio or audio clips which can be stored in the social networking computer 70, and/or which can be transmitted to and/or stored in any other social networking computer(s) 70, the central processing computer(s) 10, the user communication device(s) 20, the provider communication device(s) 30, the funding service communication device(s) 40, the official filing office computer(s) 50, the agent/broker communication device(s) 60, and/or the media computer(s) 80, described herein, and/or which can be utilized to allow a user or operator of the social networking computer 70 to engage in video conferencing with any other users, individuals, entities, providers, funding services or funding sources, official filing offices, agents, brokers, social networks, social network operators, social network members, media services or media sources, information services or sources, or news services or news sources, and/or which can be utilized to allow a user or operator of the social networking computer 70 to record and/or transmit video messages, video e-mails, and/or which can allow a user or operator of the social networking computer 70 to utilize or engage in or with any other video messaging applications.

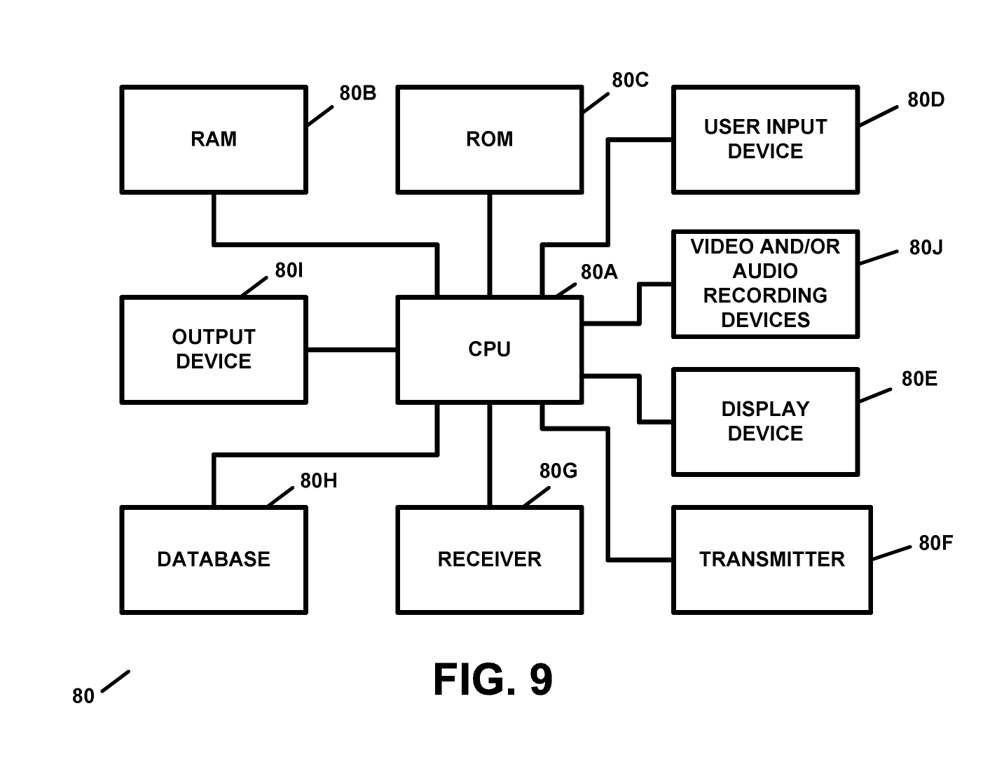

FIG. 9 illustrates the media computer 80 of FIG. 1, in block diagram form. The media computer 80, in the preferred embodiment, can be any computer, personal computer, network computer, or computer system, or any other computer or communication device, which can be utilized as a media computer 80. In the preferred embodiment, the media computer 80 includes a central processing unit or CPU 80A, which in the preferred embodiment, is a microprocessor. The CPU 80A may also be a microcomputer, a minicomputer, a macro-computer, and/or a mainframe computer, depending upon the application.

The media computer 80 also includes a random access memory device(s) 80B (RAM) and a read only memory device(s) 80C (ROM), each of which is connected to the CPU 80A, a user input device 80D, for entering data, information, and/or commands, into the media computer 80, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data, information, or commands into the media computer 80, and which input device(s) are also connected to the CPU 80A.

The media computer 80 also includes a display device 80E for displaying data and/or information to a user or operator. The media computer 80 also includes a transmitter(s) 80F, for transmitting signals and/or data and/or information to any one or more of the central processing computer(s) 10, the user communication device(s) 20, the provider communication device(s) 30, the funding service communication device(s) 40, the official filing office computer(s) 50, the agent/broker communication device(s) 60, the social networking computer(s) 70, and/or any other media computer(s) 80, which may be utilized in conjunction with the apparatus 100 and method of the present invention. The media computer 80 also includes a receiver 80G, for receiving signals and/or data and/or information from any one or more of the central processing computer(s) 10, the user communication device(s) 20, the provider communication device(s) 30, the funding service communication device(s) 40, the official filing office computer(s) 50, the agent/broker communication device(s) 60, the social networking computer(s) 70, and/or any other media computer(s) 80, which may be utilized in conjunction with the apparatus 100 and method of the present invention.

The media computer 80 also includes a database(s) 80H for storing any data and/or information needed or desired for utilizing the apparatus 100 and method of the present invention and/or for performing any and/or all of the functions and functionality described herein as being performed by the apparatus 100, the central processing computer 10, and/or the media service computer 80.

In a preferred embodiment, the database 80H can contain and/or can include, for the media service who or which utilizes the media service computer 80, data and/or information regarding the media service's name, address, telephone number, e-mail address, company name or business name, company telephone number or business telephone number, company e-mail address or business e-mail address, employee directory, and/or any other contact information for the media service or its employees or agents. The database 80H can also contain and/or include, any and/or all media, information, or new information, provided by the media service in any text form, in video form, in audio form, and/or in any combination of same.

The database 80H can also contain and/or include, for the media service, a description of the types or kinds of media, information, or news information, or any other services, products or goods, performed, provided, or offered, by the media service, the type or kind of media, information, or news information, provided by the media service, information regarding whether or not the media service provides, and/or the types or kinds of, general news or information, global news or information, national news or information, regional news or information, local news or information, business news of information, investment news of information, financial news of information, legal news or information, news or information regarding patents, trademarks, copyrights, trade secrets, or other intellectual property, any news or information regarding any commercialization, development, marketing, sale, transfer, licensing, and/or monetization, of or regarding patents, trademarks, copyrights, trade secrets, or other intellectual property, or any other media, information, or news information which may be of interest to any of the users, providers, funding services, official or governmental filing offices, agents, brokers, social networks or social networking members, or any other media services, who or which utilize the apparatus 100 and method of the present invention.

The database 80H can also contain and/or include, for the media service, the prices or fees for the various media services, or products or goods, offered by or provided by the media service.

The database 80H can also contain and/or include, for the media service, information regarding any available subscriptions offered by the media service for any services, goods, or products, performed by or offered by the media service, so that any user can purchase a subscription from the media service for any services, or goods or products, performed by or offered by the media service. In a preferred embodiment, any data and/or information provided by, and/or any media, information, or news information, provided by, the media service can be provided in text form, video form, audio form, or any combination of same.

The database 80H can also contain and/or include any link(s) or hyperlink(s) to the media service, a link(s) or a hyperlink(s) to any other media service computer(s) 80 of or associated with the media service, and/or any other data and/or information needed or desired for utilizing the apparatus 100 and method of the present invention in any of the embodiments described herein. The database 80H can also contain and/or include, and/or contain and/or include a link(s) or a hyperlink(s) to, any data and/or information maintained by, provided by, offered by, or sold by, the media service and/or which can be accessed or obtained from the media service or any computer, server, or website, of same.

The database 80H can also contain and/or include, and/or contain and/or include a link(s) or a hyperlink(s) to, any data and/or information, and/or any media, information, or news information, provided by, offered by, sold by, or maintained by, the media service and/or which can be accessed or obtained from the media service or any computer, server, or website, of same.

The database 80H can also contain and/or include, and/or contain and/or include a link(s) or a hyperlink(s) to, any data and/or information described herein as being stored in any of the databases 10H, 20H, 30H, 40H, 50H, 60H, 70H, and/or 80H, described herein.

The media computer 80 also includes an output device 801 for outputting any data, information, report, or message, described herein. In the preferred embodiment, the output device 801 can be a printer, a display, a transmitter, a modem, and/or any other device which can be used to output data or information.

The media computer 80 also includes a video and/or audio recording device(s) 80J which can include a camera and/or a video recording device for recording pictures or video and/or video clips and/or a microphone or an audio recording device for recording audio or audio clips which can be stored in the media computer 80, and/or which can be transmitted to and/or stored in any other media computer(s) 80, the central processing computer(s) 10, the user communication device(s) 20, the provider communication device(s) 30, the funding service communication device(s) 40, the official filing office computer(s) 50, the agent/broker communication device(s) 60, and/or the social networking computer(s) 80, described herein, and/or which can be utilized to allow a user or operator of the media computer 80 to engage in video conferencing with any other users, individuals, entities, providers, funding services or funding sources, official filing offices, agents, brokers, social networks, social network operators, social network members, media services or media sources, information services or sources, or news services or news sources, and/or which can be utilized to allow a user or operator of the media computer 80 to record and/or transmit video messages, video e-mails, and/or which can allow a user or operator of the media computer 80 to utilize or engage in or with any other video messaging applications.

In a preferred embodiment, the apparatus 100 and method of the present invention can be utilized in order to allow any user, individual, or entity, to post, list, or register, his, her, or its, intellectual property with the apparatus 100 of the present invention for purposes of commercializing, developing, marketing, selling, transferring, licensing, and/or monetizing, same. In such an embodiment, the apparatus 100 and method of the present invention can be utilized as a posting, listing, or registration, entity for intellectual property of any type or kind.

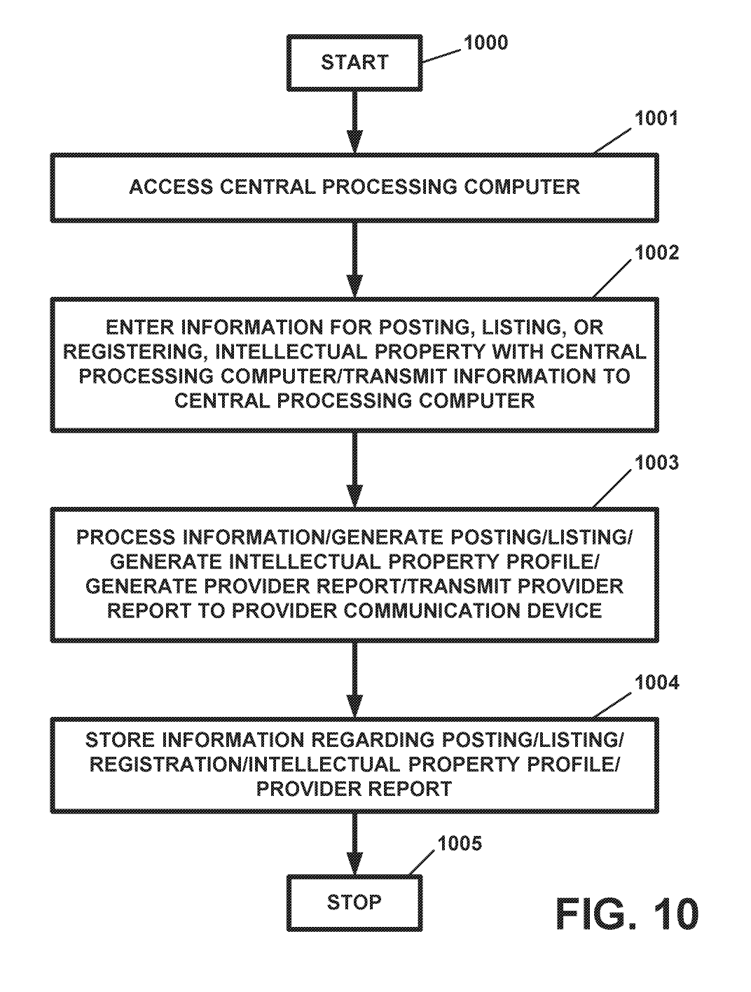

FIG. 10 illustrates a preferred embodiment method of utilizing the apparatus 100 of the present invention, in flow diagram form. While the embodiment of FIG. 10 is described herein as using a patent application and any rights to foreign patent applications as the subject intellectual property, it is to be understood that the embodiment of FIG. 10 can also be utilized, in a same, a similar, or an analogous, manner in connection with any type or kind of intellectual property, described or identified herein or otherwise, and/or with any type or kind of foreign rights, international rights, or derivative rights, associated with same or related to same.

In the exemplary embodiment described in connection with the preferred embodiment of FIG. 10, a user who or which owns a pending United States patent application can, for example, post, list, or register, his, her, or its, patent application with the apparatus 100 in order to identify, find, or locate, a provider, a funding service, or any other entity, or any other user of the apparatus 100 of the present invention, in order to commercialize, develop, market, sell, transfer, license, or monetize, the invention or inventions described in the patent application. The user can also post, list, or register, any rights to any foreign or international patent applications which, can be counterparts of or to the United States patent application, or which can claim any benefit of any priority to the United States patent application in order to commercialize, develop, market, sell, transfer, license, or monetize, same.

With reference to FIG. 10, the operation of the apparatus 100 commences at step 1000. At step 1001, the user can access the central processing computer 10 with or using his, her, or its, user communication device 20. At step 1002, the user can post, list, or register, his, her, or its, United States patent application with the central processing computer 10 by entering information regarding same into the user communication device 20 and by transmitting same to the central processing computer 10.

At step 1002, the user can also enter information regarding the serial number of the United States patent application (“the patent application”), the title of the patent application, a brief description of any invention(s) described in or covered by the patent application, the names of the applicant(s), inventor(s), or any assignee, a legal representative, any user ideas for uses of the invention(s) described or covered in the patent application, any foreign patent application(s) or international patent application(s) which are or can be counterpart(s) to the patent application or which can correspond to same in a foreign country, or which can claim the benefit of the priority of the patent application. At step 1002, the user can also enter information regarding the category or categories, and/or any sub-category or sub-categories, of services, goods, or products, within which he, she, or it, believes the invention, described or covered in the patent application, falls. For example, for a software patent or business method patent relating to providing an Internet-based retail shopping website for clothing and apparel, the user might enter information categorizing the invention as being in an Internet electronic commerce retail sales category and as also being in a clothing and apparel subcategory of said category.

At step 1002, the user can also enter information regarding his, her, or its, objectives, plans, or desires, for commercializing, developing, marketing, selling, transferring, licensing, or monetizing the patent application, any foreign counterpart(s) or international counterparts(s) of the patent application, and/or any inventions described in or covered by the patent application. At step 1002, the user can also enter information regarding his, her, or its, plans or desired courses of action for or regarding the patent application, or any patent(s) which might issue from same, or any need of any service(s) of any provider(s), or any need for any good(s) or product(s) of any provider, the user's budget or budget for certain projects or services, or any need of or for funding regarding or relating to any desired courses of action, or any need or needs for any provider(s) or funding service, for facilitating any commercialization, development, marketing, sale, transfer, licensing, and/or monetization, of, for, or regarding, the patent application, any foreign counterpart(s) or international counterparts(s) of the patent application, and/or of, for, or regarding, any inventions described in or covered by the patent application.

For example, for a patent application for or covering an Internet software invention or software products and/or services relating to same, the user can enter information whereby he, she, or it, can express a need or a desire for, or to hire, a patent attorney to assist in prosecuting the patent application in the United States for the user or to hire a commercial attorney to represent the user in starting a business entity to practice the inventions described in or covered by the patent application, or a need for or a desire to engage the services of a funding service, or to find an investor, to provide funding for the any commercialization, development, marketing, sale, transfer, licensing, and/or monetization, activities, or a need or a desire for, or to hire, a software developer to develop the invention described in or covered by the patent application into an operational website, or a need or a desire for, or to hire, a webhosting service, or a need or a desire to engage the services of an agent, a patent broker, or a patent auction company or service, in order to assist the user to selling or in auctioning off rights to any foreign patent application counterparts or international patent application counterparts to the patent application, any licenses, covenants not to sue, or releases, under the patent application or any foreign patent application counterparts or international patent application counterparts to same, or any use, sale, or development rights to or under the patent application or any foreign patent application counterparts or international patent application counterparts to same.

In a preferred embodiment, at step 1002, the user can enter any data and/or information in any order or manner determined or selected by the user, or the central processing computer 10 can also provide the user with information, prompts, or templates, which can be tailored to elicit the information from the user depending upon any information which having been provided by the user at or during step 1002. At step 1002, the information entered by the user at step 1002, can be transmitted to, and can be received by, the central processing computer 10 at step 1002. At step 1002, the user can also transmit a copy of the patent application to the central processing computer 10, or upload a copy of the patent application to the central processing computer 10.

At step 1003, the central processing computer 10 can process the data and/or information received at step 1002 and can generate a posting or listing of or for the patent application. At step 1003, the central processing computer 10 can also generate an intellectual property profile for the patent application containing any information regarding the patent application, the invention(s) described therein or covered thereby, any information regarding the user's plans or desires for the user can also enter information regarding his, her, or its, plans or desired for commercializing, developing, marketing, selling, transferring, licensing, or monetizing the patent application, any foreign counterpart(s) or international counterparts(s) of the patent application, and/or any inventions described in or covered by the patent application, or information regarding the user's plans or desired courses of action for or regarding the patent application, or any patent(s) which might issue from same, or any need by the user for any providers for providing any services, goods, or products. Once generated, the intellectual property profile can be stored in the database 10H of the central processing computer 10 for later searches and retrievals by any providers, funding services, agents, or brokers, or other users, who or which utilize the apparatus 100 and method of the present invention.

At step 1003, the central processing computer 10 can also process any information stored in the database 10H in order to identify, find, or locate, a provider(s), funding service(s), or an investor(s), or an agent or broker, who or which has been previously registered with the apparatus 100 of the present invention as being interested in serving the needs of the user. At step 1003, the central processing computer 10 can generate a provider report which can contain information identifying a provider or providers who or which can provide any needed or desired services, goods, or products, to the user, or which or which can otherwise assist the user in pursuing his, her, or its, objectives, can generate a funding service/investor report which can contain information identifying a funding service or funding services or an investor or investors who or which might be able to assist the user with his, her, or its, funding needs, or can generate an agent/broker report which can contain information identifying an agent or a broker who or which can provide any needed or desired services to the user.

In a preferred embodiment, the provider report can contain, for each provider identified therein, information identifying the provider, a telephone number for the provider, an e-mail address for the provider, a text message or an SMS message number for the provider, information regarding the provider's business address, website, or a link or a hyperlink to the provider's website, information regarding any credentials or qualifications of the provider, information regarding any services provided by the provider, information regarding any goods or products provided by the provider, information regarding the provider's work schedule or work schedules, information or instructions for reserving, hiring, or engaging, the services of the provider, information regarding the provider's price lists, fees, fee schedules, or rates, information or instructions for ordering goods or products from the provider, or information regarding the prices or price lists for goods or services offered or sold by the provider, or information for or regarding any contract or contracts, or any link or hyperlink to same, used by or required by the provider in order to allow the user to engage the services of the provider, purchase goods or products from the provider, or to otherwise do business with the provider.

In a preferred embodiment, the funding service/investor report can contain, for each funding service or investor identified therein, information identifying the funding service or the investor, a telephone number for the funding service or the investor, an e-mail address for the funding service or the investor, a text message or an SMS message number for the funding service or the investor, information regarding the funding service's or the investor's business address, website, or a link or a hyperlink to the funding service's or the investor's website, information regarding any credentials or qualifications of the funding service's or the investor's, information regarding any services provided by the funding service's or the investor's, information regarding the funding service's or the investor's schedule or schedules, information or instructions for reserving, hiring, or engaging, the services of the funding service, or information or instructions for providing the investor with information for the investor to consider, information regarding the funding service's price lists, fees, fee schedules, or rates, or information for or regarding any contract or contracts, or any link or hyperlink to same, used by or required by the funding service or the investor in order to allow the user to engage the services of the funding service or in order to submit information to the investor.

In a preferred embodiment, the agent/broker report can contain, for each agent or broker identified therein, information identifying the agent or the broker, a telephone number for the agent or the broker, an e-mail address for the agent or the broker, a text message or an SMS message number for the agent or the broker, information regarding the agent's or the broker's business address, website, or a link or a hyperlink to the agent's or the broker's website, information regarding any credentials or qualifications of the agent or the broker, information regarding any services provided by the agent or the broker, information regarding the agent's or the broker's work schedule or work schedules, information or instructions for reserving, hiring, or engaging, the services of the agent or the broker, information regarding the agent or the broker's commissions, price lists, fees, fee schedules, or rates, or information for or regarding any contract or contracts, or any link or hyperlink to same, used by or required by the agent or the broker in order to allow the user to engage the services of the agent or the broker, or to otherwise do business with the agent or the broker.

At step 1003, the central processing computer 10 can transmit the provider report, the funding service/investor report, or the agent/broker report, to the user communication device 20 of or associated with the user. At step 1003, the user can review any information contained in the provider report, in the funding service/investor report, or in the agent/broker report, and can decide to make contact with or explore discussions or opportunities with any provider identified in the provider report, to make contact with or explore discussions or opportunities with any funding service or with any investor identified in the funding service/investor report, or to make contact with or explore discussions or opportunities with any agent or broker identified in the agent/broker report.

In another preferred embodiment, the central processing computer 10, at step 1003, can generate an intellectual property report containing any information contained in the intellectual property profile, including, at the very least, information regarding the patent application and information for contacting the user, and can transmit same to any provider communication device(s) 30 of or associated with any provider(s) identified at step 1003 or included or identified in any provider report, can transmit the intellectual property report to any funding service communication device(s) 40 of or associated with any funding service(s) or investor(s) identified at step 1003 or included or identified in any funding service/investor report, or can transmit the intellectual property report to any agent/broker communication device(s) of or associated with any agent(s) or broker(s) identified in the agent/broker report. At step 1003, any respective provider, any respective funding service or investor, or any respective agent or broker, can review the intellectual property report and can contact the user to explore any discussions or opportunities with the user.

In another preferred embodiment, the central processing computer 10, at step 1003, can generate an intellectual property report message which can contain information regarding any provider(s), funding service(s), or investor(s), or agent(s) or broker(s), to whom or to which an intellectual property report was transmitted and can transmit the intellectual property report message to the user communication device 20 of the user.

At step 1004, the central processing computer 10 can store any information processed at step 1002 and/or at step 1003, and/or can store any data and/or information regarding the posting, the listing, or the registration, of the patent application and/or any associated data and/or information provided by the user, and/or the central processing computer 10 can store the intellectual property profile, and/or can store any provider report(s), any funding service/investor report(s), any agent/broker report(s), any intellectual property report(s), or any intellectual property report message(s), if generated, in the database 10H. Thereafter, the operation of the apparatus 100 will cease at step 1005.

In another preferred embodiment, the apparatus 100 of FIG. 10 can be utilized in a same, in a similar, and/or in an analogous manner, in connection with the posting, listing, or registration, of any types or kinds of intellectual property described herein or otherwise, and/or in connection with any types or kinds of providers, service providers, goods providers, funding services, investors, agents, brokers, official or governmental filing offices, social networks, media services, information service, or news information services, described herein or otherwise.

In another preferred embodiment, the apparatus 100 and method of the present invention can be utilized in order to allow any provider, service provider, goods provider, funding service, investor, agent, broker, media service, information service, or news information service, post, list, or register, himself, herself, or itself, and/or information regarding the respective services, goods, or products, which he, she, or it, provides, with the apparatus 100 of the present invention for purposes of serving the commercializing, developing, marketing, selling, transferring, licensing, and/or monetizing, needs of any of users described herein who or which own, hold, or manage any intellectual property. In such an embodiment, the apparatus 100 and method of the present invention can be utilized as a posting, listing, or registration, entity for services, goods, or products, of any type or kind.

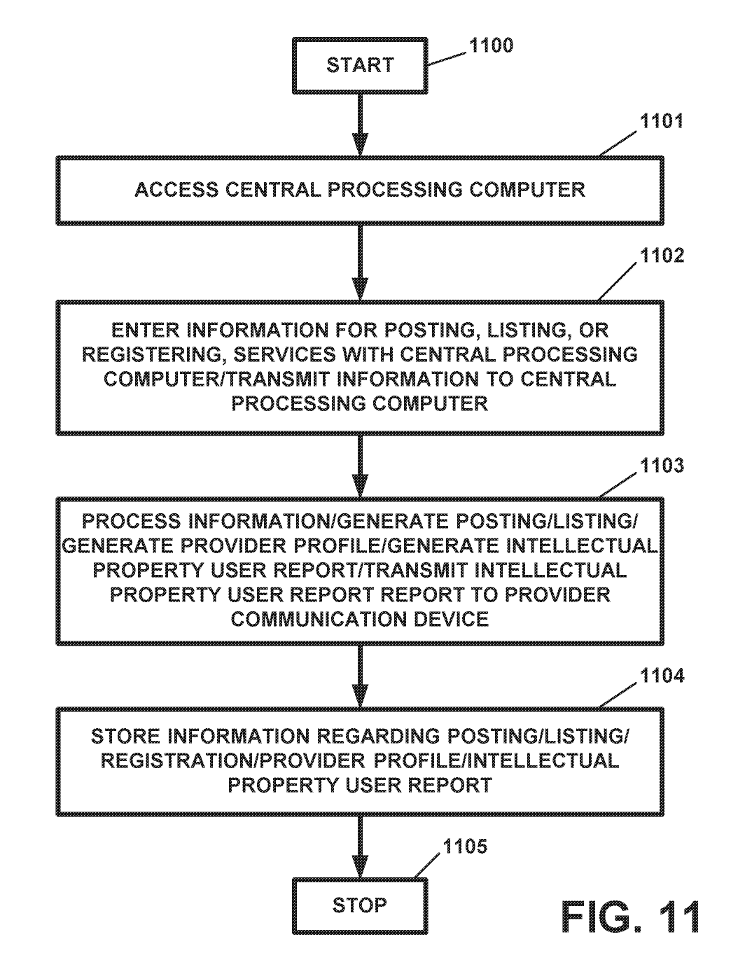

FIG. 11 illustrates a preferred embodiment method of utilizing the apparatus 100 of the present invention, in flow diagram form. While the embodiment of FIG. 11 is described herein as being used by a provider of a service or a service provider to post, list, or register, himself, herself, or itself, along with information regarding the service or services he, she, or it, provides, it is to be understood that the embodiment of FIG. 11 can also be utilized, in a same, a similar, or an analogous, manner in connection with any type or kind of provider, service provider, goods provider, funding service, investor, official or governmental filing office, agent, broker, media service, information service, or news information service, post, list, or register, himself, herself, or itself, and/or information regarding the respective services, goods, or products, which he, she, or it, provides which can be of assistance to a user in commercializing, developing, marketing, selling, transferring, licensing, and/or monetizing, intellectual property.

In the exemplary embodiment described in connection with the preferred embodiment of FIG. 110, a provider of website development and/or software development can, for example, post, list, or register, his, her, or its, services with the apparatus 100 in order to identify, find, or locate, a user interested in commercializing or developing his, her, or its, intellectual property, which in an exemplary embodiment, can be a patent or a patent application describing or covering a software invention or a business method invention which the user desires to practice. Although described as being utilized by a provider of website development services and/or software development services to identify a user interested in commercializing or developing a software or business method invention, it is to be understood, that the embodiment of FIG. 11 can be utilized in a same, a similar, or an analogous, manner to identify any user for which the provider can provide services, goods, or products, to allow or assist any user to commercialize, develop, market, sell, transfer, license, or monetize, his, hers, or its, intellectual property of any type or kind.

With reference to FIG. 11, the operation of the apparatus 100 commences at step 1100. At step 1101, the provider can access the central processing computer 10 with or using his, her, or its, provider communication device 30. At step 1102, the provider can post, list, or register, his, her, or its, services with the central processing computer 10 by entering information regarding same into the provider communication device 30 and by transmitting same to the central processing computer 10.

At step 1102, the provider can also enter information regarding himself, herself, or itself, information regarding the various services he, she, or it provides or performs, information regarding his, her, or its, telephone number, e-mail address, text message or an SMS message number, business address, website, a link or a hyperlink to the provider's website, information regarding any of the provider's credentials or qualifications, information regarding any services provided by the provider, information regarding any goods or products provided by the provider, information regarding the provider's work schedule or work schedules, information or instructions for reserving, hiring, or engaging, the services of the provider, information regarding the provider's price lists, fees, fee schedules, or rates, information or instructions for ordering goods or products from the provider, or information regarding the prices or price lists for goods or services offered or sold by the provider, or information for or regarding any contract or contracts, or any link or hyperlink to same, used by or required by the provider in order for a user to engage the services of the provider, purchase goods or products from the provider, or to otherwise do business with the provider. For example, the provider can post, list, or register, information regarding its experience and/or expertise in developing software and websites for certain software inventions or business method inventions in the hopes of finding work from users having software or business method inventions covered or described in a pending patent application or in an issued patent.

At step 1102, the provider can also enter information regarding his, her, or its, desired projects or jobs and any rates charged for his, her, or its, services. At step 1102, the provider can also enter information regarding any project category or categories and/or any project subcategory or subcategories of services, goods, or products, for which he, she, or it, is interested in being engaged or hired. In a preferred embodiment, at step 1102, the provider can enter any data and/or information in any order or manner determined or selected by the provider, or the central processing computer 10 can also provide the provider with information, prompts, or templates, which can be tailored to elicit the information from the provider depending upon information having been provided by the provider at and during step 1102. At step 1102, the information entered by the provider at step 1102, can be transmitted to, and can be received by, the central processing computer 10 at step 1102. At step 1102, the provider can also transmit any other information which might be deemed important for the provider's posting, listing, or registration.

At step 1103, the central processing computer 10 can process the data and/or information received at step 1102 and can generate a posting or listing of or for the provider. At step 1103, the central processing computer 10 can also generate a provider profile for the provider containing any information regarding the provider, his, her, or its, services offered, any goods or products offered, and/or any information regarding the provider's desired projects or jobs, for commercializing, developing, marketing, selling, transferring, licensing, or monetizing, certain intellectual property, and the provider's compensation requirements or fees.

Once generated, the provider profile can be stored in the database 10H of the central processing computer 10 for later searches and retrievals by any users described herein, or by any other providers, by any funding services or investor, by any agents or brokers, or by any other users, who or which utilize the apparatus 100 and method of the present invention.

At step 1103, the central processing computer 10 can also process any information stored in the database 10H in order to identify, find, or locate, any user(s) who or which has previously posted, listed, or registered intellectual property with the apparatus 100 of the present invention as being interested in securing or engaging the services of the provider. At step 1103, the central processing computer 10 can generate an intellectual property user report which can contain information identifying a user or users who or which might be in need of the provider's services.

In a preferred embodiment, the intellectual property user report can contain, for each user identified therein, information identifying the intellectual property which the respective user desires to commercialize, develop, market, sell, transfer, license, or monetize, a telephone number for the user, an e-mail address for the user, a text message or an SMS message number for the user, information regarding the user's business address, website, or a link or a hyperlink to the user's website, information regarding any services requested by the user, information regarding any goods or products requested by the user, information regarding the user's time requirements for having services performed or completed, information regarding the user's work schedule or work schedules, information, requirements, or instructions, for being interviewed by, hired by, or engaged by, the user, information regarding the user's budget or budgets, or information for or regarding any contract or contracts, or any link or hyperlink to same, used by or required by the user in order for the provider to be engaged by the user or to otherwise do business with the user.

At step 1103, the central processing computer 10 can transmit the intellectual property user report to the provider communication device 30 of or associated with the provider. At step 1103, the provider can review any information contained in the intellectual property user report and can decide to make contact with or explore discussions or opportunities with any user identified in the intellectual property user report.

At step 1103, the central processing computer 10, at step 1103, can also generate a provider report containing any information contained in the provider profile, including, at the very least, information regarding the provider and information for contacting the provider, and can transmit same to any user communication device(s) 20 of or associated with any user(s) identified at step 1103 or included or identified in any intellectual property user report. At step 1103, any respective user can review the provider report and can contact the provider to explore any discussions or opportunities with the provider.

In another preferred embodiment, the central processing computer 10, at step 1103, can also generate an intellectual property user report message which can contain information regarding any user(s) to whom or to which a provider report was transmitted and can transmit the intellectual property user report message to the provider communication device 20 of the provider. At step 1104, the central processing computer 10 can store any information processed at step 1102 and/or at step 1103, and/or can store any data and/or information regarding the posting, the listing, or the registration, of the provider and/or any associated data and/or information provided by the provider, and/or the central processing computer 10 can store the provider profile, and/or can store any intellectual property user report(s), or any intellectual property user report message(s), or any provider report(s), if generated, in the database 10H. Thereafter, the operation of the apparatus 100 will cease at step 1105.

In another preferred embodiment, the apparatus 100 of FIG. 11 can be utilized in a same, in a similar, and/or in an analogous, manner in connection with the posting, listing, or registration, of any type or kind of providers, service providers, goods providers, funding services, investors, agents, brokers, official or governmental filing offices, social networks, media services, information service, or news information services, described herein or otherwise, and/or in connection with any types or kinds of intellectual property, described herein or otherwise.

In another preferred embodiment, the apparatus 100 and method of the present invention can also be utilized in order to allow any user, provider, funding service or investor, agent or broker, social network, or media service, information service, or news information service, to be notified upon the posting, listing, or registration, of an intellectual property with the apparatus 100. In this regard, the apparatus 100 of the present invention can be utilized to generate a notification message or an alert message, containing information regarding a newly posted, listed, or registered, intellectual property, and to transmit the notification message or the alert message to a respective communication device 20, 30, 40, 60, 70, or 80 of a respective user, provider, funding service or investor, agent or broker, social network, or media service, information service, or news information service.

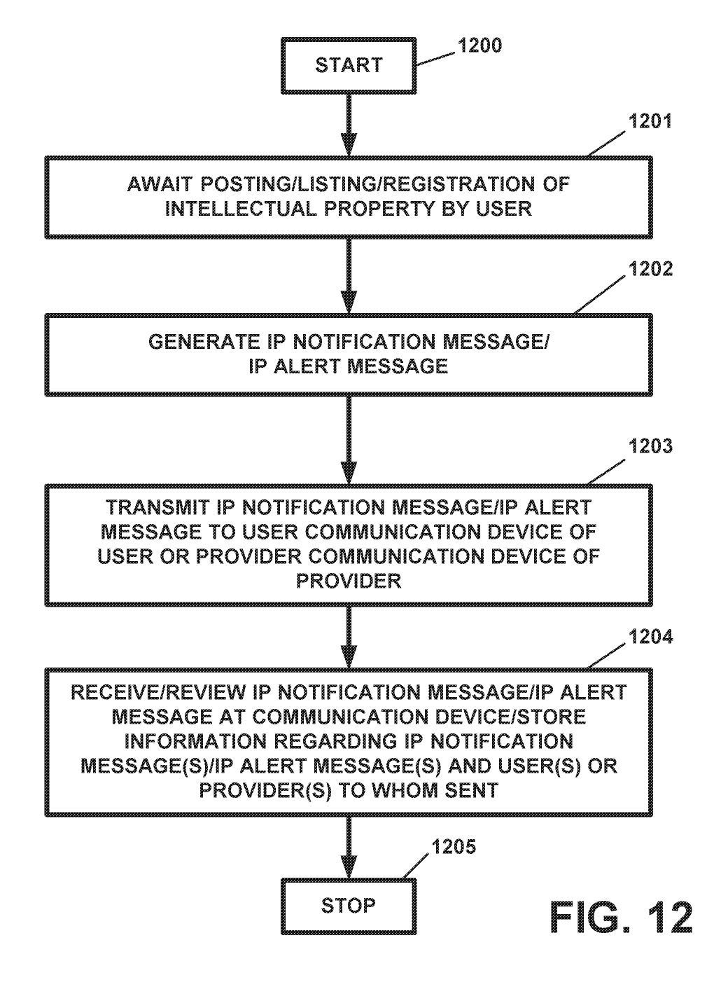

FIG. 12 illustrates another preferred embodiment method of utilizing the apparatus 100 of the present invention, in flow diagram form. While the embodiment of FIG. 12 is described herein as being used to provide a notification message or an alert message to a user, who or which may be interested in purchasing the intellectual property, or any rights in, to, or relating to, same, or to a provider who or which might be interested in providing services to user who or which owns, posts, lists, or registers, the intellectual property for facilitating the commercialization, development, marketing, sale, transfer, licensing, and/or monetization, of same, the apparatus 100 of FIG. 12 can also be utilized in a same, a similar, or an analogous, manner, in order to provide a notification message or an alert message to any of herein-described users, providers, funding services or investors, agents or brokers, social networks, or media services, information services, or news information services, for any reason or purpose.

In the embodiment of FIG. 12, any user, provider, funding service or investor, agent or broker, social network, or media service, information service, or news information service, can pre-register with the apparatus 100 and/or can set-up or establish with the central processing computer 10, or can program the central processing computer 10 with information regarding, any criteria for receiving a notification message or an alert message regarding any posting, listing, or registration, of any intellectual property of or for which the respective user, provider, funding service or investor, agent or broker, social network, or media service, information service, or news information service, desires to be notified. For, example, a user want to be notified if certain patent applications or patents may be available for sale or for licensing, a provider may want to be notified if an owner of a patent application in a specific category or technology field desires to commercialize same or develop same, or an agent or a broker may want to be notified if an owner of a patent application has a need for an agent or a broker for commercializing, developing, marketing, selling, transferring, licensing, or monetizing, same. Any such pre-registration information can be stored in the database 10H of the central processing computer 10.

With reference or FIG. 12, the operation of the apparatus 100 commences at step 1200. At step 1201, the central processing computer will await a posting, listing, or registration, or an intellectual property by a user. For example, in a preferred embodiment, the central processing computer 10 will await an occurrence of a user accessing same, and providing information regarding an intellectual property for posting, listing, or registration, with the apparatus 100. For example, a user can access the central processing computer 10 using his, her, or its, user communication device 20 and can enter information regarding an intellectual property. In the preferred embodiment of FIG. 12, the intellectual property posted, listed, or registered, can be a patent application. Although a patent application is used in the example of the preferred embodiment of FIG. 12, it is important to note that the embodiment of FIG. 12 can also be utilized in connection with any of the herein-described intellectual property, intellectual property types, or intellectual property kinds, described herein or otherwise.

In a preferred embodiment, the central processing computer 10 and/or the CPU 10A can detect the occurrence of the posting, the listing, or the registration, of the patent application by the user. The central processing computer 10 can receive and process any information regarding the patent application, and/or any foreign counterpart applications or international counterpart applications, which can be transmitted from the user's user communication device 20. The information provided by the user can contain or can include information regarding the patent application and any foreign counterpart application(s) or international counterpart application(s) (“counterpart application(s)”), the serial number of the patent application and/or of any counterpart application(s), the title of the patent application, a brief description of any invention(s) described in or covered by the patent application or counterpart application(s), the names of the applicant(s), inventor(s), or any assignee, a legal representative, any user ideas for uses of the invention(s) described or covered in the patent application or counterpart application(s), information regarding the category or categories, and/or any sub-category or sub-categories, of services, goods, or products, into which or within which he, she, or it, believes the invention, described or covered in the patent application or counterpart application(s), falls. For example, for a software patent or business method patent relating to providing an Internet-based retail shopping website for clothing and apparel, the user might enter information categorizing the invention as being in an Internet electronic commerce retail sales category and as also being in a clothing and apparel subcategory of said category.

The user can also enter information regarding his, her, or its, objectives, plans, or desires, for commercializing, developing, marketing, selling, transferring, licensing, or monetizing the patent application or any counterpart application(s), and/or any inventions described in or covered by the patent application. The user can also enter information regarding his, her, or its, plans or desired courses of action for or regarding the patent application or counterpart application(s), or any patent(s) which might issue from same, or any need of any service(s) of any provider(s), or any need for any good(s) or product(s) of any provider, the user's budget or budget for certain projects or services, or any need of or for funding regarding or relating to any desired courses of action, or any need or needs for any provider(s) or funding service, for facilitating any commercialization, development, marketing, sale, transfer, licensing, and/or monetization, of, for, or regarding, the patent application, any counterpart application(s), and/or of, for, or regarding, any inventions described in or covered by the patent application or the counterpart application(s).

For example, for a patent application for or covering an Internet software invention or software products and/or services relating to same, the user can enter information whereby he, she, or it, can express a need or a desire for, or to hire, a patent attorney to assist in prosecuting the patent application in the United States for the user or to hire a commercial attorney to represent the user in starting a business entity to practice the inventions described in or covered by the patent application, or a need for or a desire to engage the services of a funding service, or to find an investor, to provide funding for the any commercialization, development, marketing, sale, transfer, licensing, and/or monetization, activities, or a need or a desire for, or to hire, a software developer to develop the invention described in or covered by the patent application into an operational website, or a need or a desire for, or to hire, a webhosting service, or a need or a desire to engage the services of an agent, a patent broker, or a patent auction company or service, in order to assist the user to selling or in auctioning off rights to any foreign patent application counterparts or international patent application counterparts to the patent application, any licenses, covenants not to sue, or releases, under the patent application or any foreign patent application counterparts or international patent application counterparts to same, or any use, sale, or development rights to or under the patent application or any foreign patent application counterparts or international patent application counterparts to same.

The user can also enter information regarding an asking price or a selling price for the patent application or any counterpart application(s), or any asking prices for any license, exclusive license, non-exclusive license, or defined field of use license, or for any release or covenant not to sue regarding the patent application or counterpart application(s)

The user can also enter any information which many of interest to any other user or any provider regarding the patent application or counterpart applications. Once the user has entered and transmitted to the central processing computer 10 any and/or all information regarding the patent application or any counterpart application(s), and once the posting, listing, or registration, of same, is complete, the central processing computer 10 will detect same at step 1201.

At step 1202, the central processing computer 10 can generate an intellectual property (“IP”) notification message or an IP alert message which can contain or include any of the herein-described information regarding the patent application or any counterpart application(s) provided by the user when he, she, or it, posted, listed, or registered, the patent application and/or any counterpart application(s) with the central processing computer 10. In a preferred embodiment the IP notification message or the IP alert message can also contain a link(s) or a hyperlink(s) to the patent application or any counterpart application(s) and/or contact information, or a link(s) or a hyperlink(s) to contact information, for contacting the owner of the patent application or the user who posted, listed, or registered, same with the central processing computer 10. In the preferred embodiment, the contact information can be, or can include, but is not limited to, a telephone number, a cellular telephone number, an e-mail address, a text messaging number, an SMS messaging number, or any other contact information.

At step 1203, the central processing computer 10 can transmit the IP notification message or the IP alert message to the user communication device 20 of the user who or which desires to be notified of the posting, the listing, or the registration, of the patent application or any counterpart application(s) and/or can transmit the IP notification message or the IP alert message to the provider communication device 30 of the provider who or which desires to be notified of the posting, the listing, or the registration of the patent application or any counterpart application(s). At step 1204, the user communication device 20 of the user, desiring to the notified of the posting, the listing, or the registration, of the patent application or any counterpart application(s), can receive the IP notification message or the IP alert message or the provider communication device 30 of the provider desiring to the notified of the posting, the listing, or the registration, of the patent application or any counterpart application(s), can receive the IP notification message or the IP alert message.

At step the 1204, the user receiving the IP notification message or the IP alert message, or the provider receiving the IP notification message or the IP alert message, can review the information contained therein and decide whether or not to contact the owner of the patent application or the user who posted, listed, or registered, same with the central processing computer 10 in order to engage in any discussions regarding the patent application or any counterpart application(s) and/or to discuss any opportunities regarding same. At step 1204, the central processing computer 10 can also store any information regarding any IP notification message(s) or IP alert message(s) generated at step 1202 and transmitted by the central processing computer 10 at step 1203 and any information regarding the user or the provider to whom the IP notification message(s) or the IP alert message(s) were sent. Thereafter, the operation of the apparatus will cease at step 1205.

In another preferred embodiment, the apparatus 100 and method of the present invention can be utilized in order to allow any owner of intellectual property or any user who posts, lists, or registers, same with the apparatus 100 of the present invention to be notified upon the posting, listing, or registration, of any provider, funding service or investor, agent or broker, official or governmental filing office, social network, or media service, information service, or news information service, or any other user, who or which the owner of intellectual property or any user who posts, lists, or registers, same might be interested in engaging the services of, or might be interested in purchasing services, goods, or products, from, or might be interested in being represented by, or to whom the owner of intellectual property or any user who posts, lists, or registers, same might be interested in selling or licensing the intellectual property or a portion thereof, or who or which the owner of intellectual property or any user who posts, lists, or registers, same may have any reason or interest for being so notified. In this regard, the apparatus 100 of the present invention can be utilized to generate a notification message or an alert message, containing information regarding a newly posted, listed, or registered, provider, funding service or investor, agent or broker, official or governmental filing office, social network, or media service, information service, or news information service, or other user, who can provide any service, good, or product, which might be of interest to the owner of intellectual property or any user who posts, lists, or registers, same or who might be of any interest to the owner of intellectual property or any user who posts, lists, or registers, same for any reason or purpose. The apparatus 100 can thereafter transmit the notification message or the alert message to the user communication device 20 of or associated with the owner of intellectual property or any user who posts, lists, or registers, same.

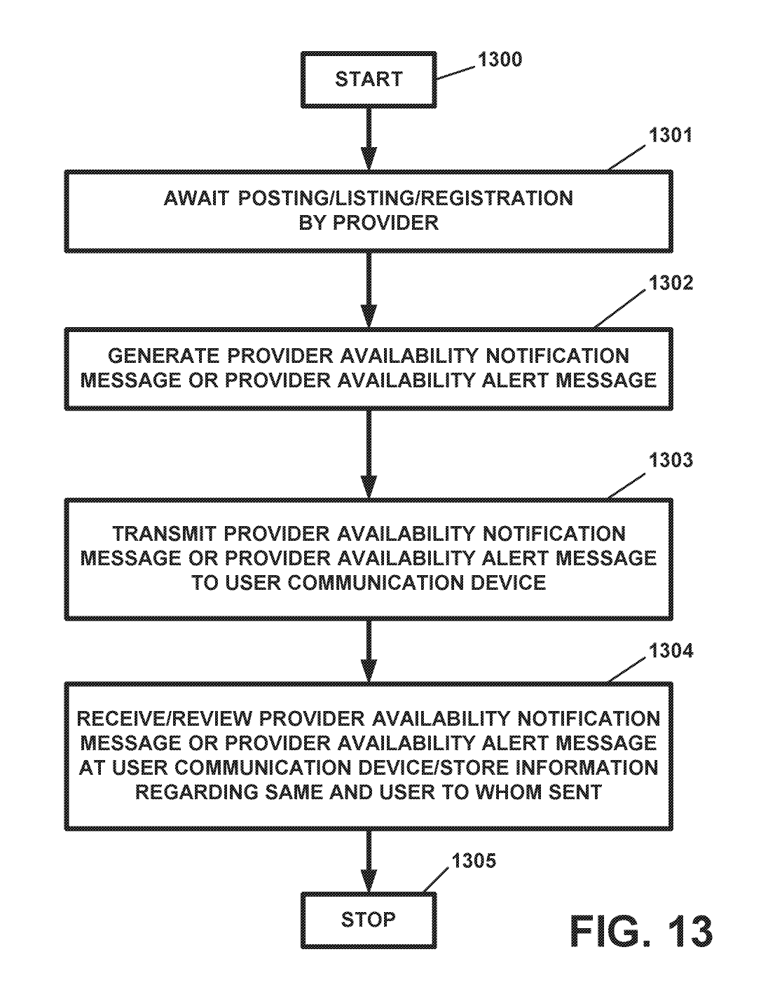

FIG. 13 illustrates another preferred embodiment method of utilizing the apparatus 100 of the present invention, in flow diagram form. While the embodiment of FIG. 13 is described herein as being used to provide a notification message or an alert message to a user, who or which is the owner of intellectual property or the user who posts, lists, or registers, same with the apparatus 100, the apparatus 100 of the present invention can also be utilized, in a same, a similar, or an analogous, manner, in order to provide a notification message or an alert message to any user, provider, funding service or investor, agent or broker, official or governmental filing office, social network, or media service, information service, or news information service, who or which utilizes the apparatus 100 and method of the present invention and who or which might be interested in any commercialization, development, marketing, sale, transfer, licensing, or monetization, of or involving the posted, listed, or registered, intellectual property or for any other reason or purpose.

In the embodiment of FIG. 13, any user owner or the intellectual property or the user who or which posts, lists, or registers, same with the central processing computer 10 can pre-register with the apparatus 100 and/or can set-up or establish with the central processing computer 10, or can program the central processing computer 10 with information regarding, any criteria for receiving a notification message or an alert message regarding any posting, listing, or registration, by any provider, funding service or investor, agent or broker, official or governmental filing office, social network, or media service, information service, or news information service, or by any other user, of or for which the posting, listing, or registering, owner or user desires to be notified. For, example, a user may desire to be notified if a certain provider who or which can perform a needed service for the user to develop or commercialize his, her, or its, invention, a user may desire to be notified if another user may be interested in purchasing his, her, or its, patent application or any foreign counterpart application or international counterpart application or in purchasing a license or other right in or to same, or a user may desire to be notified if an agent or a broker becomes available to represent the user. Any such pre-registration information can be stored in the database 10H of the central processing computer 10.

With reference or FIG. 13, the operation of the apparatus 100 commences at step 1300. At step 1301, the central processing computer will await a posting, listing, or registration, by any provider, funding service or investor, agent or broker, official or governmental filing office, social network, or media service, information service, or news information service, or by any other user. For example, in a preferred embodiment, the central processing computer 10 will await an occurrence of any provider, funding service or investor, agent or broker, official or governmental filing office, social network, or media service, information service, or news information service, or any other user, accessing same, and providing information regarding any service or services, or any types or kinds or services, which the provider, funding service or investor, agent or broker, official or governmental filing office, social network, or media service, information service, or news information service, or any other user, can offer to an owner of intellectual property or a user who or which posts, lists, or registers same, with the apparatus 100 or central processing computer 10, information regarding any goods or products which the provider, funding service or investor, agent or broker, official or governmental filing office, social network, or media service, information service, or news information service, or any other user, can offer to an owner of intellectual property or a user who or which posts, lists, or registers same, information regarding any funding services or capital raising services which any provider, funding service or investor, agent or broker, official or governmental filing office, social network, or media service, information service, or news information service, or any other user, can offer to an owner of intellectual property or a user who or which posts, lists, or registers same, information regarding any work schedules or work scheduling information for any provider, funding service or investor, agent or broker, official or governmental filing office, social network, or media service, information service, or news information service, or any other user, can offer to an owner of intellectual property or a user who or which posts, lists, or registers same, or any information regarding any fees charged or commissions charged by the provider, funding service or investor, agent or broker, official or governmental filing office, social network, or media service, information service, or news information service, or the other user, or any price lists, price listings, or other cost information for any services, goods, or products, offered by the provider, funding service or investor, agent or broker, official or governmental filing office, social network, or media service, information service, or news information service, or the other user.

In the preferred embodiment of FIG. 13, the provider, funding service or investor, agent or broker, official or governmental filing office, social network, or media service, information service, or news information service, or the other user, can be any provider of any service needed or desired for developing or for commercializing an invention covered in a patent application. Although a provider offered or provided service, needed or desired for developing or for commercializing an invention covered in a patent application, is used in the example of the preferred embodiment of FIG. 13, it is important to note that the embodiment of FIG. 13 can also be utilized in connection with any services, goods, or products, provided by or offered by any of the herein-described providers, funding services or investors, agents or brokers, official or governmental filing offices, social networks, or media services, information services, or news information services, or other users.

In a preferred embodiment, the central processing computer 10 and/or the CPU 10A can detect the occurrence of the posting, the listing, or the registration, of the provider's service or services by the provider. The central processing computer 10 can receive and process any information regarding the provider and the provider's offered or provided service or services, any fees, costs, or price(s) for same, any information regarding the provider's work schedule or scheduling information, and/or any other information provided by the provider in the posting, listing, or registration, made or performed by the provider.

Once the provider has entered and transmitted to the central processing computer 10 any and/or all information regarding the provider and the provider's service or services, and once the posting, listing, or registration, of same, is complete, the central processing computer 10 will detect same at step 1301.

At step 1302, the central processing computer 10 can generate a provider availability notification message or a provider availability alert message which can contain or include any of the herein-described information regarding the provider and the provider's offered or provided service or services and/or any other information provided by the provider when he, she, or it, posted, listed, or registered, same with the central processing computer 10. In a preferred embodiment, provider availability notification message or a provider availability alert message can also contain a link(s) or a hyperlink(s) to the provider, the provider's website, and/or contact information, or a link(s) or a hyperlink(s) to contact information, for contacting the provider who posted, listed, or registered, with the central processing computer 10. In the preferred embodiment, the contact information can be, or can include, but is not limited to, a domain name, a uniform resource locator (url), a telephone number, a cellular telephone number, an e-mail address, a text messaging number, an SMS messaging number, or any other contact information for or associated with the provider.

At step 1303, the central processing computer 10 can transmit the provider availability notification message or a provider availability alert message to the user communication device 20 of the user who or which desires to be notified of the posting, the listing, or the registration, of same. At step 1304, the user communication device 20 of the user, desiring to the notified of the posting, the listing, or the registration, by the provider can receive the provider availability notification message or a provider availability alert message. At step the 1304, the user receiving the provider availability notification message or a provider availability alert message can review the information contained therein and can decide whether or not to contact the provider identified therein in order to engage in any discussions regarding the engaging or hiring the provider to perform a service or services for the user and/or to discuss any opportunities regarding same. At step 1304, the central processing computer 10 can also store any information regarding any provider availability notification message(s) or a provider availability alert message(s), generated at step 1302 and transmitted by the central processing computer 10 at step 1303, and any information regarding the user to whom the provider availability notification message or a provider availability alert message was sent. Thereafter, the operation of the apparatus will cease at step 1305.

In another preferred embodiment, the apparatus 100 and method of the present invention can be utilized to provide a centralized entity or repository, or a clearinghouse, for storing and/or for providing information regarding intellectual property of any kind or type which is available, or which can be available for commercialization, development, marketing, sale, transfer, licensing, or monetization. In a preferred embodiment, any number of users of the apparatus 100 and method of the present invention can post, list, or register, his, her, or its, intellectual property or intellectual properties with the apparatus 100 of the present invention and/or the central processing computer 10 in order to commercialize, develop, market, sell, transfer, license, or monetize, same. In a preferred embodiment, any and/or all information regarding any of the posted, listed, or registered, intellectual properties, and/or any information regarding the user who posted, listed, or registered, same, can be stored by in the database 10H of the central processing computer 10 and can be searchable by any of the herein-described providers, funding services or investors, official or governmental filing offices, agents or brokers, social networking companies or entities or any members of any social networks, or media services or media sources, information services or information sources, or news services or news sources, or any other users.

In a preferred embodiment, a provider of a service of a provider of goods or products can, for example, search available intellectual property for purposes of offering its respective services, goods, or products, to an owner of an intellectual property or to a user who or which posted, listed, or registered, same, or to owners of intellectual properties or to users who or which posted, listed, or registered, same, to assist the respective owner or posting, listing, or registering, user in commercializing, developing, marketing, selling, transferring, licensing, or monetizing, same, or for any other purpose or purposes.

In a preferred embodiment, a funding service or an investor can, for example, search available intellectual property or intellectual properties for purposes of offering to provide funding for, or offering to raise capital for, or offering to invest in or with, any efforts to commercialize, develop, market, sell, transfer, license, or monetize, an intellectual property or intellectual properties posted, listed, or registered, with the central processing computer 10, or for any other purpose or purposes.

In a preferred embodiment, an official or governmental filing office can, for example, search available intellectual property or intellectual properties for purposes of offering to provide its services, goods, or products, to an owner of an intellectual property or to a user who or which posted, listed, or registered, same, or to owners of intellectual properties or to users who or which posted, listed, or registered, same, to assist the respective owner or posting, listing, or registering, user in protecting, commercializing, developing, marketing, selling, transferring, licensing, or monetizing, same, or for any other purpose or purposes.

In a preferred embodiment, an agent or a broker can, for example, search available intellectual property for purposes of offering its respective services, goods, or products, to an owner of an intellectual property or to a user who or which posted, listed, or registered, same, or to owners of intellectual properties or to users who or which posted, listed, or registered, same, to assist the respective owner or posting, listing, or registering, user in commercializing, developing, marketing, selling, transferring, licensing, or monetizing, same, for purposes of representing the owner or the user, or for any other purpose or purposes.

In a preferred embodiment, a social networking company or entity can, for example, search available intellectual property for purposes of offering its respective services, goods, or products, to an owner of an intellectual property or to a user who or which posted, listed, or registered, same, or to owners of intellectual properties or to users who or which posted, listed, or registered, same, for purposes of providing access to its social network or social networking members for purposes of assisting the respective owner or posting, listing, or registering, user in commercializing, developing, marketing, selling, transferring, licensing, or monetizing, same, for purposes of providing the owner or user with access to its social networking member, for purposes of providing information regarding any posted, listed, or registered, intellectual property or intellectual properties to its social networking members, or for any other purpose or purposes.

In a preferred embodiment, a media service or media source, information service or information source, news information service or news information source, can, for example, search available intellectual property for purposes of offering its respective services, goods, or products, to an owner of an intellectual property or to a user who or which posted, listed, or registered, same, or to owners of intellectual properties or to users who or which posted, listed, or registered, same, or for purposes or obtaining information regarding any intellectual property or intellectual properties, or for any other purpose or purposes.

In a preferred embodiment, any user of the apparatus 100 of the present invention, can, for example, perform a search of available intellectual property for purposes of offering to purchase same, offering to purchase foreign rights or international rights to any foreign counterpart or any international counterpart of same, for purposes of purchasing an intellectual property or a foreign counterpart or an international counterpart to same, for purchases of acquiring a license, an exclusive license, or a non-exclusive license, under an intellectual property or under any foreign counterpart or international counterpart to same, for purposes of acquiring a covenant not to sue or a release under an intellectual property or under any foreign counterpart or international counterpart to same, for purposes of purchasing a share in, or shares in, or an interest in, an intellectual property or in any foreign counterpart or international counterpart to same, or for any other purpose or purposes.

It is envisioned that any number of owners of intellectual property or intellectual properties, or any number of users who or which can post, list, or register, same, can post, list, or register, same with the central processing computer 10. In a preferred embodiment, the owner or user can include, in posting, listing, or registering, an intellectual property, can include information identifying the intellectual property, any foreign or international counterpart(s) of same, or any derivative rights in or to same, information regarding a description of what the intellectual property is or what it covers or protects, information regarding any inventor(s), applicant(s), owner(s), assignor(s), assignee(s) of the intellectual property or any foreign or international counterpart(s) of same, information regarding the field or the subject matter of the intellectual property, information regarding a market sector, a service sector, a goods sector, or a products sector, or field, or technological field, in which the intellectual property, or any services, goods, products, or entities, covered thereby or protected thereby to which the intellectual property pertains, information regarding what the owner of the intellectual property wants to do with same, including but not limited to, any interests or desires to commercialize, develop, market, sell, transfer, license, or monetize, the intellectual property, or any other information described herein as being provided by a user who or which posts, lists, or registers, any intellectual property with the central processing computer 10 as described in any of the other and herein-described embodiments, including, but not limited to, the embodiments of each of FIGS. 11, 12, 13, and 14. Any and/or all information provider by the owner or user, when posting, listing, or registering, an intellectual property can be transmitted to, received by, and stored by, the central processing computer 10 and/or can be stored in the database 10H.

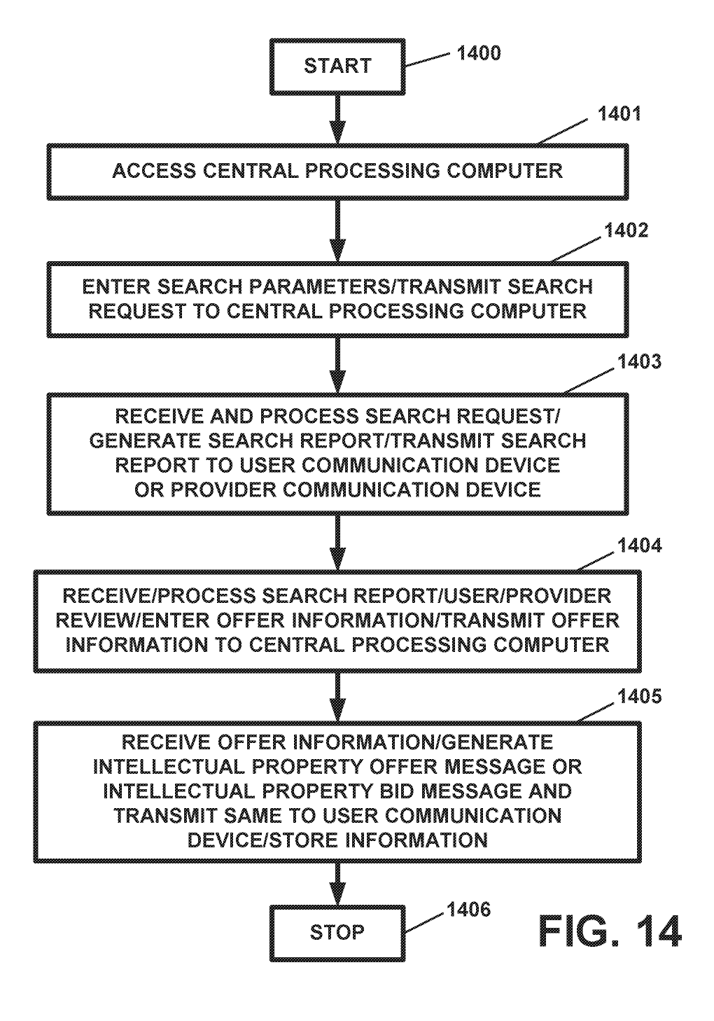

FIG. 14 illustrates another preferred embodiment method of utilizing the apparatus 100 of the present invention, in flow diagram form. While the embodiment of FIG. 14 is described and illustrated as being utilized by a user, or by a provider of a service, for any purpose or purposes, it is important to note that the embodiment of FIG. 14 can also be utilized in a same, a similar, or an analogous, manner, by any of the herein-described providers, funding services or investors, official or governmental filing offices, agents or brokers, social networking companies or entities or any members of any social networks, or media services or media sources, information services or information sources, or news services or news sources, or any other users.

With reference to FIG. 14, the operation of the apparatus 100 commences at step 1400. At step 1401, the user can access the central processing computer 10 using his, her, or its, user communication device 20 or the provider can access the central processing computer 10 using his, her, or its, provider communication device 30. At step 1402, the user or the provider can enter his, her, or its, search parameters, for searching for or to identify and/or to obtain information regarding any available intellectual property, into his, her, or its, respective user communication device 20 or provider communication device 30. At step 1402, the respective user communication device 20 or the provider communication device 30 can generate a search request, which can contain information regarding the search parameters, and the respective user communication device 20 or the provider communication device 30 can transmit the search request to the central processing computer 10.

In a preferred embodiment, a user can, for example, enter search parameters pertaining to identifying or locating intellectual property, or any specific kind or type, which is, or which may be, available for purchase by the user or for licensing by the user, or the user can enter any other search parameters pertaining to any interest or involvement the user may desire to have in any commercialization, development, marketing, sale, transfer, licensing, or monetization, of any type or kind of specified or unspecified intellectual property. In a preferred embodiment, a provider can, for example, enter search parameters pertaining to identifying or locating intellectual property, or any specific kind or type, which is, or which may be, available for commercialization, development, marketing, sale, transfer, licensing, or monetization, of any type or kind of specified or unspecified intellectual property which might involve a service or services provided by, or which can be provided or performed by, the provider, or which might involve any goods or products provided by, or which can be provided or performed by, the provider, or the provider can enter any other search parameters pertaining to any interest or involvement the provider may desire to have in any commercialization, development, marketing, sale, transfer, licensing, or monetization, of any type or kind of specified or unspecified intellectual property.

At step 1403, the central processing computer 10 can receive and process the search request, identify an intellectual property or any number of intellectual properties which are responsive to the search request and/or which are responsive to the search parameters, and can generate a search report. In a preferred embodiment, the search report can contain or include any information, or any link(s) or hyperlink(s) to any information which is responsive to the search request or responsive to any search parameters. At step 1403, the central processing computer 10 can transmit the search report to the respective user communication device 20 of the user or to the provider communication device 30 of the provider.

At step 1404, the respective user communication device 20 or provider communication device 30 can receive the search report and/or process any information contained therein and/or can provide same and/or any information contained therein to the respective user or provider. At step 1404, the user or the provider can review the information contained in the search report. At step 1404, the respective user can enter information pertaining to or regarding an offer to purchase the intellectual property, can enter information pertaining to or regarding an offer to purchase a foreign counterpart or an international counterpart to the intellectual property, can enter information pertaining to or regarding an offer to purchase a derivative right in or under the intellectual property, can enter information pertaining to or regarding an offer to purchase a license, an exclusive license, or non-exclusive license, or a defined field license, in or under the intellectual property or a foreign counterpart or an international counterpart of same, can enter information pertaining to or regarding an offer to purchase a covenant not to sue or a release under the intellectual property or a foreign counterpart or an international counterpart of same, or a derivative right in same, or can enter information regarding a bid by the offer to purchase any of the above rights or interests, or can enter information regarding an offer or a bid to purchase a share of or an interest in and to the intellectual property, any foreign counterpart or an international counterpart same, or derivative right in same, of can enter information regarding an offer to partner with the owner of the intellectual property in commercializing, developing, marketing, selling, transferring, licensing, or monetizing, the intellectual property.

At step 1404, the respective provider can enter information pertaining to or regarding an offer or a bid to provide any service or services, or any goods or any products, needed or desired in commercializing, developing, marketing, selling, transferring, licensing, or monetizing, the intellectual property, or a foreign counterpart or an international counterpart of same, or a derivative right in same.

At step 1404, the provider can also offer to sell a subscription for his, her, or its, services, or goods or products, which subscription can include, involve, or represent, the provider's obligation to perform a number of services, a number the same service, a number of different services, with each obligated performance of a service being represented by a transferable coupon, or which subscription can include, involve, or represent, the provider's obligation to provide a number of the same goods or products, or a number of different goods or products, with each obligation to provide any goods or products being represented by a transferable coupon. For example, a provider who provides software development services can sell an owner of the intellectual property, or the user who or which post, lists, or registers, same, a subscription obligating the provider to perform a number such as, for example, ten (10) software programming projects, with each project being represented by a coupon. The coupons obtained from the provider can thereafter be resold by the owner of the intellectual property, or the user who or which post, lists, or registers, same, to another owner of intellectual property, or another user who or which post, lists, or registers, intellectual property. The coupons can also be bartered or traded for other coupons issued by other providers for other service, goods, or products.

At step 1404, the respective user or provider can enter any of the herein-described information, or any other information, for or regarding any intellectual property or any number of intellectual properties any offer relating to same or regarding same. At step 1405, the information entered by the respective user or provider can be transmitted from the respective user communication device 20 or provider communication device 30 to the central processing computer 10 and can be received by the central processing computer 10. At step 1405, the central processing computer 10 will, for each intellectual property for which the user or provider entered information, generate an intellectual property offer message or an intellectual property bid message, whichever the case may be, and will transmit the respective an intellectual property offer message or an intellectual property bid message to the user communication device 20 of or associated with the owner of the intellectual property or the user who or which posted, listed, or registered, same with the central processing computer 10.

In a preferred embodiment, any intellectual property offer message or an intellectual property bid message can contain contact information for the respective user or provider making the offer or the bid. At step 1405, the user communication device 20 of or associated with the owner of the intellectual property or the user who or which posted, listed, or registered, same, can receive the respective intellectual property offer message or the intellectual property bid message and decide whether or not to respond to same, accept any offer or bid, reject any offer or bid, can purchase any subscriptions and/or associated coupons for any services, goods, or products, offered by any providers, can contact the respective user or provider to discuss or explore any opportunities with the respective user or provider, or can enter into any other discussions or negotiations with the with the respective user or provider.

The central processing computer 10 can also, at step 1405, store any information regarding any of the user's or provider's search parameters, any search reports generated by the central processing computer 10, any intellectual property offer message(s) or intellectual property bid message(s) generated and/or transmitted to the owner of the intellectual property or the user who or which posted, listed, or registered, same, and/or any information regarding any ensuing discussions or activities, or any sale or purchase of any intellectual property, or a foreign counterpart or an international counterpart of same, or a derivative right in same, or any sale of any of the herein-described subscriptions offered by any provider, which may have occurred or which may have taken place between the owner of the intellectual property or the user who or which posted, listed, or registered, same, and any respective user(s) or providers(s), or the central processing computer 10 can store any other data and/or information regarding the user's or the provider's use of the apparatus 100. In a preferred embodiment, any owner of the intellectual property or any user who or which posted, listed, or registered, same, or any respective user(s) or providers(s) can enter and transmit the central processing computer 10 any notes or comments regarding any interactions with the other party.

At step 1405, in a situation in which an owner of, or a user who or which posts, lists, or registers, an intellectual property desires to sell, to sell a share or interest, or to sell a license, in or to same, or in or to a foreign counterpart or an international counterpart of same, or in or to a derivative right in same, the central processing computer 10 can process information regarding an associated or resulting, or other, transaction. At step 1405, in a situation in which an owner of, or a user who or which posts, lists, or registers, an intellectual property desires to hire or engage a provider to perform a service or services, or to provide goods or products, the central processing computer 10 can process information regarding any associated or resulting, or other, transaction. Thereafter, the operation of the apparatus 100 will cease at step 1406.

In this regard, in a preferred embodiment, the apparatus 100 of the present invention can also be utilized in order to process information regarding a commercialization of, a development of, a marketing of, a sale of, a transfer of, a licensing of, or a monetization of, any intellectual property, or any investment in such activity for or regarding any intellectual property. In a preferred embodiment, the apparatus 100 of the present invention can also be utilized in order allow an owner of intellectual property, or a user who or which posts, lists, or registers, same, to sell, transfer, or license, any domestic rights or foreign rights, or any derivative rights, in or to his, her, or its, intellectual property, or to sell shares or interests in intellectual property, or to sell shares or interests in any activity, effort, or entity, for or regarding the commercialization of, the development of, the marketing of, the sale of, the transfer of, the licensing of, or the monetization of, his, her, or its, intellectual property.

It is important to note that the embodiment of FIG. 14 can also be utilized in a same, a similar, and/or in an analogous, manner by any providers, funding services or investors, official or governmental filing offices, agents or brokers, social networking companies or entities or any members of any social networks, or media services or media sources, information services or information sources, or news services or news sources, or any users, in order to search for or identify or locate, intellectual property for which they can offer services, or goods, or products, for the commercialization, development, marketing, sale, transfer, licensing, and/or monetization, of same, or which can provide any providers, funding services or investors, official or governmental filing offices, agents or brokers, social networking companies or entities or any members of any social networks, or media services or media sources, information services or information sources, or news services or news sources, or other users, with information pertaining to their own activities and/or operations.

In another preferred embodiment, the apparatus 100 and method of the present invention can be utilized to provide a centralized entity or repository, or a clearinghouse, for storing and/or for providing information regarding any of the herein-described providers, funding services or investors, official or governmental filing offices, agents or brokers, social networking companies or entities or any members of any social networks, or media services or media sources, information services or information sources, or news services or news sources, or any other users, and any of the respective services, goods, or products, which are or can be provided by each of same.

The apparatus 100 and method of the present invention can also provide any information regarding the type or kinds of the respective services, goods, or products, which are or can be provided by each of same, or any information regarding the work schedule(s) or scheduling information for or regarding any provider(s), funding service(s) or investor(s), official or governmental filing office(s), agent(s) or broker(s), social networking company or companies or entity or entities or any member or members of any social networks, or media service(s) or media source(s), information service(s) or information source(s), or news service(s) or news source(s), or any other user(s), or any information regarding instructions for engaging, contracting or otherwise doing business with, or hiring, any provider(s), funding service(s) or investor(s), official or governmental filing office(s), agent(s) or broker(s), social networking company or companies or entity or entities or any member or members of any social networks, or media service(s) or media source(s), information service(s) or information source(s), or news service(s) or news source(s), or any other user(s), or any information regarding any subscriptions offered by any provider(s), funding service(s) or investor(s), official or governmental filing office(s), agent(s) or broker(s), social networking company or companies or entity or entities or any member or members of any social networks, or media service(s) or media source(s), information service(s) or information source(s), or news service(s) or news source(s), or any other user(s), or any information regarding a coupons, which can transferable or nontransferable, for any services, goods, or products, offered by any provider(s), funding service(s) or investor(s), official or governmental filing office(s), agent(s) or broker(s), social networking company or companies or entity or entities or any member or members of any social networks, or media service(s) or media source(s), information service(s) or information source(s), or news service(s) or news source(s), or any other user(s), which coupons be stand alone coupons or coupons associated with, or part of, any subscription.

In a preferred embodiment, any number of the herein-described providers, funding services or investors, official or governmental filing offices, agents or brokers, social networking companies or entities or any members of any social networks, or media services or media sources, information services or information sources, or news services or news sources, or any other users, can post, list, or register, himself, herself, or itself, any of the respective services, goods, or products, it provides or can provide with the apparatus 100 of the present invention and/or the central processing computer 10 in order to provide services, goods, or products, which can be utilized by an owner of intellectual property or by any user who or which posts, lists, or registers, same with the central processing computer 10 in commercializing, developing, marketing, selling, transferring, licensing, and/or monetizing, his, her, or its, intellectual property.

In a preferred embodiment, any and/or all information regarding any of the posted, listed, or registered, providers, funding services or investors, official or governmental filing offices, agents or brokers, social networking companies or entities or any members of any social networks, or media services or media sources, information services or information sources, or news services or news sources, or any other users, and/or their respective services, goods, or products, can be stored by in the database 10H of the central processing computer 10 and can be searchable by any of the herein-described users who or which are owners of an intellectual property or who or which posts, lists, or registers, an intellectual property with the central processing computer 10.

In a preferred embodiment, a user who or which is an owner of an intellectual property or who or which posts, lists, or registers, same with the central processing computer 10 can, for example, search available providers, funding services or investors, official or governmental filing offices, agents or brokers, social networking companies or entities or any members of any social networks, or media services or media sources, information services or information sources, or news services or news sources, or any other users, and/or their respective services, goods, or products, for purposes of gaining access to, obtaining, or securing, the respective services, goods, or products, of one or more of the respective providers, funding services or investors, official or governmental filing offices, agents or brokers, social networking company or companies or entity or entities or any member or members of any social network or social networks, or media services or media sources, information services or information sources, or news services or news sources, or any other users, for purposes of commercializing, developing, marketing, selling, transferring, licensing, or monetizing, his, her, or its, intellectual property or for any other purpose or purposes.

In a preferred embodiment, a user who or which is an owner of intellectual property or who or which posts, lists, or registers, same with the central processing computer 10 can, for example, search available providers, funding services or investors, official or governmental filing offices, agents or brokers, social networking company or companies or entity or entities or any member or members of any social network or social networks, or media services or media sources, information services or information sources, or news services or news sources, or any other users, and/or any of the respective services, goods, or products, offered or provided by same for purposes of gaining access to, obtaining, or securing, the respective services, goods, or products, of one or more of the respective providers, funding services or investors, official or governmental filing offices, agents or brokers, social networking company or companies or entity or entities or any member or members of any social network or social networks, or media services or media sources, information services or information sources, or news services or news sources, or any other users, for purposes of commercializing, developing, marketing, selling, transferring, licensing, or monetizing, his, her, or its, intellectual property or for any other purpose or purposes.

In a preferred embodiment, a provider of a service of a provider of goods or products can, for example, post, list, or register, information, or a link(s) or hyperlink(s) to information, regarding, describing, pertaining to, or relating to, its services, goods, or products, or any subscriptions for same or relating to same, or any information sessions or any broadcasts, seminars, or any other activities or events, or any schedule(s) or scheduling information for or regarding same, offered by the provider, or any provider work schedule(s) or scheduling information, which can be searchable by, and which can be utilized by, an owner of an intellectual property or by a user who or which posted, listed, or registered, same, in order to assist the respective owner or posting, listing, or registering, user in gaining access to, obtaining, or securing, the respective services, goods, or products, of one or more providers for purposes of commercializing, developing, marketing, selling, transferring, licensing, or monetizing, his, her, or its, intellectual property, or for any other purpose or purposes.

In a preferred embodiment, a funding service or an investor can, for example, post, list, or register, information, or a link(s) or hyperlink(s) to information, regarding, describing, pertaining to, or relating to, its services, funding services, information regarding his, her, or its, investing criteria, and any other information, and/or any services, goods, or products, or any subscriptions for same or relating to same, or any information sessions or any broadcasts, seminars, or any other activities or events, or any schedule(s) or scheduling information for or regarding same, offered by the funding service or the investor, or any work schedule(s) or scheduling information for or regarding same, which can be searchable by, and which can be utilized by, an owner of an intellectual property or by a user who or which posted, listed, or registered, same, in order to assist the respective owner or the posting, listing, or registering, user in gaining access to, obtaining, or securing, funding, capital, or an investment, or any other services, goods, or products, of one or more funding services or investors for purposes of commercializing, developing, marketing, selling, transferring, licensing, or monetizing, his, her, or its, intellectual property, or for any other purpose or purposes.

In a preferred embodiment, an official or governmental filing office can, for example, post, list, or register, information, or a link(s) or hyperlink(s) to information, regarding, describing, pertaining to, or relating to, its services, goods, or products, or any information sessions or any broadcasts, seminars, or any other activities or events, or any schedule(s) or scheduling information for or regarding same, or any subscriptions for same or relating to same, which can be searchable by, and which can be utilized by, an owner of an intellectual property or by a user who or which posted, listed, or registered, same, in order to assist the respective owner or posting, listing, or registering, user in gaining access to, obtaining, or securing, the respective services, goods, or products, of one or more official or governmental filing offices for purposes of protecting, commercializing, developing, marketing, selling, transferring, licensing, or monetizing, his, her, or its, intellectual property, or for any other purpose or purposes.

In a preferred embodiment, an agent or a broker can, for example, post, list, or register, information, or a link(s) or hyperlink(s) to information, regarding, describing, pertaining to, or relating to, its representation services or offerings, services, goods, or products, or any work schedule(s) or scheduling information, or any subscriptions for same or relating to same, which can be searchable by, and which can be utilized by, an owner of an intellectual property or by a user who or which posted, listed, or registered, same, in order to assist the respective owner or posting, listing, or registering, user in gaining access to, obtaining, or securing, the respective services, goods, or products, of one or more agents or brokers for purposes of commercializing, developing, marketing, selling, transferring, licensing, or monetizing, his, her, or its, intellectual property, or for any other purpose or purposes.

In a preferred embodiment, a social networking company or entity can, for example, post, list, or register, information, or a link(s) or hyperlink(s) to information, regarding, describing, pertaining to, or relating to, its services, goods, or products, and/or its social networks and/or social networking groups and/or subgroups, or networking groups, and/or its information sessions, classes, or seminars, or group chat rooms, group chat room events or activities, social networking forums, seminars, or webinars, and/or any other activities or events, or any schedules or scheduling information for same or regarding same, or any subscriptions for same or relating to same, pertaining to, relating, or regarding, any types or kinds or topics or networking activities pertaining to, relating, or regarding, commercializing, developing, marketing, selling, transferring, licensing, or monetizing, intellectual property of any type or kind, or for any other purpose or purposes.

In a preferred embodiment, a media service or media source, information service or information source, news information service or news information source, can, for example, post, list, or register, information, or a link(s) or hyperlink(s) to information, regarding, describing, pertaining to, or relating to, its services, goods, or products, or any broadcasts or shows, or any schedules or scheduling information for same or regarding same, or any subscriptions for same or relating to same, pertaining to, relating, or regarding, any media, information, or news, business news, financial news, legal news, intellectual property news, current events, world news or current events, national news or current events, local news or current events, or any other information which may be useful or helpful to any owner or posting, listing, or registering, user, pertaining to, relating, or regarding, commercializing, developing, marketing, selling, transferring, licensing, or monetizing, intellectual property of any type or kind, or for any other purpose or purposes.

In a preferred embodiment, any owner or intellectual property, any posting, listing, or registering user, or any other user, of the apparatus 100 of the present invention, can, for example, perform a search of available providers, funding services or investors, official or governmental filing offices, agents or brokers, social networking company or companies or entity or entities or any member or members of any social network or social networks, or media services or media sources, information services or information sources, or news services or news sources, or any other users, and/or any of the respective services, goods, or products, or other offerings, offered or provided by same, in order to obtain information regarding, or to gain access to, or to engage the services of, or to hire or to enter into a contract or other working relationship with, to purchase services, goods, or products, from, or to otherwise obtain information or assistance of any type or kind from, any of the herein-described providers, funding services or investors, official or governmental filing offices, agents or brokers, social networking company or companies or entity or entities or any member or members of any social network or social networks, or media services or media sources, information services or information sources, or news services or news sources, or any other users, for purposes or commercializing, developing, marketing, selling, transferring, licensing, or monetizing, his, her, or its, intellectual property or for any other purpose or purposes.

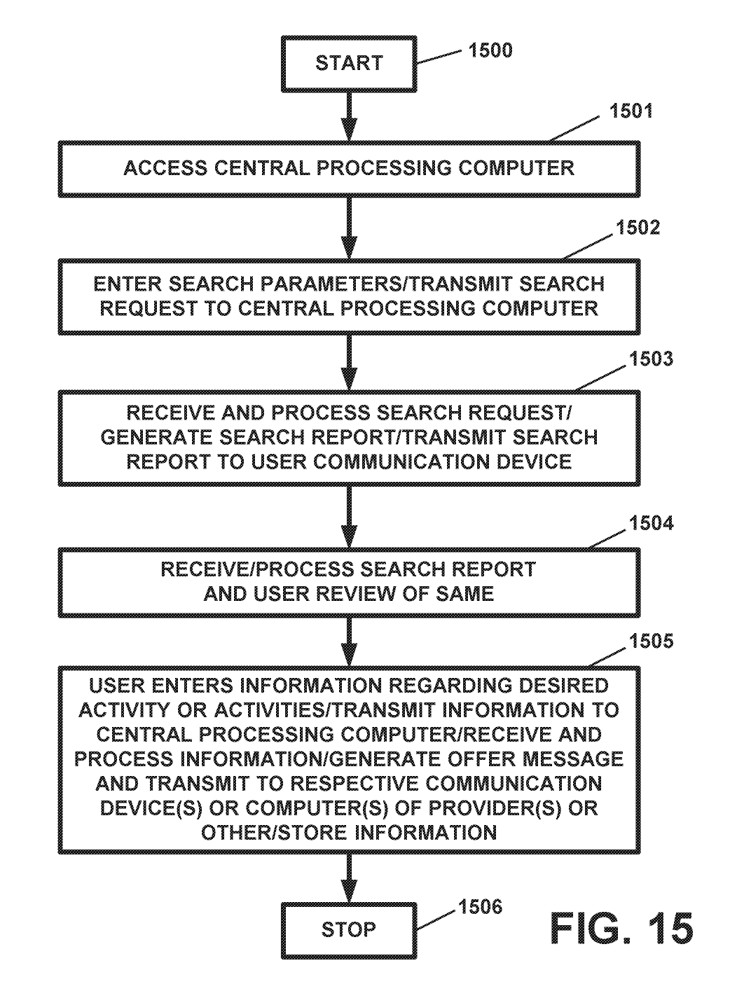

FIG. 15 illustrates another preferred embodiment method of utilizing the apparatus 100 of the present invention, in flow diagram form. While the embodiment of FIG. 15 is described and illustrated as being utilized by an owner of intellectual property or a posting, listing, or registering, user of same, for any purpose or purposes, it is important to note that the embodiment of FIG. 15 can also be utilized in a same, a similar, or an analogous, manner, by any of the herein-described providers, funding services or investors, official or governmental filing offices, agents or brokers, social networking companies or entities or any members of any social networks, or media services or media sources, information services or information sources, or news services or news sources, or any other users.

With reference to FIG. 15, the operation of the apparatus 100 commences at step 1500. At step 1501, the user can access the central processing computer 10 using his, her, or its, user communication device 20. At step 1502, the user can enter his, her, or its, search parameters, for searching to identify and/or to obtain information regarding any provider(s), funding service(s) or investor(s), official or governmental filing office(s), agent(s) or broker(s), social networking company or companies or entity or entities or any members of any social network(s), or media service(s) or media source(s), information service(s) or information source(s), or news service(s) or news source(s), or any other user(s), and/or its or their respective services, goods, or products, or other offerings, and/or any subscriptions regarding same in the user communication device 20. At step 1502, the user communication device 20 can generate a search request, which can contain information regarding the search parameters, and the user communication device 20 can transmit to search request to the central processing computer 10.

In a preferred embodiment, a user can, for example, enter search parameters pertaining to or for identifying or for locating a provider or providers who can provide the user with a service(s) needed or desired for commercializing, developing, marketing, selling, transferring, licensing, or monetizing, his, her, or its, intellectual property or for any other purpose or purposes, or the user can enter search parameters pertaining to or for identifying or for locating a funding service(s) or an investor(s) who or which might be interested in providing any needed or desired funding for or any needed or desired investment for commercializing, developing, marketing, selling, transferring, licensing, or monetizing, his, her, or its, intellectual property or for any other purpose or purposes, or the user can enter search parameters pertaining to or for identifying or for locating an official or governmental filing office(s) which can provide any needed or desired services, products, or goods, regarding protecting, commercializing, developing, marketing, selling, transferring, licensing, or monetizing, his, her, or its, intellectual property or for any other purpose or purposes, or the user can enter search parameters pertaining to or for identifying or for locating an agent(s) or a broker(s) who or which can provide any needed or desired representation or other services, goods, or products, for or regarding commercializing, developing, marketing, selling, transferring, licensing, or monetizing, his, her, or its, intellectual property or for any other purpose or purposes, or the user can enter search parameters pertaining to or for identifying or for locating a social network(s) or social networking members who or which can provide the user with any needed or information, advise, or a network or individuals, or any other needed or desired services, goods, products, for or regarding commercializing, developing, marketing, selling, transferring, licensing, or monetizing, his, her, or its, intellectual property or for any other purpose or purposes, or the user can enter search parameters pertaining to or for identifying or for locating a media service(s) or media source(s), or information service(s) or information source(s), or news service(s) or news source(s), which or who can provide the user with any needed or information, or any other services, goods, or products, needed or desired for or regarding commercializing, developing, marketing, selling, transferring, licensing, or monetizing, his, her, or its, intellectual property or for any other purpose or purposes, or the user can enter search parameters pertaining to or for identifying or for locating any other user who or which can provide the user with any needed or desired services, goods, or products, for or regarding commercializing, developing, marketing, selling, transferring, licensing, or monetizing, his, her, or its, intellectual property or for any other purpose or purposes. At step 1502, the user an also enter any search parameters for or regarding any coupon(s) for any services, goods, or products, offered by or provided by any provider(s), funding service(s) or investor(s), official or governmental filing office(s), agent(s) or broker(s), social networking company or companies or entity or entities or any members of any social network(s), or media service(s) or media source(s), information service(s) or information source(s), or news service(s) or news source(s), or by any other user(s), which coupon(s) are available for sale or for re-sale.

At step 1502, any search parameters can be transmitted, in a search request, to the central processing computer 10. At step 1503, the central processing computer 10 can receive and process the search request, identify any provider(s), funding service(s) or investor(s), official or governmental filing office(s), agent(s) or broker(s), social networking company or companies or entity or entities or any members of any social network(s), or media service(s) or media source(s), information service(s) or information source(s), or news service(s) or news source(s), or any other user(s), which are responsive to the search request and/or which are responsive to the search parameters, and can generate a search report. At step 1503, the central processing computer 10 can transmit the search report to the user communication device 20 of the user. At step 1503, the central processing computer 10 can also identify any of the herein-described coupon(s) which are available for sale or for resale. In a preferred embodiment, the search report can contain or include any information, or any link(s) or hyperlink(s) to any information which is responsive to the search request or responsive to any search parameters.

At step 1504, the user communication device 20 can receive the search report and/or process any information contained therein and/or can provide same, or any information contained therein, to the user. At step 1504, the user can review the information contained in the search report regarding any provider(s), funding service(s) or investor(s), official or governmental filing office(s), agent(s) or broker(s), social networking company or companies or entity or entities or any members of any social network(s), or media service(s) or media source(s), information service(s) or information source(s), or news service(s) or news source(s), or any other user(s), and/or any of their respective offerings, or their respective services, goods, or products, offerings or any other offerings.

At step 1505, the user can, for each provider, funding service or investor, official or governmental filing office, agent or broker, social networking company or entity or any members of any social network, or media service or media source, information service or information source, or news service or news source, or other user, utilize the user communication device 20 in order to enter information in order to contact the provider, the funding service or the investor, the official or governmental filing office, the agent or the broker, the social networking company or entity or any members of any social network, or the media service or the media source, the information service or the information source, or the news information service or the news information source, in order to discuss engaging the services of, or purchasing any service(s), goods, or products, or any other offerings, provided by the respective provider, funding service or investor, official or governmental filing office, agent or broker, social networking company or entity or any members of any social network, or media service or media source, information service or information source, or news service or news source, or other user, or in order to request to hire, or engage the services, of a respective provider, funding service or investor, official or governmental filing office, agent or broker, social networking company or entity or any members of any social network, or media service or media source, information service or information source, or news service or news source, or other user, or in order to hire, or engage, or reserve, the services, of a respective provider, funding service or investor, official or governmental filing office, agent or broker, social networking company or entity or any members of any social network, or media service or media source, information service or information source, or news service or news source, or other user, from, via, or using information contained in the work schedule(s) or scheduling information of same, the work schedule(s) or scheduling information of the respective provider, funding service or investor, official or governmental filing office, agent or broker, social networking company or entity or any members of any social network, or media service or media source, information service or information source, or news service or news source, or other user, or in order to purchase, place an order to purchase, or bid on or for, any service(s), goods, or products, from or offered or provided by a respective provider, funding service or investor, official or governmental filing office, agent or broker, social networking company or entity or any members of any social network, or media service or media source, information service or information source, or news service or news source, or other user, or in order to purchase a subscription for, or to subscribe to, any service(s), goods, or products, from a respective provider, funding service or investor, official or governmental filing office, agent or broker, social networking company or entity or any members of any social network, or media service or media source, information service or information source, or news service or news source, or other user, or in order to join or participate in, or engage in, any social networking activity identified as being provided by a social networking company, or in order to purchase any coupon(s) for any services, goods, or products, from a respective provider, funding service or investor, official or governmental filing office, agent or broker, social networking company or entity or any members of any social network, or media service or media source, information service or information source, or news service or news source, or other user, or in order to perform any other activity or to take any other action for or regarding commercializing, developing, marketing, selling, transferring, licensing, or monetizing, his, her, or its, intellectual property or for any other purpose or purposes.

At step 1505, the user can engage in any activity or activities or take any action using any of the information, or any link(s) or hyperlink(s) to any information provided in the search report with any of the providers, funding services or investors, official or governmental filing offices, agents or brokers, social networking company or companies or entity or entities or any members of any social network(s), or media services or media sources, information services or information sources, or news services or news sources, or other users, identified in the search report. At step 1505, any information entered by the user can be transmitted from the user communication device 20 to the central processing computer 10 and can be received by the central processing computer 10.

In a preferred embodiment, at step 1505, the central processing computer 10 can generate an offer message for each provider, funding service or investor, official or governmental filing office, agent or broker, social networking company or entity or any members of any social network, or media service or media source, information service or information source, or news service or news source, or other user, for whom or for which the user enters information for contacting same in order to discuss engaging the services of same, or for purchasing any service(s), goods, or products, or any other offerings, from same, or in order to request to hire, or engage the services of, same, or in order to hire, engage, or reserve, the services, of a respective provider, funding service or investor, official or governmental filing office, agent or broker, social networking company or entity or any members of any social network, or media service or media source, information service or information source, or news service or news source, or other user, from, via, or using, information contained in the work schedule(s) or scheduling information of same, or in order to purchase, place an order to purchase, or bid on or for, any service(s), goods, or products, from or offered or provided by same, or in order to purchase a subscription for, or to subscribe to, any service(s), goods, or products, from same, or in order to join or participate in, or engage in, any social networking activity, or in order to purchase any coupon(s) for any services, goods, or products, from a respective provider, funding service or investor, official or governmental filing office, agent or broker, social networking company or entity or any members of any social network, or media service or media source, information service or information source, or news service or news source, or other user. At step 1505, the central processing computer 10 can transmit each generated offer message to the respective communication device or computer 30, 40, 50, 60, 70, 80, or 20, of the respective provider, funding service or investor, official or governmental filing office, agent or broker, social networking company or entity or any members of any social network, or media service or media source, information service or information source, or news service or news source, or other user. In a preferred embodiment, any offer message can also contain contact information for the user making the offer.

At step 1505, the respective communication device or computer 30, 40, 50, 60, 70, 80, or 20, of the respective provider, funding service or investor, official or governmental filing office, agent or broker, social networking company or entity or any members of any social network, or media service or media source, information service or information source, or news service or news source, or other user, can receive the respective offer message and decide whether or not to respond to same, accept any offer or bid, reject any offer or bid, sell any subscriptions and/or associated coupons for any services, goods, or products, can contact the user to discuss or explore any opportunities with the user, or can enter into any other discussions or negotiations with the user.

The central processing computer 10 can also, at step 1505, store any information regarding any of the user's search parameters, any search reports generated by the central processing computer 10, any actions taken by the user or any activities engaged in by the user, any of the user's offer messages, any actions taken by, or any activities engaged in by, any of the providers, funding services or investors, official or governmental filing offices, agents or brokers, social networking company or companies or entity or entities or any members of any social network(s), or media services or media sources, information services or information sources, or news services or news sources, or other users, to whom or to which an offer message was transmitted, and/or any information regarding any associated or resulting, or other, transaction regarding or resulting from the offer message, or any other data and/or information regarding the user's use of the apparatus 100.

In a preferred embodiment, any provider, funding service or investor, official or governmental filing office, agent or broker, social networking company or entity or any members of any social network, or media service or media source, information service or information source, or news service or news source, or other user, who or which is posted, listed, or registered, with the apparatus 100 can enter and transmit to the central processing computer 10 any notes or comments regarding any interactions with the user.

At step 1505, central processing computer 10 can also process any information regarding an associated or resulting, or other, transaction between the user and any provider, funding service or investor, official or governmental filing office, agent or broker, social networking company or entity or any members of any social network, or media service or media source, information service or information source, or news service or news source, or other user, and store any information regarding same. Thereafter, the operation of the apparatus 100 will cease at step 1506.

In another preferred embodiment, the apparatus 100 and/or the central processing computer 10 can receive, such as with receiver 10G, information regarding an intellectual property. In a preferred embodiment, the information regarding the intellectual property can include at least an identifier for the intellectual property, which can signify that the intellectual property has been previously filed with an intellectual property examining entity or an official filing office, and information regarding a goal or an objective for commercializing or monetizing the intellectual property.

The apparatus and/or the central processing computer 10 can process, such as with CPU 10A, the information regarding the intellectual property. In a preferred embodiment, the apparatus 100, the central processing computer 10, or the CPU 10A, can be specially programmed to process the information regarding the intellectual property, specially programmed to create a posting, a listing, or a registration, of, for, or associated with, the intellectual property, and specially programmed to generate a profile for the intellectual property. In a preferred embodiment, the apparatus 100, the central processing computer 10, or the CPU 10A, can generate or create the posting, the listing, or the registration for the intellectual property, and can also generate the profile for the intellectual property as well as a report containing information regarding the intellectual property.

In a preferred embodiment, the apparatus 100, the central processing computer 10, or the CPU 10A, can process information for identifying a provider of a service, services, goods, or products, or for identifying a funding service or an investor, based on the goal or the objective for commercializing or monetizing the intellectual property, using information regarding the goal or the objective for commercializing or monetizing the intellectual property which can be previously stored in the database 10H. In another preferred embodiment, the apparatus 100 the central processing computer 10, or the transmitter 10F can transmit the report to any one or more of the user communication device 20 of a user, a provider communication device 30 of a provider, and/or a funding service communication device 40 of an investor or funding entity.

In another preferred embodiment, the apparatus 100 and/or the central processing computer 10 can receive, such as with receiver 10G, information regarding a provider of a service, services, goods, or products, or information regarding an investor or a funding entity. In a preferred embodiment, the information regarding the provider can include at least information regarding qualifications or credentials of the provider and desired projects or jobs sought by the provider, in order to assist an owner of intellectual property to commercialize or monetize the intellectual property. In a preferred embodiment, the information regarding the investor or the funding entity can include information regarding investment criteria, services provided, and/or information regarding projects or intellectual property opportunities in or for which the investor or funding entity is interested in investing.

The apparatus and/or the central processing computer 10 can process, such as with CPU 10A, the information regarding the provider or the investor or funding entity. In a preferred embodiment, the apparatus 100, the central processing computer 10, or the CPU 10A, can be specially programmed to generate a posting or a listing of or for the provider or the investor or funding entity and can be specially programmed to generate a profile for the provider or the investor or funding entity. In a preferred embodiment, the apparatus 100, the central processing computer 10, or the CPU 10A, can generate or create the posting, the listing, or the registration, of, for, or associated with, the provider or the investor or the funding entity, and can also generate the profile for the provider or the investor or the funding entity as well as a report containing information regarding the provider or the investor or the funding entity.

In a preferred embodiment, the apparatus 100, the central processing computer 10, or the CPU 10A, can process information for identifying the owner of intellectual property based on the qualifications or credentials of the provider, or based on the qualifications, credentials, or investment criteria, of the investor or funding entity, and for identifying desired projects or jobs sought by the provider, to assist an owner of intellectual property to commercialize or monetize the intellectual property, or for identifying investment opportunities for the investor or funding entity, for assisting the intellectual property owner in commercializing or monetizing the intellectual property. In another preferred embodiment, the apparatus 100 the central processing computer 10, or the transmitter 10F can transmit the report to any one or more of the user communication device 20 of the intellectual property owner, a provider communication device 30 of a provider, and/or a funding service communication device 40 of an investor or funding entity.

In any and/or all of the embodiments described herein, any of the information, messages, reports, profiles, intellectual property profiles, provider reports, funding service/investor reports, agent/broker reports, intellectual property reports, intellectual property report messages, provider profiles, intellectual property user reports, provider reports, intellectual property user report messages, notification messages, alert messages, intellectual property (“IP”) notification messages, IP alert messages, provider availability notification messages, provider availability alert messages, search requests, search reports, intellectual property offer messages, intellectual property bid messages, offer messages, or any other messages, reports, or communications, described herein which can be generated by the apparatus 100 of the present invention or by the central processing computer 10, or which can be generated by, transmitted from, or received by, any user communication device 20, any provider communication device 30, any funding service communication device 40, any official filing office computer 50, any agent/broker communication device 60, any social networking computer 70, or any media computer 80, can contain or include an advertisement, advertising information, marketing information, or marketing materials.

In any and/or all of the embodiments described herein, the apparatus 100 and/or the central processing computer 10 can also process any transactions, or any transaction information associated with same, which can or may occur, or which can or may transpire, with, between, or involving, any of the herein-described users, providers, funding services or investors, official or governmental filing offices, agents or brokers, social networking companies or entities or any members of any social networks, or media services or media sources, information services or information sources, or news services or news sources, pursuant to their respective utilization of the apparatus 100 of the present invention and/or otherwise.

In any and/or all of the embodiments described herein, the apparatus 100 and/or the central processing computer 10 can also administer, or process data and/or information for administering, financial accounts or any other accounts for or on behalf of any of the herein-described users, providers, funding services or investors, official or governmental filing offices, agents or brokers, social networking companies or entities or any members of any social networks, or media services or media sources, information services or information sources, or news services or news sources.

The apparatus 100 and method of the present invention can be utilized in many applications by providing a venue by which owners of intellectual property can sell or license their intellectual property, any foreign or international counterparts of to same, or any derivative rights to same, or any portion of same, or can identify, find, or locate, providers for commercializing, developing, marketing, selling, transferring, licensing, or monetizing, their intellectual property, any foreign or international counterparts of to same, or any derivative rights to same, or any portion of same, or can identify, find, or locate, a funding service or investor to fund any commercialization, development, marketing, sales, transfers, licensing, or monetization, of their intellectual property, any foreign or international counterparts of to same, or any derivative rights to same, or any portion of same, of can identify, find, or locate, official or governmental filing offices and/or any services, goods, or products, of same, for protecting, commercializing, developing, marketing, selling, transferring, licensing, or monetizing, their intellectual property, any foreign or international counterparts of to same, or any derivative rights to same, or any portion of same, or can identify, find, or locate, agents or brokers for obtaining representation and/or any other services for and/or regarding commercializing, developing, marketing, selling, transferring, licensing, or monetizing, their intellectual property, any foreign or international counterparts of to same, or any derivative rights to same, or any portion of same, or can identify, find, or locate, social networks for obtaining information and/or networking contacts for and/or regarding commercializing, developing, marketing, selling, transferring, licensing, or monetizing, their intellectual property, any foreign or international counterparts of to same, or any derivative rights to same, or any portion of same, or can identify, find, or locate, media services or media sources, information services or information sources, or news information services or news information sources, for obtaining any information for regarding commercializing, developing, marketing, selling, transferring, licensing, or monetizing, their intellectual property, any foreign or international counterparts of to same, or any derivative rights to same, or any portion of same or can utilize the apparatus 100 and method of the present invention in any other manner which can allow them to benefit from same.

The apparatus 100 and method of the present invention can also be utilized as a venue by which any providers of any services, goods, or products, any funding services or investors, any official or governmental filing offices, agents or brokers, social networking companies, or media services or media sources, information services or information sources, or news information services or news information sources, can respectively find clients or customers for their respective services, goods, or products, can obtain work projects, or can obtain orders for their goods, products, or services, can find investment opportunities, can find new work projects from and/or for existing clients or customers, or can find customers or clients for disseminate information regarding their respective services, goods, or products, or can find clients or customers to represent, or can find new social networking members and/or provide enhanced services for their members, or can advertise and/or market themselves and/or their respective services, goods, or products, to others, or can disseminate information which can be utilized by any of the herein-described users, providers, funding services or investors, official or governmental filing offices, agents or brokers, social networking companies, or media services or media sources, information services or information sources, or news information services or news information sources, or can establish business relationships with any users, providers, funding services or investors, official or governmental filing offices, agents or brokers, social networking companies, or media services or media sources, information services or information sources, or news information services or news information sources, of the apparatus 100, or can utilize the apparatus 100 and method of the present invention in any other manner which can allow them to benefit from same.

In another preferred embodiment, as well as in any and/or all of the embodiments described herein, any of the herein-described information, messages, reports, profiles, intellectual property profiles, provider reports, funding service/investor reports, agent/broker reports, intellectual property reports, intellectual property report messages, provider profiles, intellectual property user reports, provider reports, intellectual property user report messages, notification messages, alert messages, intellectual property (“IP”) notification messages, IP alert messages, provider availability notification messages, provider availability alert messages, search requests, search reports, intellectual property offer messages, intellectual property bid messages, offer messages, or any other messages, reports, or communications, which can be generated by the apparatus 100 of the present invention or by the central processing computer 10, or which can be generated by, transmitted from, or received by, any user communication device 20, any provider communication device 30, any funding service communication device 40, any official filing office computer 50, any agent/broker communication device 60, any social networking computer 70, or any media computer 80, can contain or can include data or information regarding, or a link(s) to or a hyperlink(s) to, any of the herein-described users, providers, funding services or investors, official or governmental filing offices, agents or brokers, social networking companies, or media services or media sources, information services or information sources, or news information services or news information sources, or any website associated with or corresponding to same, or any respective communication device(s) or computer(s) (20, 30, 40, 50. 60. 70, or 80) associated with or corresponding to same, or any social network, or any Internet chat room or discussion group, Internet forum, on-line chat room or discussion group, on-line forum, class or instructional session or broadcast, seminar, or webinar, or any advertisement(s) or advertising materials, or any marketing information or marketing materials, or any work schedule(s) or scheduling information, of, for, regarding, relating to, or associated with or corresponding to, same.

In another preferred embodiment, as well as in any and/or all of the embodiments described herein, any of the herein-described information, messages, reports, profiles, intellectual property profiles, provider reports, funding service/investor reports, agent/broker reports, intellectual property reports, intellectual property report messages, provider profiles, intellectual property user reports, provider reports, intellectual property user report messages, notification messages, alert messages, intellectual property (“IP”) notification messages, IP alert messages, provider availability notification messages, provider availability alert messages, search requests, search reports, intellectual property offer messages, intellectual property bid messages, offer messages, or any other messages, reports, or communications, which can be generated by the apparatus 100 of the present invention or by the central processing computer 10, or which can be generated by, transmitted from, or received by, any user communication device 20, any provider communication device 30, any funding service communication device 40, any official filing office computer 50, any agent/broker communication device 60, any social networking computer 70, or any media computer 80, can contain or can include a video recording and/or an audio recording which can be recorded by any respective user or operator of the respective central processing computer 10, user communication device 20, provider communication device 30, funding service communication device 40, official filing office computer 50, agent/broker communication device 60, social networking computer 70, or media computer 80. In this regard, any of the herein-described information, messages, reports, profiles, intellectual property profiles, provider reports, funding service/investor reports, agent/broker reports, intellectual property reports, intellectual property report messages, provider profiles, intellectual property user reports, provider reports, intellectual property user report messages, notification messages, alert messages, intellectual property (“IP”) notification messages, IP alert messages, provider availability notification messages, provider availability alert messages, search requests, search reports, intellectual property offer messages, intellectual property bid messages, offer messages, or any other messages, reports, or communications, can contain, include, or have attached thereto, a video clip, a video message, an audio clip, and/or an audio message.

For example, any time a respective user or operator of any central processing computer 10, user communication device 20, provider communication device 30, funding service communication device 40, official filing office computer 50, agent/broker communication device 60, social networking computer 70, or media computer 80, (hereinafter the “sending user”) performs a transaction with or using the same, or any time the sending user desires to communicate with any other user or operator of the apparatus 100 (hereinafter the “receiving user”), a video and/or an audio recording of the sending user can be made with or using the respective video and/or audio recording device(s) 20J, 30J, 40J, 50J, 60J, 70J, and/or 80J, and the video and/or audio recording can be transmitted in, along with, or attached to, any message, correspondence, or communication, which is sent or transmitted by the sending user to the receiving user.

In another preferred embodiment, as well as in any and/or all of the embodiments described herein, the apparatus 100 and/or the central processing computer 10 can also process any data or information for allowing any of the herein-described users, providers, funding services or investors, official or governmental filing offices, agents or brokers, social networking companies, or media services or media sources, information services or information sources, or news information services or news information sources, or any agents or employees of same, to engage in chat room sessions or discussions and/or video chat room sessions or discussions with one another, and/or in groups.

In another preferred embodiment, as well as in any and/or all of the embodiments described herein, the apparatus 100 and/or the central processing computer 10 can also process any data or information for allowing any of the herein-described users, providers, funding services or investors, official or governmental filing offices, agents or brokers, social networking companies, or media services or media sources, information services or information sources, or news information services or news information sources, or any agents or employees of same, to engage in bartering or in trading activities regarding or involving any services, goods, products, or other offerings which can be provide via the apparatus 100 and method of the present invention.

In another preferred embodiment, as well as any and/or all of the embodiments described herein, the apparatus 100 and/or the central processing computer 10 can process data or information for advertising, marketing, or selling, franchises of any type or kind.

In another preferred embodiment, as well as any and/or all of the embodiments described herein, the apparatus 100 and/or the central processing computer 10 can process data or information for advertising, marketing, or selling, media rights of any type or kind.

In another preferred embodiment, as well as any and/or all of the embodiments described herein, the apparatus 100 and/or the central processing computer 10 can process data or information for advertising, marketing, or selling, publicity rights of any type or kind.

In another preferred embodiment, as well as any and/or all of the embodiments described herein as well as, in particular, the preferred embodiments of FIGS. 10, 11, 12, 13, 14, and 15, any and all transactions which are or can be processed by any of the herein-described central processing computer(s) 10, user communication devices 20, provider communication devices 30, funding service communication devices 40, official filing office computers 50, agent/broker communication devices 60, social networking computers 70, and/or the media computers 80, can be processed by using a distributed ledger and/or distributed ledger technology or technologies, and/or by using Blockchain technology and/or technologies, Bitcoin technology and/or technologies, Ethereum technology and/or technologies, cryptocurrency technology and/or technologies, and/or smart contract technology and/or technologies, and/or peer-to-peer technology or technologies, and/or any technology or technologies related thereto or which can be utilized in conjunction therewith. In this regard, Applicant incorporates by references herein the subject matter and teachings of “Blockchain Technology Explained” by Alan T. Norman, “Blockchain” by Abraham K. White, “Blockchain—A Practical Guide To Developing Business, Law, And Technology Solutions” by Joseph J. Bambara and Paul R. Allen, and “Blockchain—Ultimate Guide To Understanding Blockchain, Bitcoin, Cryptocurrencies, Smart Contracts And The Future of Money” by Mark Gates, for all of their respective teachings regarding distributed ledger technology and/or technologies, Blockchain technology and/or technologies, Bitcoin technology and/or technologies, Ethereum technology and/or technologies, cryptocurrency technology and/or technologies, and/or smart contract technology and/or technologies, and/or peer-to-peer technology and/or technologies, and/or any technology or technologies related thereto or which can be utilized in conjunction therewith.

In another preferred embodiment, any combination of a centralized system, such as by using the central processing computer 10, to perform certain functions, and a decentralized system, such as a distributed ledger system, which can use Blockchain technology and/or technologies, Bitcoin technology and/or technologies, Ethereum technology and/or technologies, cryptocurrency technology and/or technologies, and/or smart contract technology and/or technologies, and/or peer-to-peer technology and/or technologies, to perform other functions, can also be utilized in the operation and use of the apparatus 100 and any of the herein-described described central processing computer(s) 10, user communication devices 20, provider communication devices 30, funding service communication devices 40, official filing office computers 50, agent/broker communication devices 60, social networking computers 70, and/or the media computers 80.

In another preferred embodiment, a distributed ledger system, which can use Blockchain technology and/or technologies, Bitcoin technology and/or technologies, Ethereum technology and/or technologies, cryptocurrency technology and/or technologies, and/or smart contract technology and/or technologies, and/or peer-to-peer technology and/or technologies, can be utilized instead of using a central processing computer 10 or instead of using any other of the herein-described user communication devices 20, provider communication devices 30, funding service communication devices 40, official filing office computers 50, agent/broker communication devices 60, social networking computers 70, and/or the media computers 80.

The apparatus 100 and method of the present invention can also be utilized in any number of ways in order to process information for, regarding, and/or for facilitating, the commercialization, development, marketing, sale, transfer, licensing, or monetization, of intellectual property which can be beneficial to the various users, providers, funding services or investors, official or governmental filing offices, agents or brokers, social networking companies, or media services or media sources, information services or information sources, or news information services or new information sources, described herein or otherwise who or which utilize the apparatus 100 and method of the present invention.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. An apparatus, comprising:
a user communication device, wherein the user communication device is associated with an owner of an intellectual property, wherein the user communication device further comprises:
a first processor;
a first receiver;
a first video recording device or a first audio recording device; and
a first transmitter;
a provider communication device, wherein the provider communication device is associated with a provider of a service or a product or is associated with an investor or a funding entity, wherein the provider communication device further comprises:
a second processor;
a second receiver;
a second video recording device or a second audio recording device; and
a second transmitter; and
a central processing computer, further comprising:
a third processor;
a third receiver; and
a third transmitter; and
a distributed ledger,
wherein the user communication device and the provider communication device are capable of communicating with each other directly or via the central processing computer, wherein the third receiver receives information regarding an intellectual property of the owner of an intellectual property, wherein the information regarding the intellectual property contains at least an identifier for the intellectual property, to signify that the intellectual property has been previously filed with an intellectual property examining entity, and information regarding a goal or an objective for commercializing or monetizing the intellectual property,
wherein the central processing computer is specially programmed to process the information regarding the intellectual property, specially programmed to create a posting, a listing, or a registration, of, for, or associated with, the intellectual property, and specially programmed to generate a profile for the intellectual property, wherein the central processing computer generates or creates the posting, the listing, or the registration, for the intellectual property, and further wherein the central processing computer generates the profile for the intellectual property and a first report containing information regarding the intellectual property, and further wherein the first report contains a video recording or an audio recording recorded by the first video recording device or the first audio recording device,
wherein the central processing computer processes information for identifying a provider of a service or a product or for identifying an investor or a funding entity, for the intellectual property, and further wherein the central processing computer generates a second report containing information regarding at least one identified provider or at least one identified investor or funding entity and further wherein the second report contains a video recording or an audio recording recorded by the second video recording device or the second audio recording device,
wherein the central processing computer transmits the first report to the provider communication device and transmits the second report to the user communication device,
wherein the apparatus processes a transaction involving the owner of the intellectual property and the provider or the investor or the funding entity as a Blockchain transaction or as an Ethereum transaction via the distributed ledger.

2. An apparatus, comprising:
a user communication device, wherein the user communication device is associated with an owner of an intellectual property, wherein the user communication device further comprises:
a first processor;
a first receiver;
a first video recording device or a first audio recording device; and
a first transmitter;
a provider communication device, wherein the provider communication device is associated with a provider of a service or a product or is associated with an investor or a funding entity, wherein the provider communication device further comprises:
a second processor;
a second receiver;
a second video recording device or a second audio recording device; and
a second transmitter; and
a central processing computer, further comprising:
a third processor;
a third receiver; and
a third transmitter;
wherein the user communication device and the provider communication device are capable of communicating with each other directly or via the central processing computer, wherein the third receiver receives information regarding an intellectual property of the owner of an intellectual property, wherein the information regarding the intellectual property contains at least an identifier for the intellectual property, to signify that the intellectual property has been previously filed with an intellectual property examining entity, and information regarding a goal or an objective for commercializing or monetizing the intellectual property,
wherein the central processing computer is specially programmed to process the information regarding the intellectual property, specially programmed to create a posting, a listing, or a registration, of, for, or associated with, the intellectual property, and specially programmed to generate a profile for the intellectual property, wherein the central processing computer generates or creates the posting, the listing, or the registration, for the intellectual property, and further wherein the central processing computer generates the profile for the intellectual property and a first report containing information regarding the intellectual property, and further wherein the first report contains a video recording or an audio recording recorded by the first video recording device or the first audio recording device,
wherein the central processing computer processes information for identifying a provider of a service or a product or for identifying an investor or a funding entity, for the intellectual property, and further wherein the central processing computer generates a second report containing information regarding at least one identified provider or at least one identified investor or funding entity, and further wherein the second report contains a video recording or an audio recording recorded by the second video recording device or the second audio recording device,
wherein the central processing computer transmits the first report to the provider communication device and transmits the second report to the user communication device.

3. The apparatus of claim 2, wherein the provider is a service provider.

4. The apparatus of claim 2, wherein the provider is an official or governmental filing office.

5. The apparatus of claim 2, wherein the provider is an agent or a broker.

6. The apparatus of claim 2, wherein the provider is a social networking company or an operator of a social network.

7. The apparatus of claim 2, wherein the provider is a media service, a media source, an information service, an information source, a news information service, or a news information source.

8. The apparatus of claim 2, wherein the intellectual property is a patent application, a foreign counterpart to the patent application, or a patent.

9. The apparatus of claim 2, wherein the intellectual property is a trademark or a trademark application.

10. The apparatus of claim 2, wherein the intellectual property is a copyright, a copyrighted work, or a copyright application or a derivative work.

11. The apparatus of claim 2, wherein the apparatus or the central processing computer processes information regarding the provider or the investor or funding entity and creates a posting, a listing, or a registration, of, for, or associated with, the provider or the investor or the funding entity, and further wherein apparatus or the central processing computer generates a third report containing information regarding the provider or the investor or the funding entity, and further wherein the central processing computer or the third transmitter transmits the third report to the user communication device.

12. The apparatus of claim 2, wherein the apparatus or the central processing computer processes information regarding the owner of the intellectual property and creates a posting, a listing, or a registration, of, for, or associated with, the owner of the intellectual property, and further wherein apparatus or the central processing computer generates a third report containing information regarding the owner of the intellectual property, and further wherein the central processing computer or the third transmitter transmits the third report to the user communication device.

13. The apparatus of claim 2, wherein the apparatus processes a transaction involving the owner of the intellectual property and the provider or the investor or the funding entity as a Blockchain transaction or as an Ethereum transaction via a distributed ledger.

14. An apparatus, comprising:
a user communication device, wherein the user communication device is associated with an owner of an intellectual property, wherein the user communication device further comprises:
a first processor;
a first receiver;
a first video recording device or a first audio recording device; and
a first transmitter;
a provider communication device, wherein the provider communication device is associated with a provider of a service or a product or is associated with an investor or a funding entity, wherein the provider communication device further comprises:
a second processor;
a second receiver;
a second video recording device or a second audio recording device; and
a second transmitter; and
a central processing computer, further comprising:
a third processor;
a third receiver; and
a third transmitter;
wherein the user communication device and the provider communication device are capable of communicating with each other directly or via the central processing computer, wherein the third receiver receives information regarding the provider or the investor or funding entity, wherein the information regarding the provider comprises at least information regarding qualifications or credentials of the provider and desired projects or jobs sought by the provider to assist an owner of intellectual property to commercialize or monetize the intellectual property, or at least information regarding credentials of the investor or funding entity or investment opportunities sought by the investor or funding entity,
wherein the central processing computer is specially programmed to process the information regarding the provider or the investor or funding entity, specially programmed to create a posting, a listing, or a registration, of, for, or associated with, the provider or the investor or funding entity, and specially programmed to generate a profile for the provider or the investor or funding entity,
wherein the central processing computer generates or creates the posting, the listing, or the registration, for the provider or the investor or funding entity, and further wherein the central processing computer generates the profile for the provider or the investor or funding entity and a first report containing information regarding the provider or the investor or funding entity, and further wherein the first report contains a video recording or an audio recording recorded by the second video recording device or the second audio recording device,
wherein the central processing computer processes information for identifying an intellectual property for which the provider is capable of providing a service or a product or an investor or funding entity, and further wherein the central processing computer generates a second report containing information regarding at least one identified intellectual property, and further wherein the second report contains a video recording or an audio recording recorded by the first video recording device or the first audio recording device,
wherein the central processing computer transmits the first report to the user communication device and transmits the second report to the provider communication device.

15. The apparatus of claim 14, wherein the provider is a service provider.

16. The apparatus of claim 14, wherein the intellectual property is a patent application, a foreign counterpart to the patent application, or a patent.

17. The apparatus of claim 14, wherein the intellectual property is a trademark or a trademark application.

18. The apparatus of claim 14, wherein the intellectual property is a copyright, a copyrighted work, or a copyright application or a derivative work.

19. The apparatus of claim 14, wherein the apparatus or the central processing computer processes information regarding the owner of the intellectual property and creates a posting, a listing, or a registration, of, for, or associated with, the owner of the intellectual property, and further wherein apparatus or the central processing computer generates a third report containing information regarding the owner of the intellectual property, and further wherein the central processing computer or the third transmitter transmits the third report to the user communication device.

20. The apparatus of claim 14, wherein the apparatus processes a transaction involving the owner of the intellectual property and the provider or the investor or the funding entity as a Blockchain transaction or as an Ethereum transaction via a distributed ledger.
